(19) United States
(12) Patent Application Publication
(10) Pub. No.: US 2016/0300200 A1
(43) Pub. Date: Oct. 13, 2016

(54) PERSONAL ELECTRONIC CURRENCY

(71) Applicant: CONJECTURAL TECHNOLOGIES, LLC, Ann Arbor, MI (US)

(72) Inventors: JUSTIN L. BROWN, ANN ARBOR, MI (US); JOEL A. FRIED, Niskayuna, NY (US)

(21) Appl. No.: 15/095,760

(22) Filed: Apr. 11, 2016

Related U.S. Application Data
(60) Provisional application No. 62/145,328, filed on Apr. 9, 2015.

(51) Int. Cl. G06Q 20/10

(52) U.S. Cl. CPC G06Q 20/10

(57) ABSTRACT

A system and method is provided to create and use a virtual personal electronic currency. The system provides a platform and graphical user interface (GUI) that allows a user to create their own personal version(s) of digital currency that is referred to hereinafter as a “koin”, to hold, share, or trade with others. The koin is backed by the fiat of the creator, and is not traded on an open market, but rather between friends, families, groups, and organizations seeking a way to denote accomplishments or the exchange of goods and services. Embodiments of bits of koin (koinage) virtual personal electronic currency also allow people to experience direct control over their social media experience through the dissemination of their koins.

### CROSS REFERENCE TO RELATED APPLICATIONS

This application claims priority benefit of U.S. Provisional Application Ser. No. 62/145,328 filed 9 Apr. 2015; the contents of which are hereby incorporated by reference.

### FIELD OF THE INVENTION

1. Field of the Invention

The present invention in general relates to electronic commerce, and in particular to a method and system for a personal virtual electronic currency with unique parameters and distribution rules determined by the issuer.

2. Background of the Invention

Bitcoin is an online peer-to-peer payment system where users transact directly without needing an intermediary. Transactions are verified by network nodes and the transactions are recorded in a public distributed ledger called a block chain. The distributed ledger uses its own unit of account, also called bitcoin. The bitcoin system works without a central repository or single administrator, which has led the US Treasury to categorize it as a decentralized virtual currency.

Bitcoins are created as a reward for payment processing work in which users offer their computing power to verify and record payments into the public ledger. This activity is called mining and is rewarded by transaction fees and newly created bitcoins. Besides mining, bitcoins can be obtained in exchange for fiat money, products, and services. Users can send and receive bitcoins for an optional transaction fee.

An increasing number of merchants are now accepting bitcoin as a form of payment for products and services since merchants have an incentive to accept bitcoin because fees are lower than the 2-3% typically imposed by credit card processors. However, despite a big increase in the number of merchants accepting bitcoin, the bitcoin as a currency does not have much momentum in retail transactions, since unlike credit cards, any fees are paid by the purchaser, not the vendor.

However, existing forms of electronic currency do not provide individual users with the ability to set the value of the currency they are using, or to control the distribution of the currency. Thus there exists a need for an electronic currency that is controlled by and for individuals.

### SUMMARY OF THE INVENTION

A non-transitory computer-readable medium for implementing an automated virtual personal electronic currency is provided that has instructions stored thereon, that when executed on a processor, perform provides a graphical user interface (GUI) from a platform. A user is registered on the platform and creates a virtual personal electronic currency with a set of user defined attributes on the platform. The virtual personal electronic currency is distributed to one or more recipients for goods and services provided.

An automated method for implementing a virtual personal electronic currency is provided, where the method uses a graphical user interface (GUI) from a platform to register a user on a platform. The virtual personal electronic currency is created with a set of user defined attributes on the platform, and the virtual personal electronic currency is distributed to one or more recipients for goods and services provided.

A system for implementing the non-transitory computer-readable medium and corresponding method for a virtual personal electronic currency is also provided.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram illustrating a method of creating and using a virtual currency according to embodiments of the invention;

FIGS. 2A-2N are a series of screenshots of a graphical user interface illustrating the functional and social aspects of the virtual personal electronic currency according to embodiments of the invention;

FIGS. 3A-3E are a series of screenshots of a graphical user interface showing the pages available to create a user defined electronic currency in accordance with an embodiment of the invention;

FIGS. 4A-4D are a series of screenshots of a graphical user interface showing the create koin function conducted over four progressive pages in accordance with an embodiment of the invention;

FIG. 5 is a screenshot of a wallet with a list containing a set of different user currencies created in a user account in accordance with an embodiment of the invention;

FIGS. 6A-6C combine in a scroll down manner to show a screenshot of a page with information and the forum social communication feature for a currency selected in the list of FIG. 4 in accordance with an embodiment of the invention;

FIGS. 7A-7D are a series of pages of the graphical user interface for the user creation and use of the free key in accordance with an embodiment of the invention;

FIG. 8 is a screenshot of the send koin functionality including sending via e-mail in accordance with embodiments of the invention;

FIGS. 9A-9G illustrate the branches of a site map of the graphical user interface pages shown in FIGS. 2-6 in accordance with embodiments of the invention;

FIG. 10 is a screenshot of a home page for an embodiment of the virtual personal electronic currency; (00211 FIG. 11 is a screenshot of a login Page with links for signing in via social network applications in accordance with embodiments of the invention;

FIGS. 12A-12W are a series of screenshots of a graphical user interface illustrating the functional and social aspects of the virtual personal electronic currency according to embodiments of the invention;

FIGS. 13A-13H are a series of screenshots of a graphical user interface configured for use on a mobile communication and computing devices in accordance with embodiments of the invention; and

FIG. 14 is a schematic diagram illustrating an overall view of communication devices, computing devices, and mediums for implementing embodiments of the invention.

### DESCRIPTION OF THE INVENTION

The present invention has utility as a system and method to create and use a virtual personal electronic currency. Embodiments of the inventive system provide a platform and graphical user interface (GUI) that allow a user to create their own personal version(s) of digital currency, which will be referred to hereinafter as a “koin”, to hold, share, or trade with others. In specific embodiments the platform and associated GUI may be referred to as “bits of koin”. The koin is backed by the fiat of the creator, and is not traded on an open market, but rather between friends, families, groups, and organizations seeking a way to denote accomplishments or the exchange of goods and services. Embodiments of bits of koin also allow people to experience direct control over their social media experience through the dissemination of their koins.

The digital currency or koin is defined by the user to have its own unique value and attributes, and is backed by the creating user as a form of micro currency. User defined attributes for a koin illustratively may include a name, description, representative icon, who can own the koin, whether the koin can be awarded or revoked, permission levels for sharing the koin on social media, whether or not the koins expire after a defined period, the number of koins in circulation, and the value of a koin. The user created koins act as a form of currency that may be distributed on an unlimited basis to anybody (public) in the world, limited to the user's friends, or the koins may be saved only for handpicked or designated closest confidantes.

Embodiments of the system and method to create and use a virtual personal electronic currency differs from traditional currencies in that each user retains tight control over who can use—or even see the existence of—their currency as a set of privacy controls or options. These privacy options allow users to build currencies to meet their needs for specific tasks which could be of a highly personal nature. A husband and wife could create a currency that is awarded for chores, redeemable for enjoyable experiences, and keep everyone else from knowing not just the details but that the currency even exists. Conversely, embodiments of the inventive system and method tie into major social networks for users who wish to widely publicize their currency's value. The social media features provide users with the ability to use their currency to promote their business, to settle debts, to brag, or for whatever other reason they desire. Furthermore, an integrated messaging and forum feature provided in embodiments of the invention facilitates communication between users of any given currency.

While several steps performed by an inventive process and a non-transitory system involve one or more abstract ideas, the present invention as a whole includes aspects that amount to significantly more than the abstract idea. Indeed, aspects of the present invention have never been previously performed in manual or digital form prior to the present invention. As recitations of using a non-transitory computer medium to create and use a virtual personal electronic currency. The system provides a platform and graphical user interface (GUI) that allows a user to create their own personal version(s) of digital currency that is referred to hereinafter as a “koin”, to hold, share, or trade with others. The koin is backed by the fiat of the creator, and is not traded on an open market, but rather between friends, families, groups, and organizations seeking a way to denote accomplishments or the exchange of goods and services. Embodiments of bits of koin also allow people to experience direct control over their social media experience through the dissemination of their koins. A user is registered on the platform and creates a virtual personal electronic currency with a set of user defined attributes on the platform. The virtual personal electronic currency is electronically distributed to one or more recipients for goods and services provided.

These aspects of the present invention as an electronic personal virtual currency platform, amount to significantly more than simply providing a currency by addressing the challenges of current virtual currencies that are not personalized. Thus, the inventive virtual currency platform solves the problems inherent in the current method and modes for virtual currency. The present invention has the effect of improving the use of personalized virtual currency for private transactions, for goal setting rewards, and for marketing of products and services.

The invention recites a series of acts for implementing an automated personalized virtual currency application (app) on an end user device that comprises instructions stored thereon, that are executed on a processor.

The invention relates to software technology that implements an app on an end user device with a graphical user interface (GUI) from a platform, where the platform receives information about the end user and creates a personalized virtual currency, tracks the uses of the personalized currency, promotes trading between users, and maintains a rewards system for meeting personal goals. Such action does not describe an abstract concept, or a concept similar to those found by the courts to be abstract, such as a fundamental economic practice, a method of organizing human activity, an idea itself (standing alone), or a mathematical relationship. In contrast, the invention claimed here is directed towards relates to software technology that implements an app on an end user device with a graphical user interface (GUI) from a platform that perform a system and method for a virtual personal currency with an automated application, a concept inextricably tied to computer technology and distinct from the types of concepts found by the courts to be abstract. Accordingly, the inventive steps do not recite an abstract idea nor do they implicate any other judicial exception.

In addition, the claimed invention is also directed to a non-transitory computer-readable medium, which is a manufacture, and thus a statutory category of invention.

In embodiments of the inventive personal currency platform, a user has the ability to set a redemption value of the koin in any way they choose. For example, a user sets a value of 60 koins for an hour of the user's time, 250 koins for a home cooked meal, 500 koins to borrow a prized possession for a week, and 1000 koins for something the user made by hand. Companies may use koins as coupons with bar codes or quick response (QR) codes as part of the koin image. In the event the user is unsure of the value of an item or service, the user may allow for a custom redemption where people holding the user created currency make a redemption offer. When someone redeems a koin, the user receives a message letting them know who redeemed which of their koins and for what. Once the user (koin creator) provides the redeeming party with the value exchanged for the koin, the user selects or clicks an appropriate link in the message, and the redeeming party confirms they received the value they purchased with the koin. The transaction is then complete and user koin(s) are removed from the redeeming party's wallet that is part of the inventive platform. In a specific embodiment the redeeming process may also include the reception of an email by the users informing them of the transaction, and the creator/issuer of the koin go to a transactions page to mark that they provided the agreed upon value, and the redeeming party must mark that they received the value for the koinage used in order for the transaction to be considered complete. In certain embodiments when there is an “Integrated Reward” used, for example a digital gift card purchased through the site, then additional steps are required to redeem the gift card.

In specific embodiments of the inventive platform, the life cycle of a koin begins with the koins creation by the user with a create koin function that specifies the attributes for the personal currency as designated by the creating user under a manage my koins menu. The user may then distribute their koins to others via a send koin or trade koin function. The user may also distribute an alphanumeric key which may be tied within the system to a certain number of free koins. This key may also be distributed as a QR code.

When a user sends their koins, the koins go to whomever they specify either through the system or via email. When the user trades their koins, the user offers some of their koins for other koins that belong to the other parties to the trade. When someone else has enough of the user created koins in their wallet they can redeem the acquired koins for value from the koin creating user by choosing to redeem the koins, and in turn, the creating koin user may redeem the koins the creating user has accumulated from others for a value to be provided to the creating user.

In embodiments of the inventive platform, koins may be created for different specified purposes. For example, a koin may be designated for friends, where the koin is redeemable for a beer on demand, or a koin for the user's parents redeemable for a ten minute phone call. In further illustrative examples, the user may create koins for their coworkers for when the user wants to trade shifts, or for their children redeemable for candy and awarded for completing their chores.

In specific embodiments of the inventive personal currency platform, the creating koin user may edit or add more redemption values to their koin at any time with one exception. If at any time the creating user elects to lock a koin value, the redemption value for the locked koin is forever fixed. By locking the koins values, the creating user of the now locked koin shows the holders of their Koin based currency that the holders will definitely get their value. However, in specific embodiments once a koin value is locked, the locked status of the koin cannot be reversed so the user must be absolutely sure they want the value locked. Other aspects of the koin may be altered. The description, maximum circulation, social sharing features, privacy settings, and expiration date (if there is any) may all be edited by the creator of the koin. However, in specific embodiments once the name of the koin is established the name cannot be edited.

A user of the inventive personal currency platform may in specific inventive embodiments redeem koins they hold by using on screen menus that are part of the GUI. In specific embodiments redemption of koins is carried out in the user's wallet. Once at the wallet, the user is presented with a list of koins they hold, and a koin for redemption is selected by the user from the list with the redemption actions next to the listed koin, which will send the user to a redeem page where they will see any redemption values set by creator of the koin. The redeeming user will then choose what they want to redeem the koin for and click a redeem button. If the redeeming user is allowed a custom redemption, the user may fill in a user defined redemption value, which the creator of the koin to be redeemed may or may not reject.

A “Free Key” functionality in specific embodiments of the invention allows a creating user to assign an alphanumeric code, which may be depicted as a quick response (QR) code for easier dissemination and automatic redemption from mobile devices. Other users can use this code to get a certain amount of their koins for free. In a non-limiting illustrative example, a vendor who uses the system may want to give people an incentive for visiting their booth at a convention. The vendor hands out cards with a phrase like “FreeShippingPromotion2015”, and if a user goes to the inventive website and puts that phrase in to the “Enter Free Key” text box and clicks submit they would get however many koins the vendor had allotted to each user. The vendor will set the number of koins given out to a person using the code, the type of koin given out (as users could have multiples, and might very likely want to create a differently valued koin for this purpose), and the maximum number of koins given away. The vendor may also track the usage and see who has these koins (in a similar manner to other koins the vender has created).

In specific embodiments of the inventive personal currency platform certain functional features or extensions of these features may be based on a membership status or tiers, and a membership fee structure commensurate with the membership tiers. In addition, in specific embodiments, transaction costs or charges may be associated with each koin transaction. The creation of koins may be free, but once sent to other users using the send function or via trade, this sending action counts as a single transaction regardless of how many koins change wallets. In specific embodiments, users will start with a set number of free transactions, as influenced by the membership tiers, then once expired will have to purchase additional transactions from the administrators of the personal currency platform through the koin store (as a non-limiting example: 1000 transactions for $10).

In a specific exemplary embodiment of the inventive personal currency platform the membership tiers may be as follows:

Tin-Free account. Where users start. Comes with the 3 different coin types (e.g., A,B,C coins) and 100 free transactions.
Bronze-Free account. User gets an extra 3 different coin types and another 200 free transactions as a one-time bonus for making bronze. The user receives a bits of koin (BOK) (also referred to as koinage) bronze koin from the personal currency platform each month at the bronze tier. If a user's bronze status lapses the user then reverts to tin. The bronze tier has the following requirements: make 30 transactions a month, must have 5 friends, create 2 different types of coins, complete 100 transactions, share 3 times across various social media, must refer 1 user, and must complete guided tour and quiz (score 800/%).
Silver-Free account. Use gets an extra 4 different coin types (10 total) and another 500 free transactions as a one-time bonus for making silver. The user receives a BOK (koinage) silver koin from the personal currency platform each month at the silver tier. If a user's silver status lapses the user then revert to bronze the next month. The silver tier has the following requirements: make 50 transactions a month, must have 25 friends, create 5 different types of coins, complete 500 transactions, share 10 times across various social media, must refer another 5 users (6 total).
Gold-Paid account: Must pay fees of $2.99/mo or $24.99/yr. As a one-time bonus gold members receive an extra 7 types of koins/700 transactions if they pay for the full year up front. Gold members receive a BOK (koinage) Gold koin from the personal currency platform each month. If payment lapses the gold member reverts to silver status. Bonuses available to gold members illustratively include no advertisements on the platform GUI, access to the koin pond. Extra koin creator options (can limit the ability of koin users to print coins via cafe press), 25% off all items in the koin store except BOK (koinage) gift certificates and account membership upgrades.
Platinum: Must pay fees, $9.99/mo or $99.99/yr. As a one-time bonus platinum members receive an extra 15 types of koins if they pay for the full year up front. Platinum members receive a BOK (koinage) platinum koin from the personal currency platform each month. If payment lapses then platinum members revert to silver status. Platinum members receive all bonuses that gold members have plus the following: 50% off all items in the koin store except BOK (koinage) gift certificates and account membership up grades, may add one free user name, and infinite transactions.

The graphical user interface of the personal currency platform may be resident on a user's computing device as an executable program, or accessed from a remote server via a network that illustratively includes the Internet as an on-demand service as a function of the cloud. Embodiments of the graphical user interface of the personal currency platform are also available for mobile computing and communication devices as a downloadable application (app) that are available for computing operating systems (OS) or mobile operating systems illustratively including Windows, OS X, Linux, Android, iOS, Windows for mobile, and other available mobile operating systems (OS). In specific embodiments, user data (transaction data, circulation data, currency details, images, user details, privacy controls) are stored in a structured query language (SQL) database. It is appreciated that additional database management structures may be suited to carryout embodiments of the personal currency platform. In specific embodiments of the personal currency platform, queries are made against the platform database via a personal home page (PHP) framework, or other available server-side scripting languages illustratively including, but not limited to, ASP, ActiveVFP, ASP.NET, CGI, ColdFusion Markup Language, Go, Groovy, Java, JavaScript, Lua, Perl, R, Python, Ruby, Ruby on Rails, SMX, Lasso, TCL, WebDNA, and OpenEdge Advanced Business Language. In a specific embodiment backend operations are carried out using Codeigniter, which is a PHP framework with a very small footprint with a simple and elegant toolkit to create full-featured web applications.

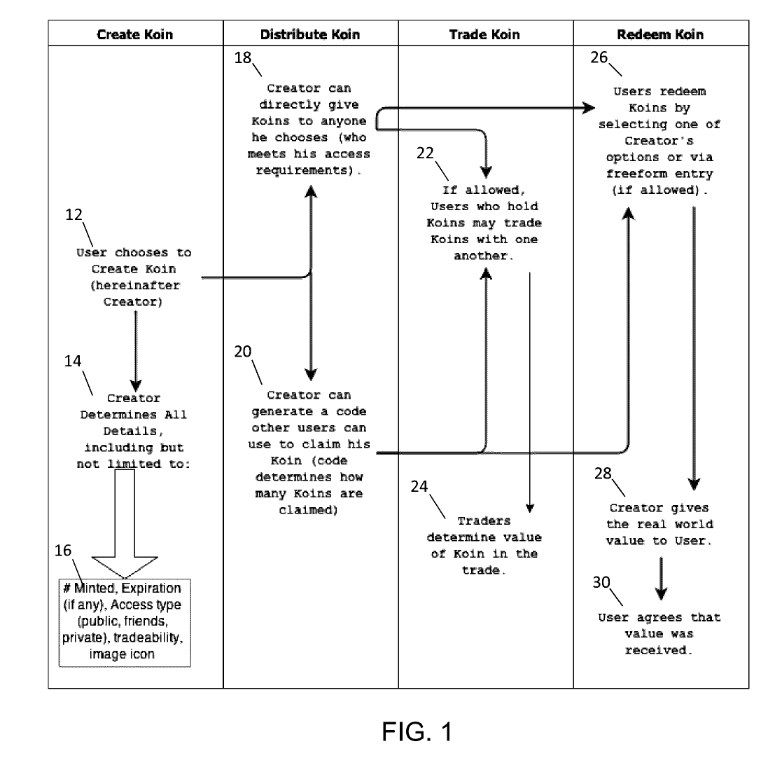

Referring now to the figures, FIG. 1 is a flowchart of a method 10 that illustrates the creation and use of a virtual personal electronic currency. The process starts with a creating user (hereinafter “creator”) creating a virtual currency or koin (block 12). The creator determines the details and attributes of the koin (block 14) including but not limited to: the number of koins minted, expiration time (if any) for the koin, access type (public, friends, private), tradeability (terms of trade), and the image icon associated with the koin (block 16), and whether the koin may be shared on social media. The creator of the koin may distribute the koin directly to whom they choose based on the access type of the koin (block 18). The creator may generate a code that recipient users may use to access or claim their koin, where the code determines how many koins are claimed (block 20). If the recipients of the koins are allowed, the recipients may trade koins with each other (block 22), where the traders determine the value of the koin in a trade (block 24). Users may redeem koins by selecting a redemption option as defined by the creator, or via a freeform user entry through which the redeemer proposes a redemption value (if allowed by the creator) (block 26). The creator of the koin may assign a value to the koin (block 28), and the user that redeems the koin agrees that value was received (block 30).

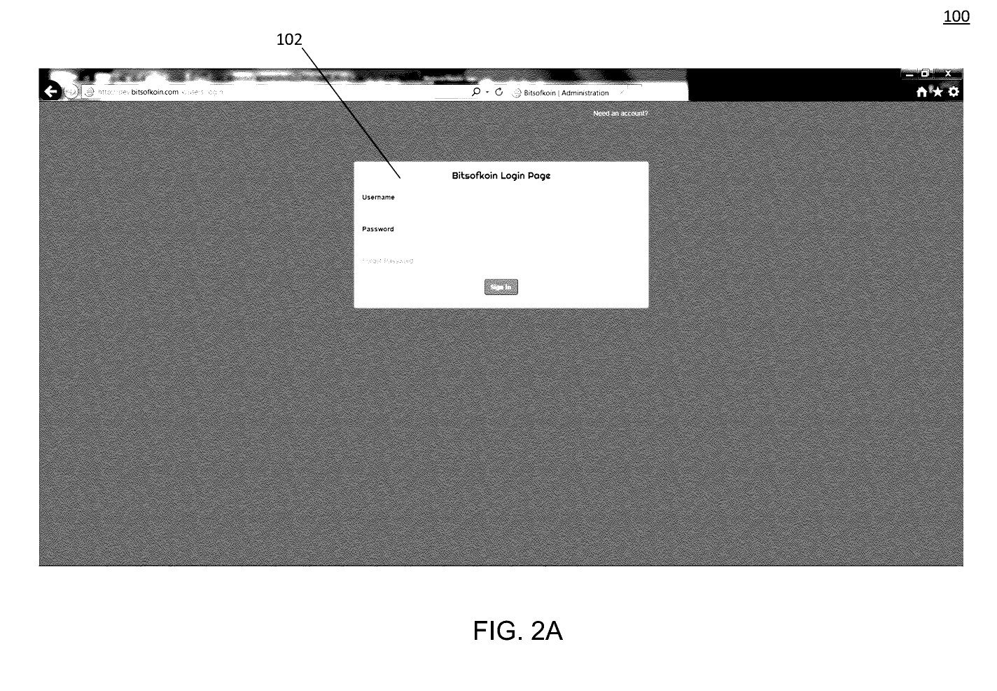

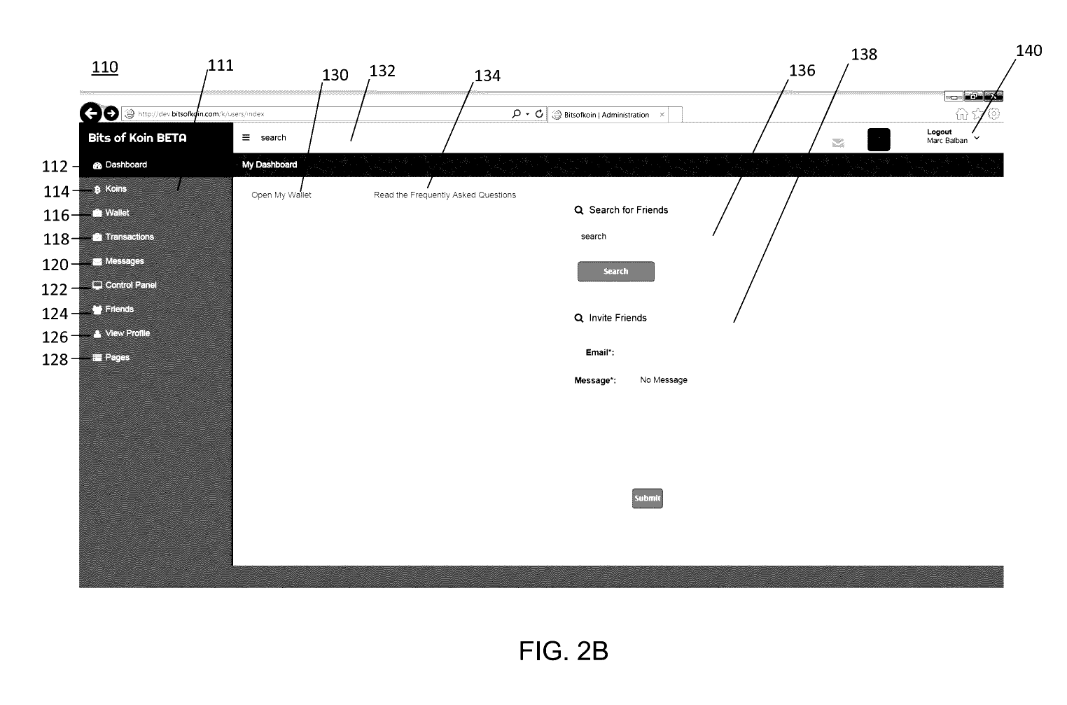

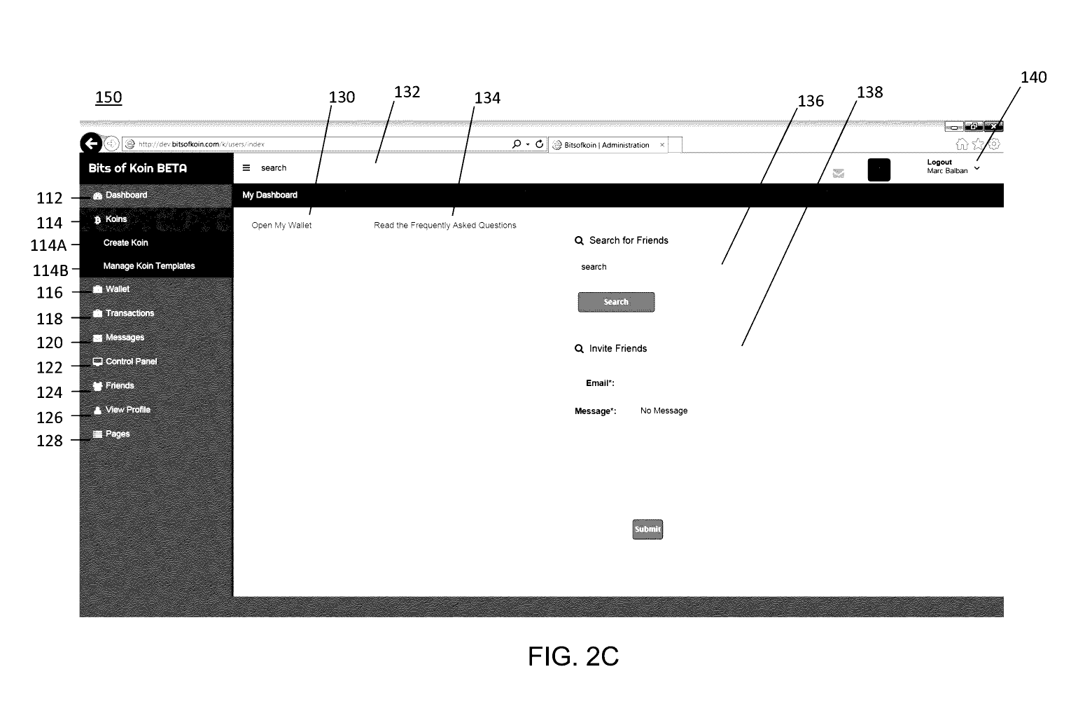

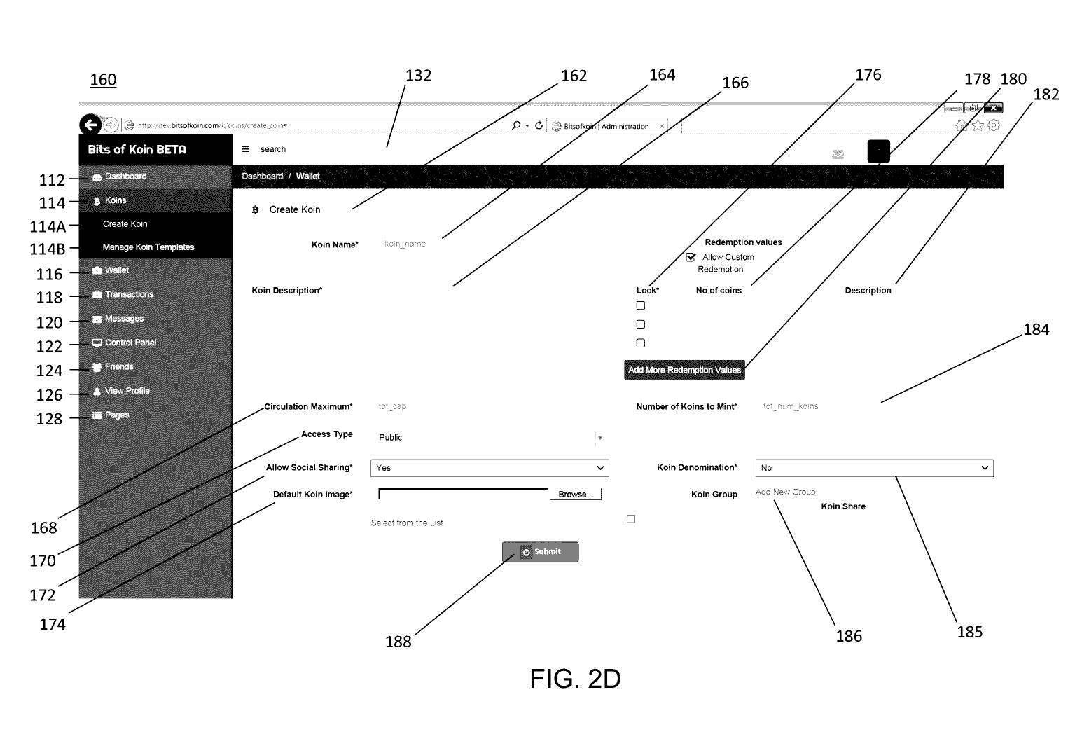

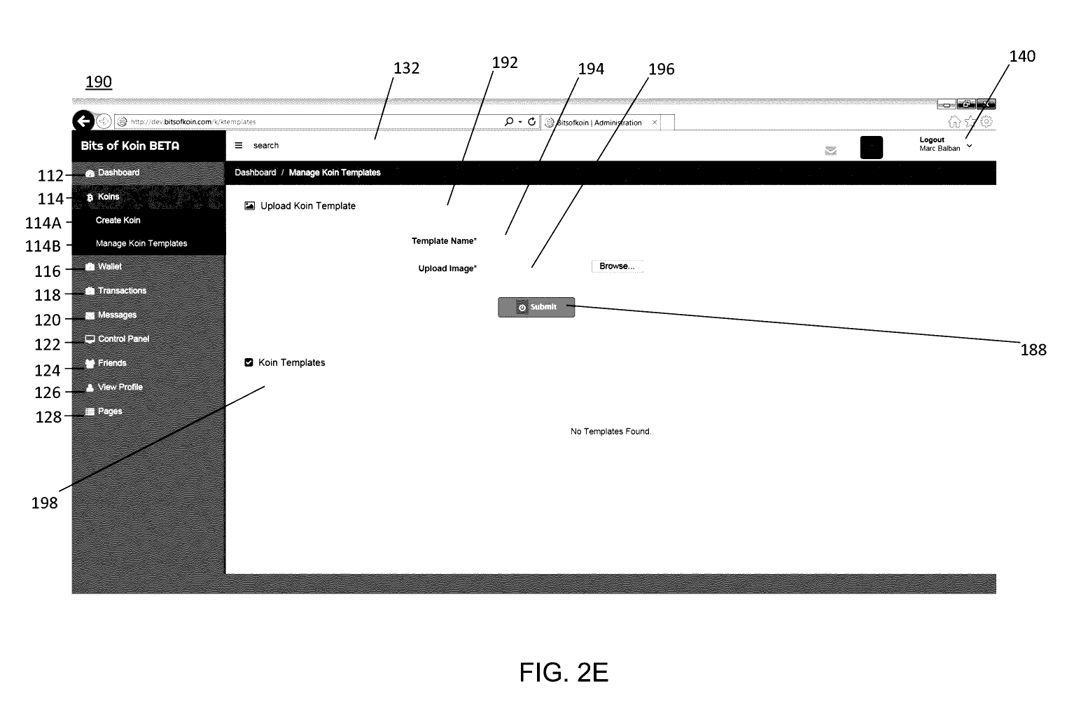

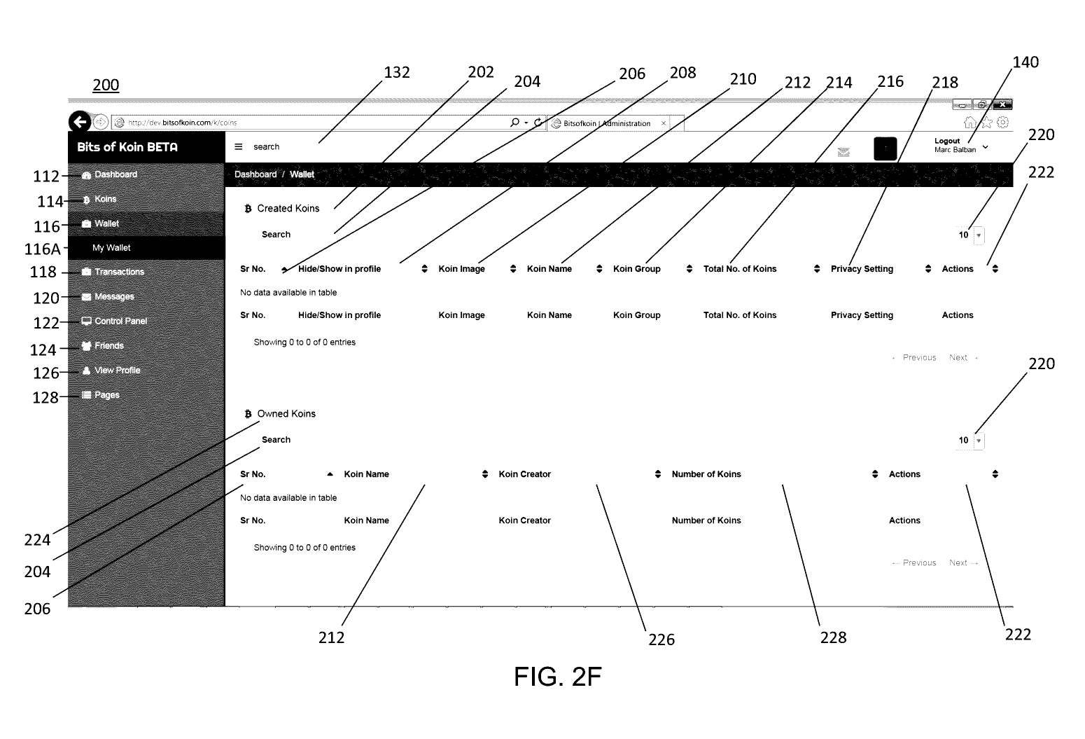

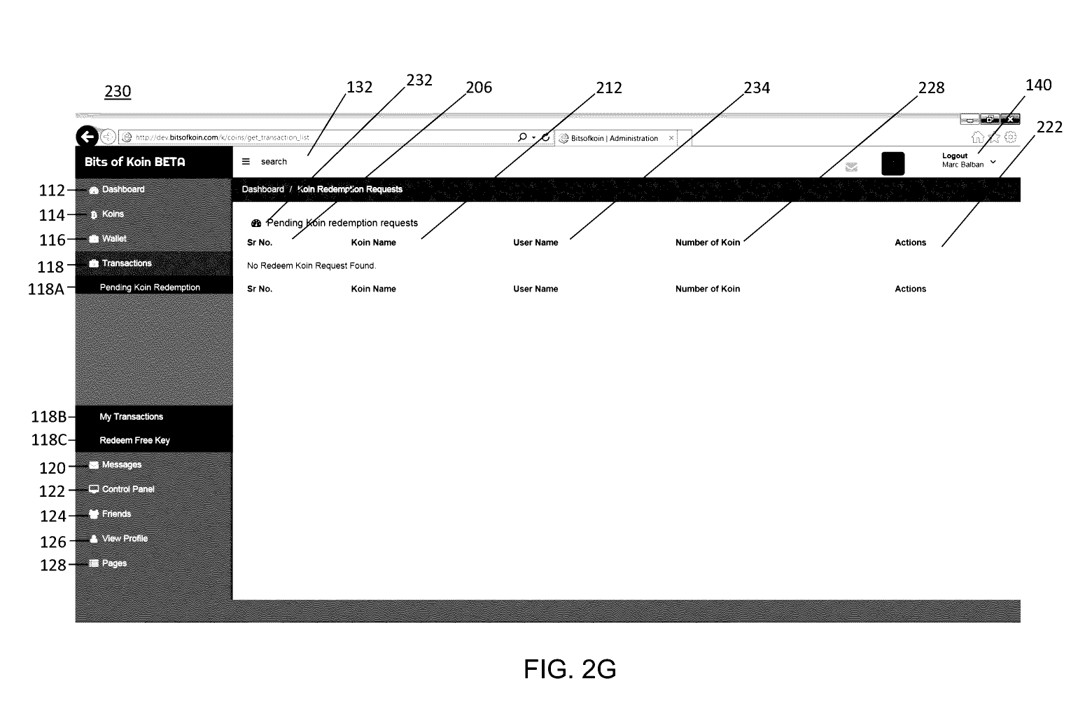

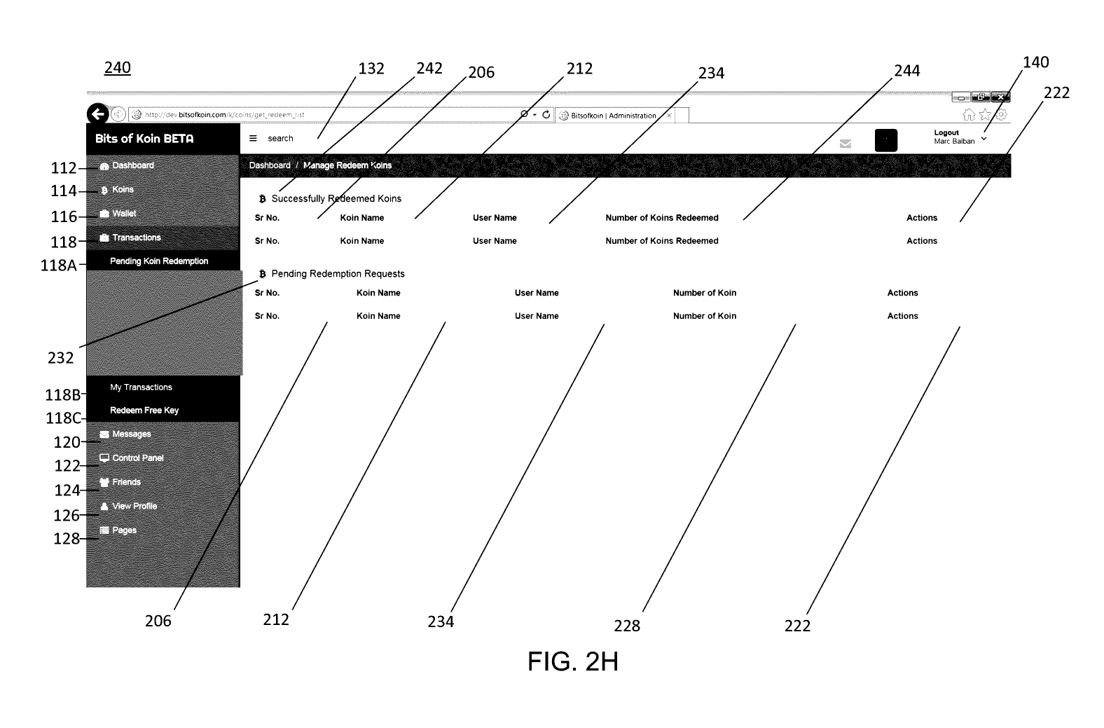

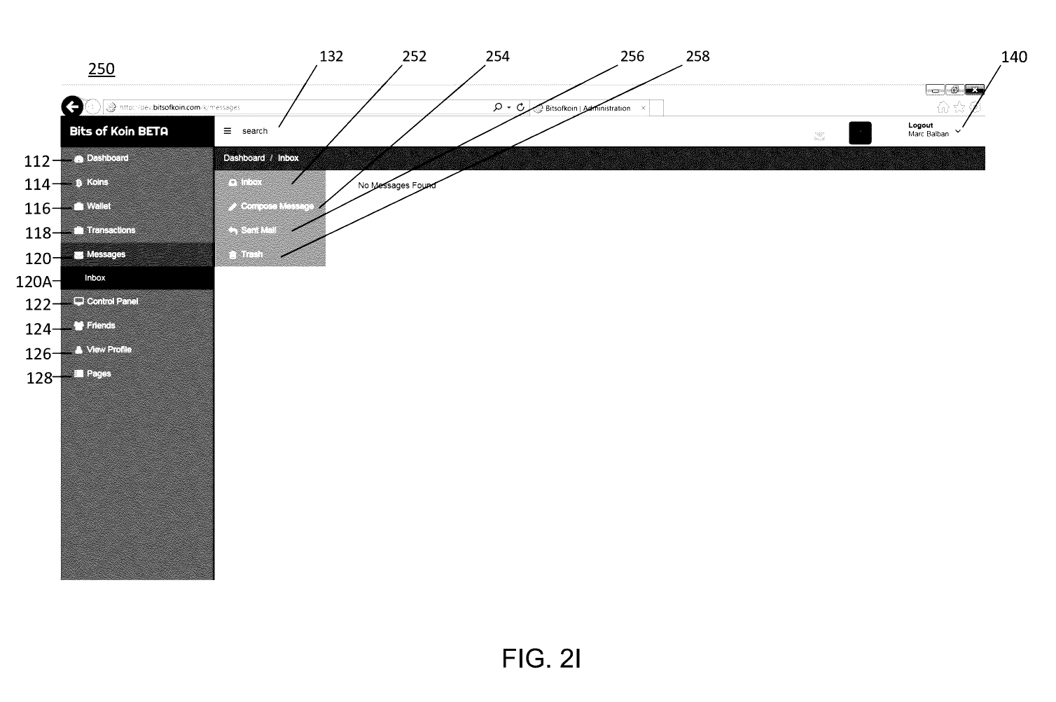

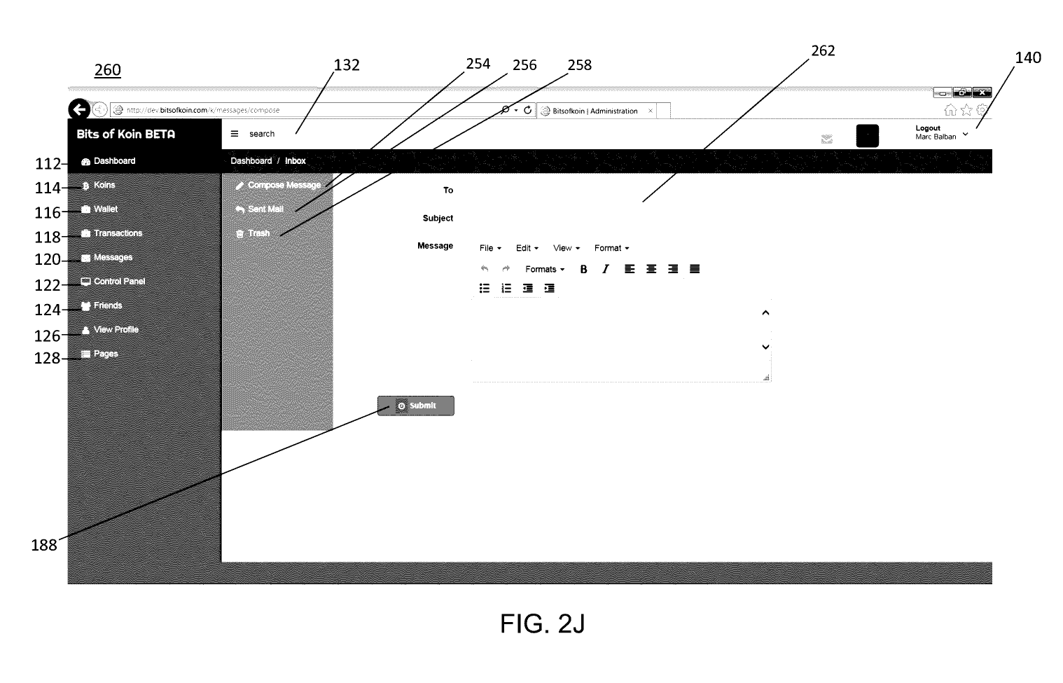

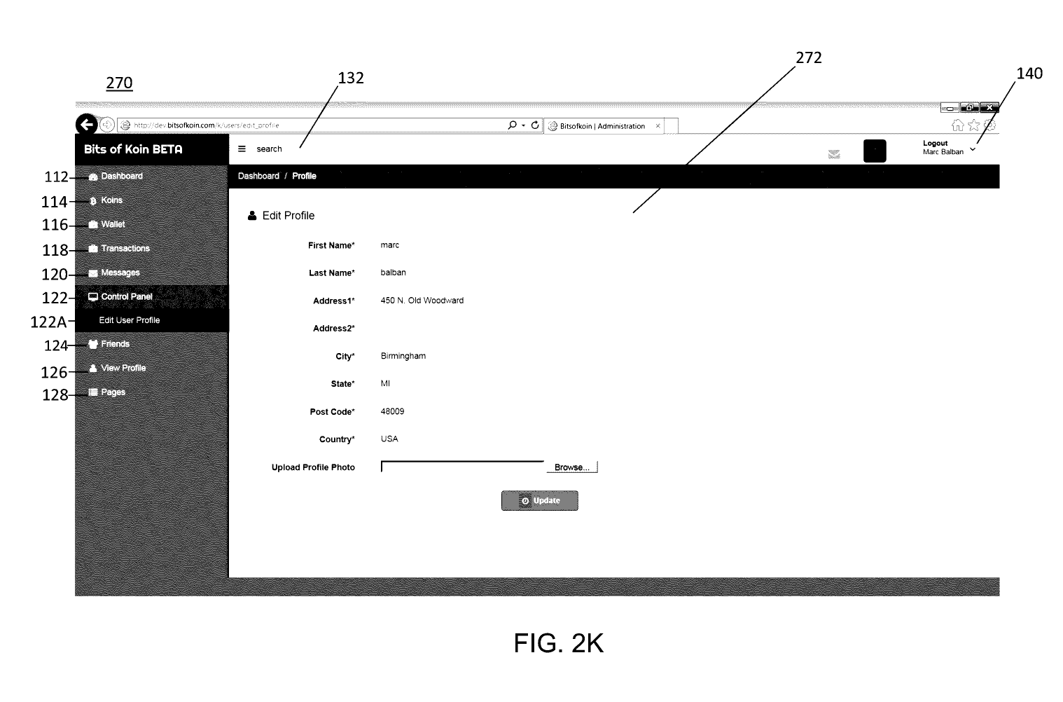

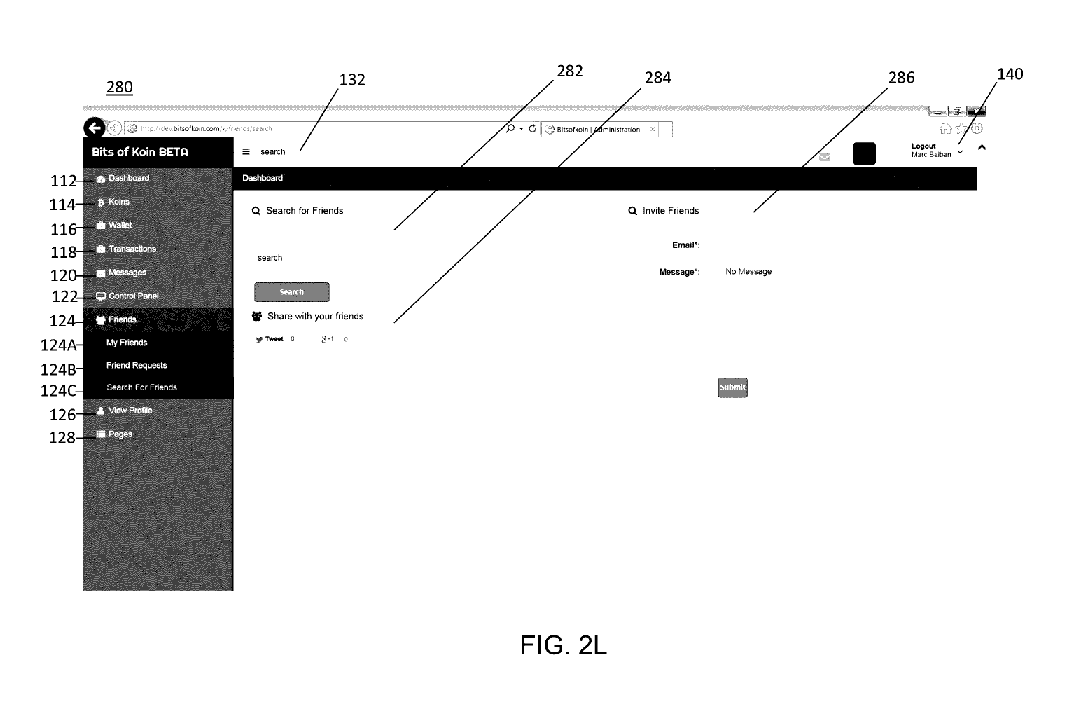

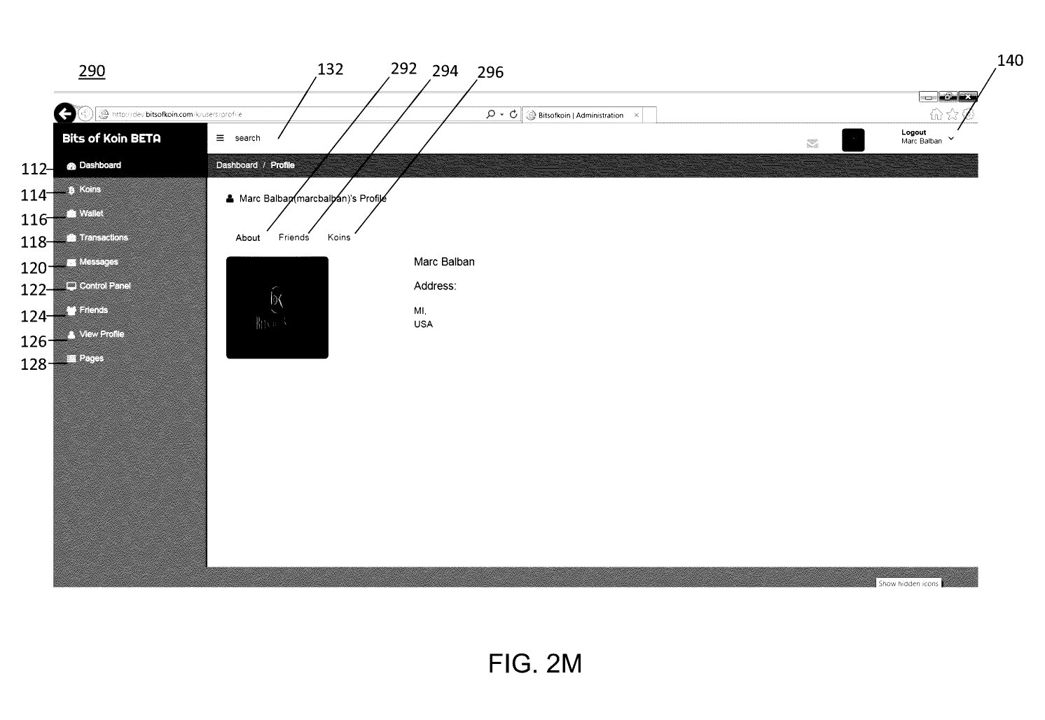

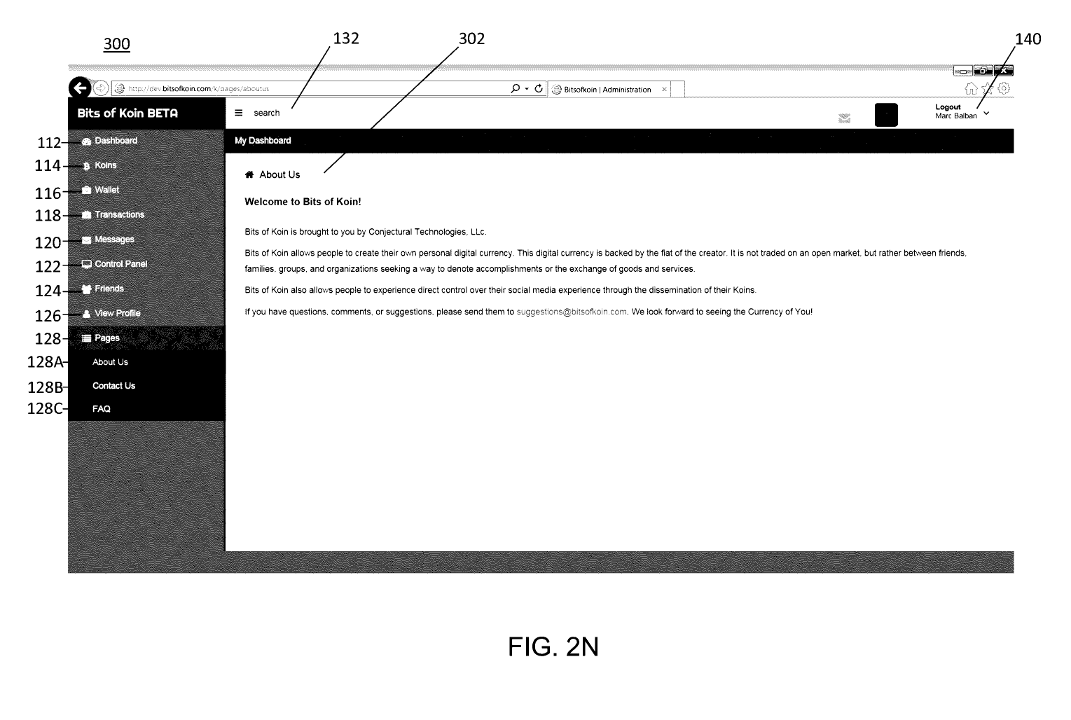

FIGS. 2A-2N are a series of screenshots of a graphical user interface (GUI) illustrating the functional and social aspects of the virtual personal electronic currency according to embodiments of the invention. FIG. 2A is a screenshot of login page 100 with a login field 102 for a usemame and password. Following a successful login, a user is directed to a screenshot of the “My Dashboard” page 110 of FIG. 2B with the dashboard tab 112 highlighted or selected in the navigation pane 111. Navigation tabs in the navigation pane also include: koins 114, wallet 116, transactions 118, messages 120, control panel 122, friends 124, view profile 126, and pages 128. It is appreciated that in other embodiments of the GUI there may be fewer or additional navigation tabs in the navigation pane 111. The open my wallet link 130 sends the user to their wallet page 200 shown in FIG. 2F. The search field 132 is used to search for terms and instructions. The read the frequently asked questions (FAQ) link 134 sends the user to the FAQ page that is also accessible under the pages tab 128 at the FAQ tab 128C. Also visible on the “My Dashboard” page 110 are the fields to search for friends 136 and invite friends 138 to join the community of users of the personal virtual currency. The logout 140 has a pull down menu for exiting the site.

FIG. 2C shows the koins tab 114 selected and expanded to sub tabs create koin 114A and manage koin templates 114B in screenshot 150. In FIG. 2D screenshot 160 illustrates the selection of the create koin tab 114A. The create koin field 162 provides a field to input a koin name 162, koin description 166, a circulation maximum for the koin 168, an access type (public, friends, private) 170, allow social sharing 172, koin image selection 174. The create koin field 162 further includes an area for setting redemption values with the ability to set values for individual koins illustratively including locking the value 176, the number of koins 178, a description 182, add more redemption values 180, number of koins to mint 184, koin denomination 185, and the ability to add new koin groups 186. The selection of the submit button 188 activates the setting entered on the page.

FIG. 2E shows the manage koin template tab 114B selected in screenshot 190. The upload koin template 192 provides input fields for a template name 194 and an associated image 196, the selections of which is executed with the submit button 188. Available koin templates are shown in the koin templates field 198.

FIG. 2F illustrates a screenshot 200 with the wallet tab 116 selected and the my wallet 116A highlighted. The created koins field 202 has a search function 204 for a specified koin. A columnar table may have the following columns: koin serial number 206, hide or show koin in profile 208, koin image 210, koin name 212, koin group 214, total number of koins 216, privacy setting 218, number of koin types displayed in the table 220, and actions related to the koins 222, which illustratively includes editing the koin, deleting the koin, redeeming the koin, sending the koin, sharing the koin via social media and editing the permissions on who is allowed to hold or see the koin. The currently owned koins 224 table similarly has a search function field 204 and may have the following columns: koin serial number 206, koin name 212, koin creator of the listed koin 226, total number of koins 228, number of koin types displayed in the table 220, and actions related to the koins 222.

FIG. 2G illustrates a screenshot 230 with the transaction tab 118 selected and the pending koin redemption 118A highlighted. A pending koin redemption requests table 232 is shown which includes the following columns: koin serial number 206, koin name 212, user name trying to redeem a koin 234, total number of koins to be redeemed 228, and actions related to the koins 222.

FIG. 2H illustrates a screenshot 240 with the transaction tab 118 selected and the pending koin redemption 118A highlighted. A successfully redeemed koin table 242 is shown which includes the following columns: koin serial number 206, koin name 212, user name trying to redeem a koin 234, total number of koins redeemed 244, and actions related to the koins 222.

FIG. 2I illustrates a screenshot 250 with the messages tab 120 selected and the inbox 120A highlighted. Available selections include: inbox 252, compose message 254, sent mail 256, and trash 258. As shown in screenshot 260 of FIG. 2J, the selection of the compose message provides the user with a message template 262.

FIG. 2K illustrates a screenshot 270 with the control panel tab 122 selected and the edit user profile 122A highlighted and the edit profile field 272 shown on the page.

FIG. 2L illustrates a screenshot 280 with the friends tab 124 selected and expanded to show subcategory tabs my friends 124A, friend requests 124B, and search for friends 124C. The selection of the search for friends 124C (as shown) provides a search for friends field 282, a share with friends field 284 through the selection of various social media, and an invite friend field 286.

Selection of the view profile tab 126 as shown in screenshot 290 of FIG. 2M allows the user to look at their profile with selection tabs including about 292, friend 294, and koins 296.

FIG. 2N shows screenshot 300 where the pages tab 128 is expanded to show subcategories about us 128A (highlighted), contact us 128B, and frequently asked questions (FAQ) 128C. The about us field 302 provides the user with an overview of the virtual personal electronic currency tool and the provider.

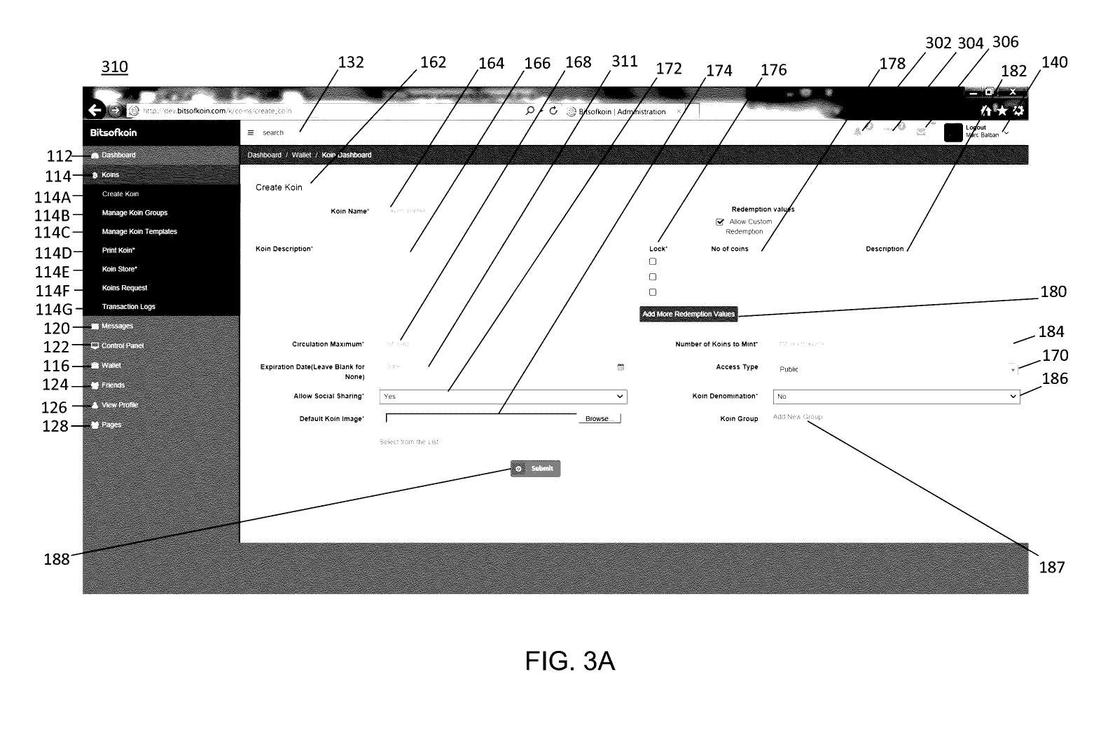

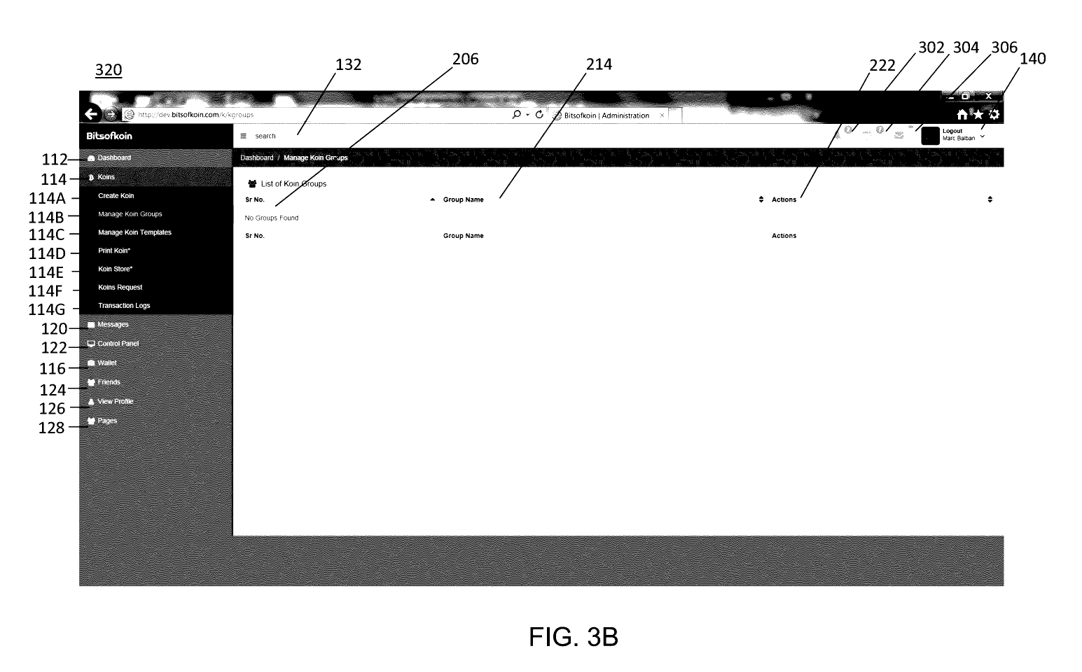

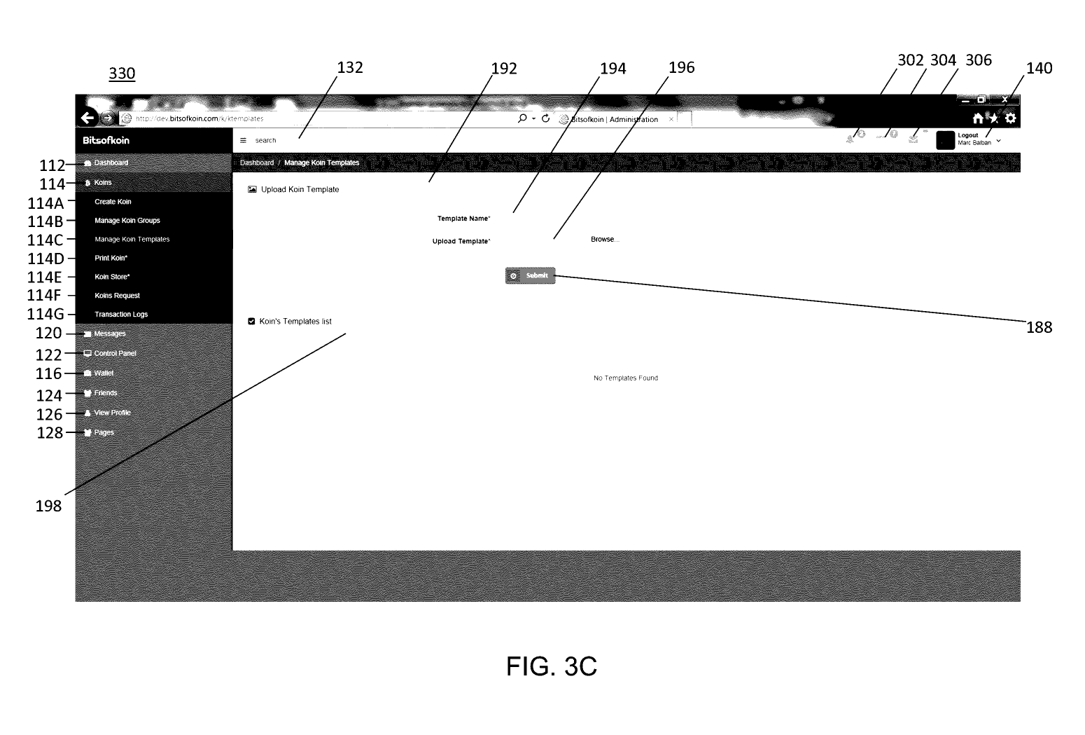

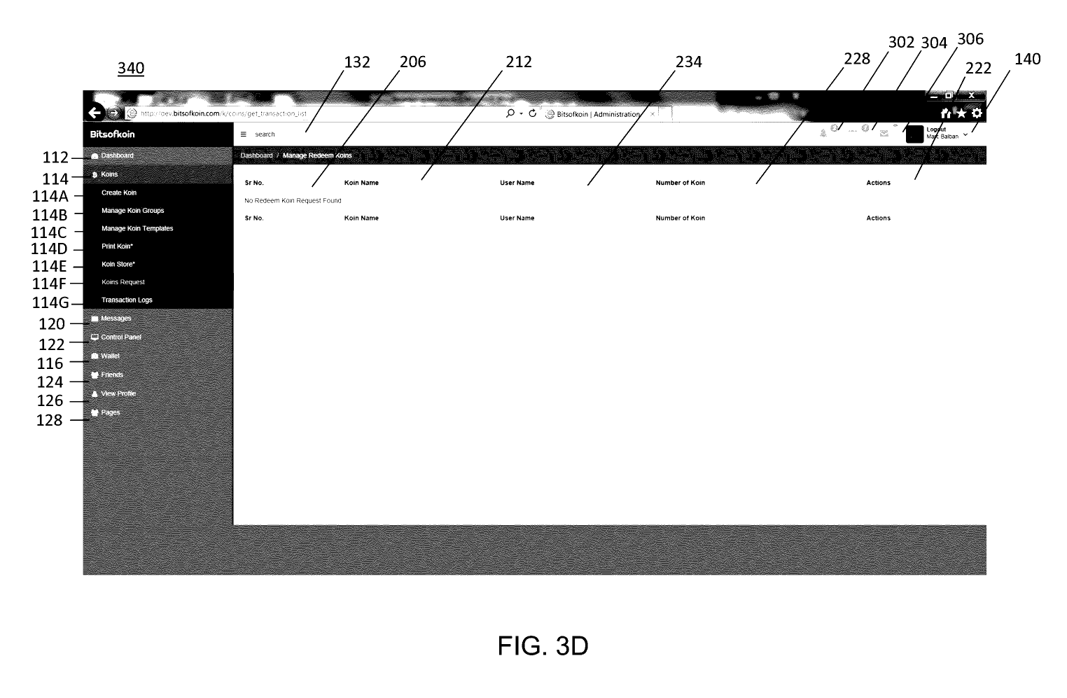

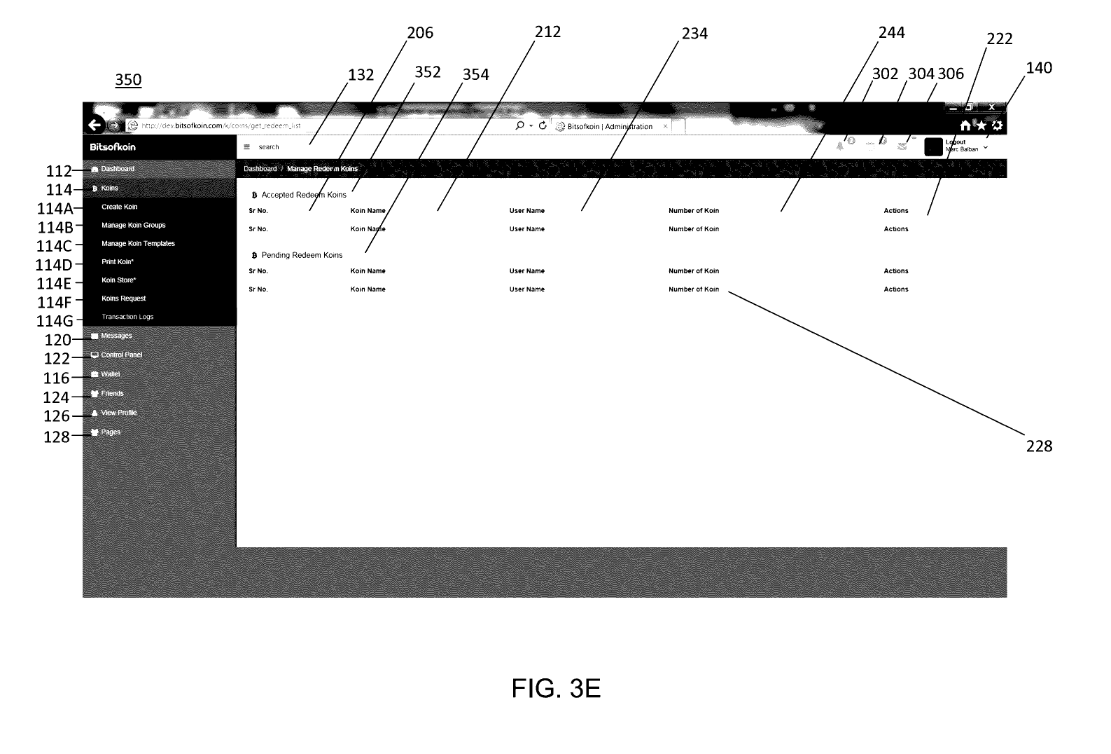

FIGS. 3A-3E are a series of screenshots of an embodiment of a graphical user interface showing the pages available to create a user defined electronic currency in accordance with an embodiment of the invention, where the description of the functions described in FIG. 2D are not repeated. Expiration date field 311 is added in screenshot 310 of FIG. 3A with respect to FIG. 2D. The koin tab 114 has additional sub tabs to the create koin 114A that includes manage koin groups 114B, manage koin templates 114C, print koin 114D, koin store 114E, koins request 114F, and transaction logs 114G. The upper right side of the screenshots have information icons including alerts 302, calendar reminder 304, and mail inbox 306. FIG. 3B shows a screenshot 320 with the manage koin groups tab 114B selected. FIG. 3C shows a screenshot 330 with the manage koin templates tab 114C selected. FIG. 3D shows a screenshot 340 with the manage koin request tab 114F selected. FIG. 3E shows a screenshot 350 with the transaction logs tab 114G selected and accepted redeemed koins table 352 and pending redeemed koins 354 shown.

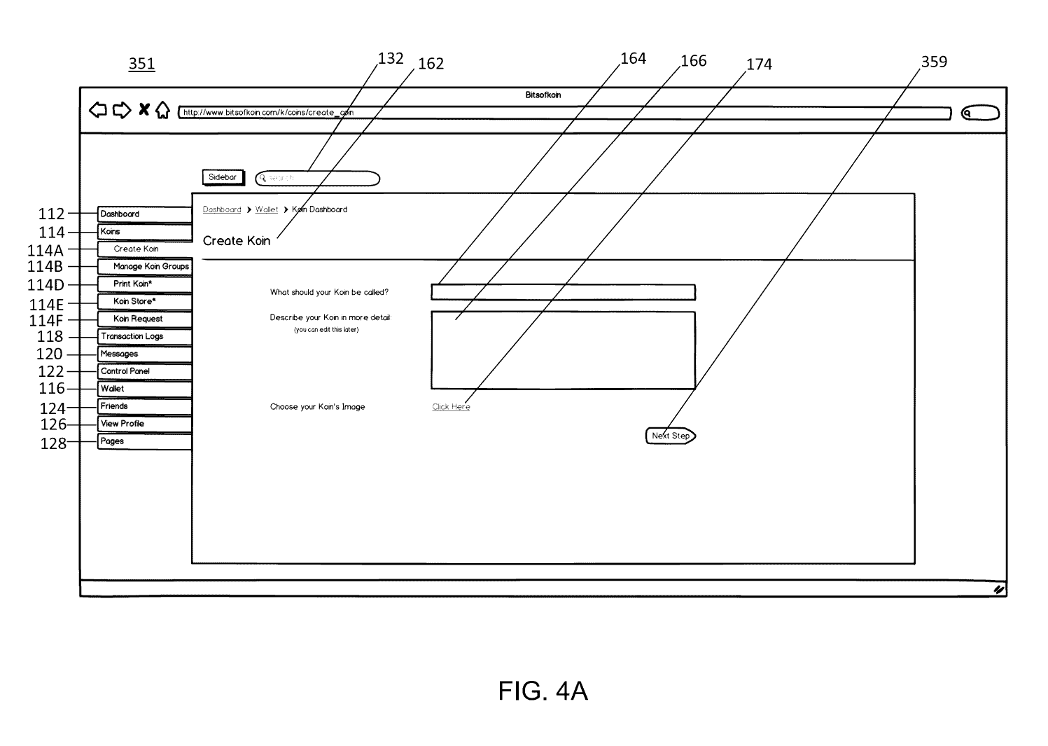

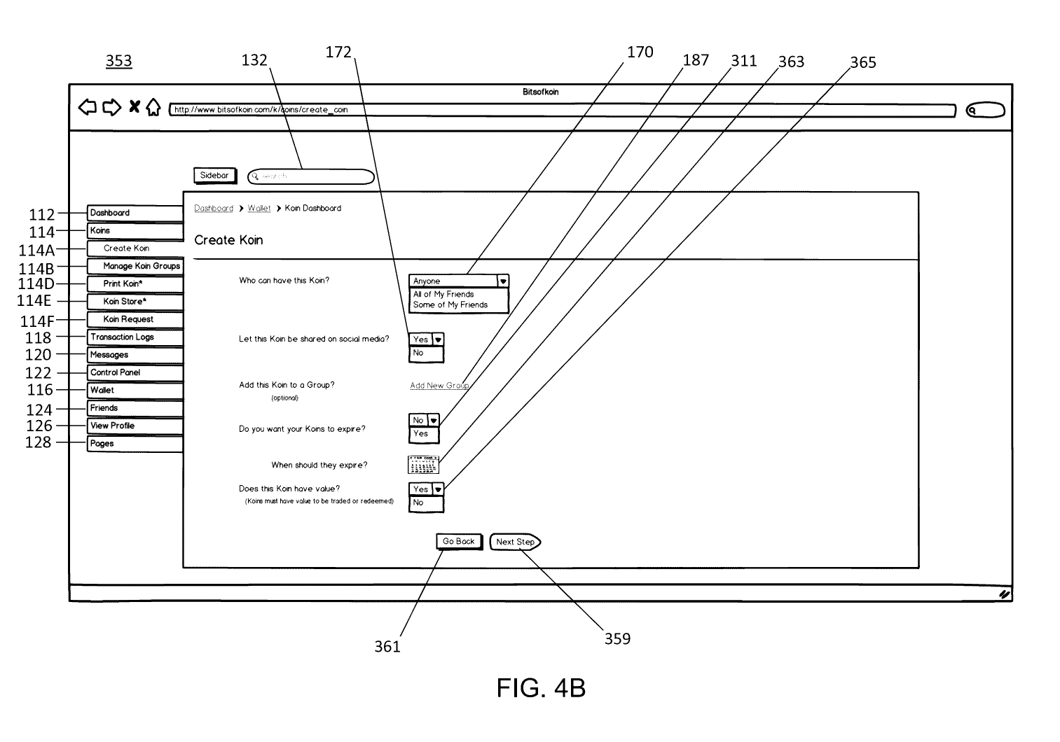

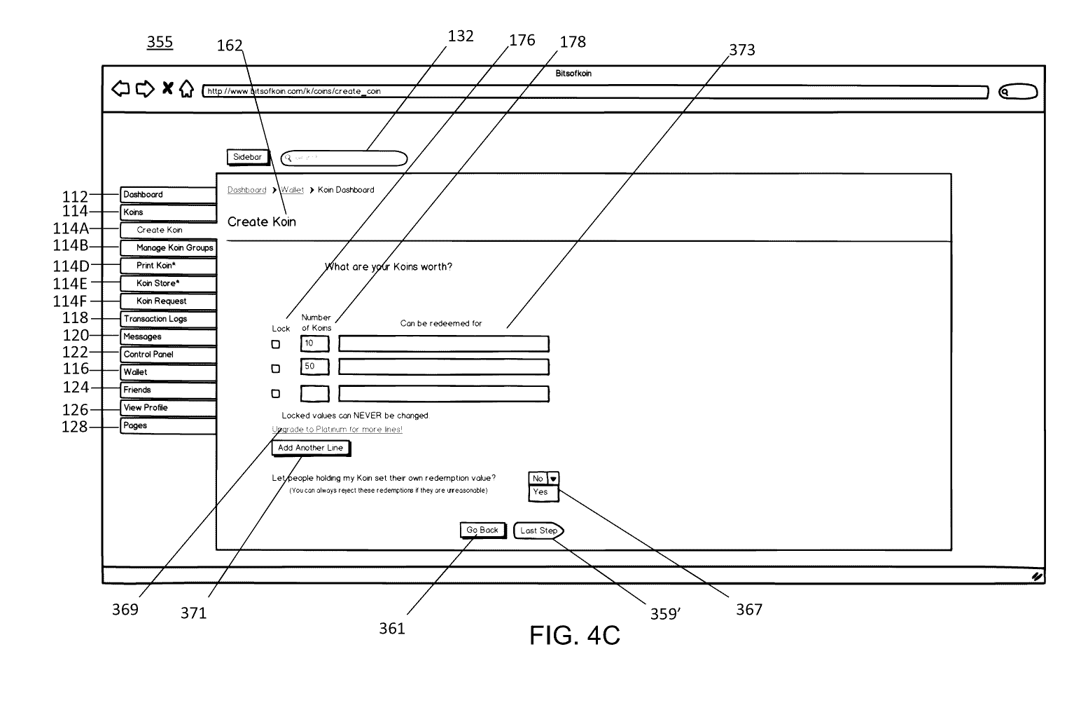

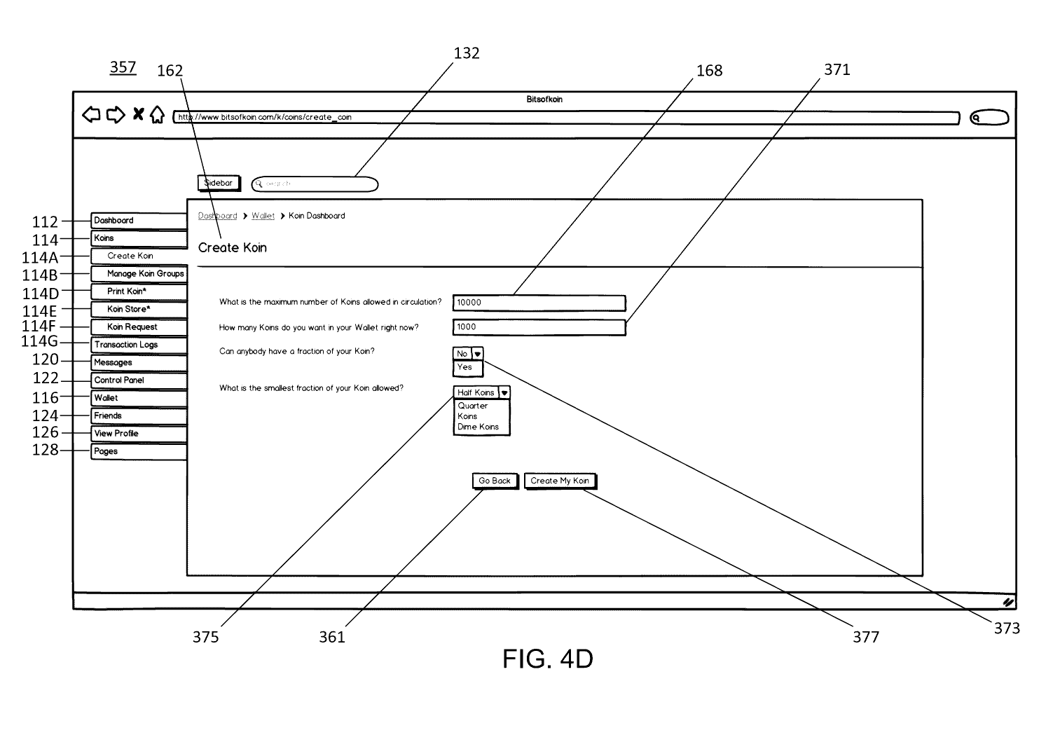

FIGS. 4A-4D are a series of screenshots of a graphical user interface showing the create koin function 162 selected with the create koin tab 114A conducted over four progressive pages (351, 353, 355, 357) in accordance with an embodiment of the invention. In FIG. 4A the creating user provides a name to a koin in entry field 164, and a description of the koin in description field 166. An image for the koin may be chosen via active link 174. Selection of the next step button 359 rolls up the current page, and unrolls the next part of the create koin form that is shown in FIG. 4B. As shown in FIG. 4B, the creating user may assign permission levels for whom the koin may be held or distributed to with pull down menu 172 with selections that may illustratively include anyone (public), all my friends, or some of my friends on a whitelist. The newly created koin may be added to a group via link 187. The creating user is presented with the choice of whether to set an expiration date for the koin with Yes/No selection 311. In the event that the creating user answers yes, the calendar 363 appears on the page 353, and the creating user selects an expiration date for the koin. The creating user may go back to the unrolled previous page view via go back button 361, or proceed to the next step via button 359 which is shown in FIG. 4C. On page 355, the creating user may set the value of the koin in the can be redeemed for fields 373 for a user defined number of koins in fields 178. The values of the koins may be permanently locked (cannot be unlocked once locked) with the selection of check boxes 176. The creating user may opt for a higher membership level via link 369 in order to add additional lines 371 for koins. The creating user then proceeds to the final creation page 357 of FIG. 4D via the last step button 359′. Using FIG. 4D the creating user sets the maximum number of koins allowed in circulation via entry field 168, the number of active (minted) koins via entry field 371. The creating user also decides if fractional or portions of a koin may be held via Yes/No menu 373. If the creating user permits fractions of koins, then the pull down menu 375 appears for setting the smallest fractional value. The create koin process is then completed by selecting the create my koin button 377.

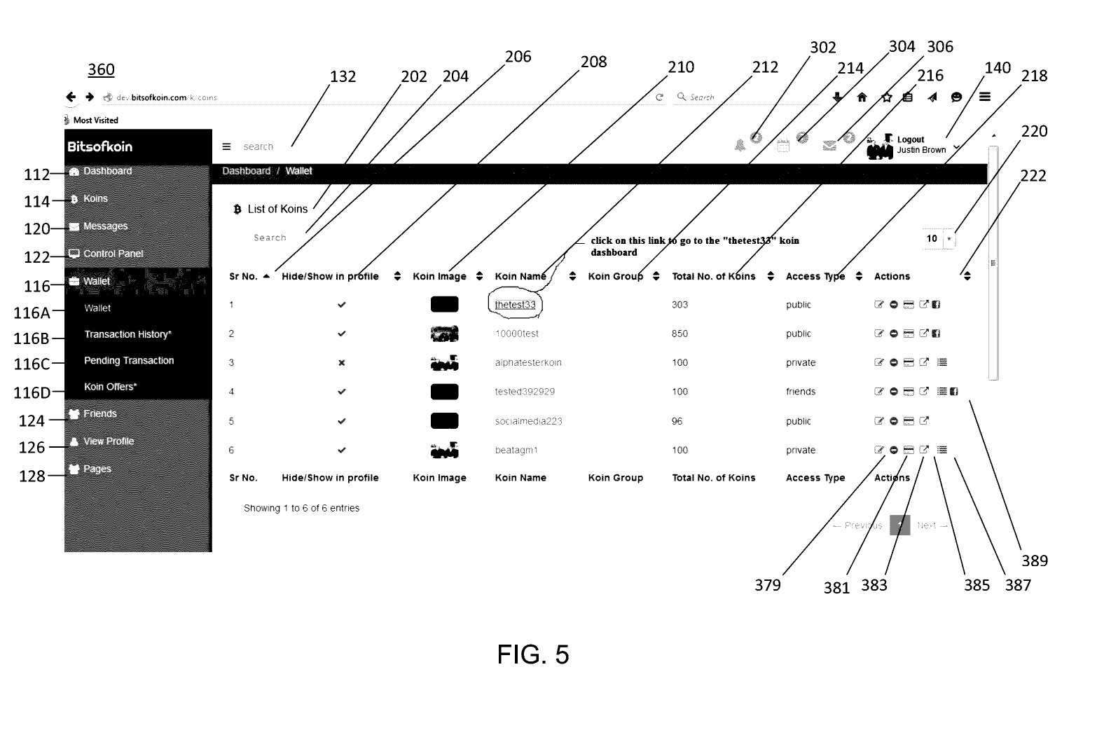

FIG. 5 is a screenshot 360 of a wallet with a list of koins 202 containing a set of different user currencies created in a user account in accordance with an embodiment of the invention. Actions 222 that may be used with the listed koins illustratively include edit 379, delete 381, redeem 383, send koin 385, edit list 387, and social network access 389.

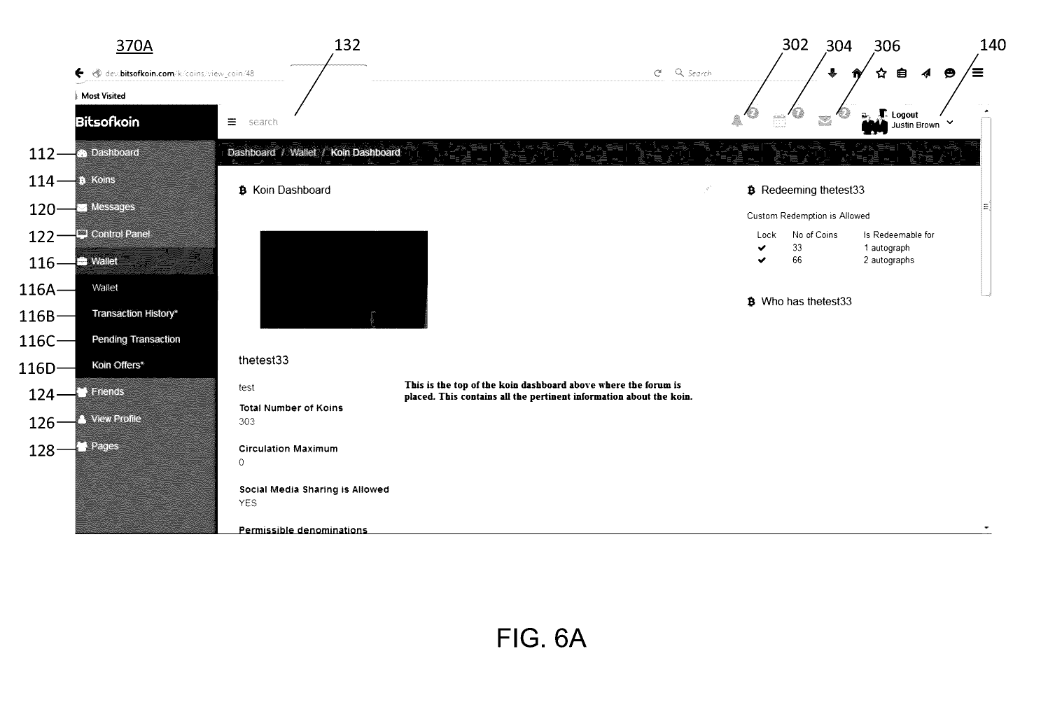

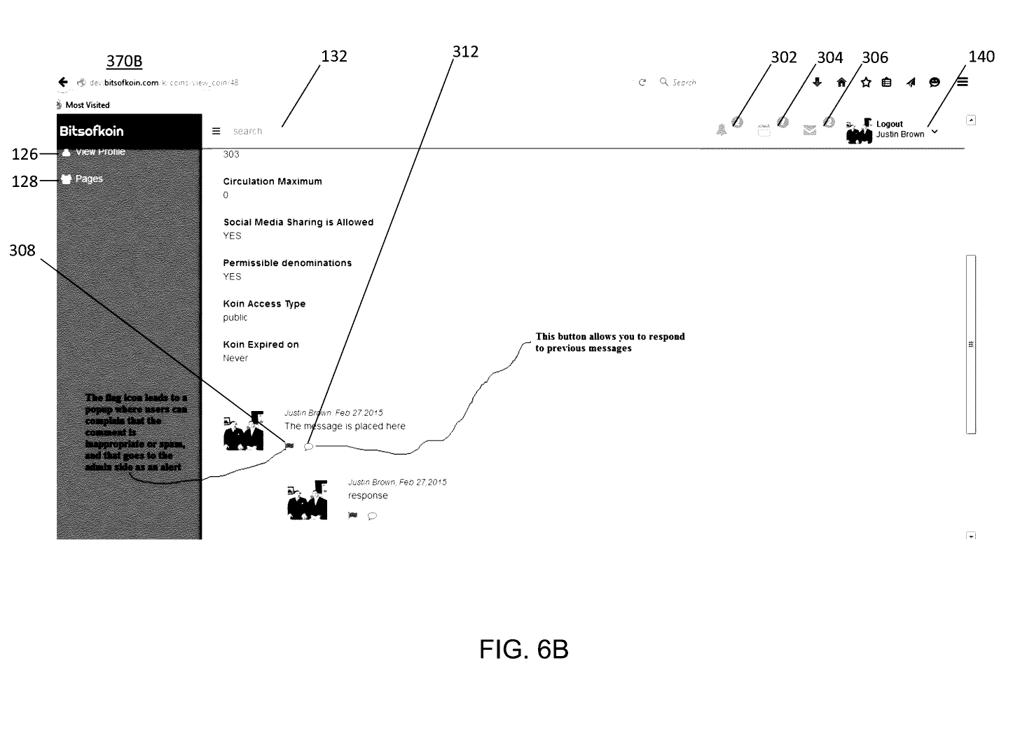

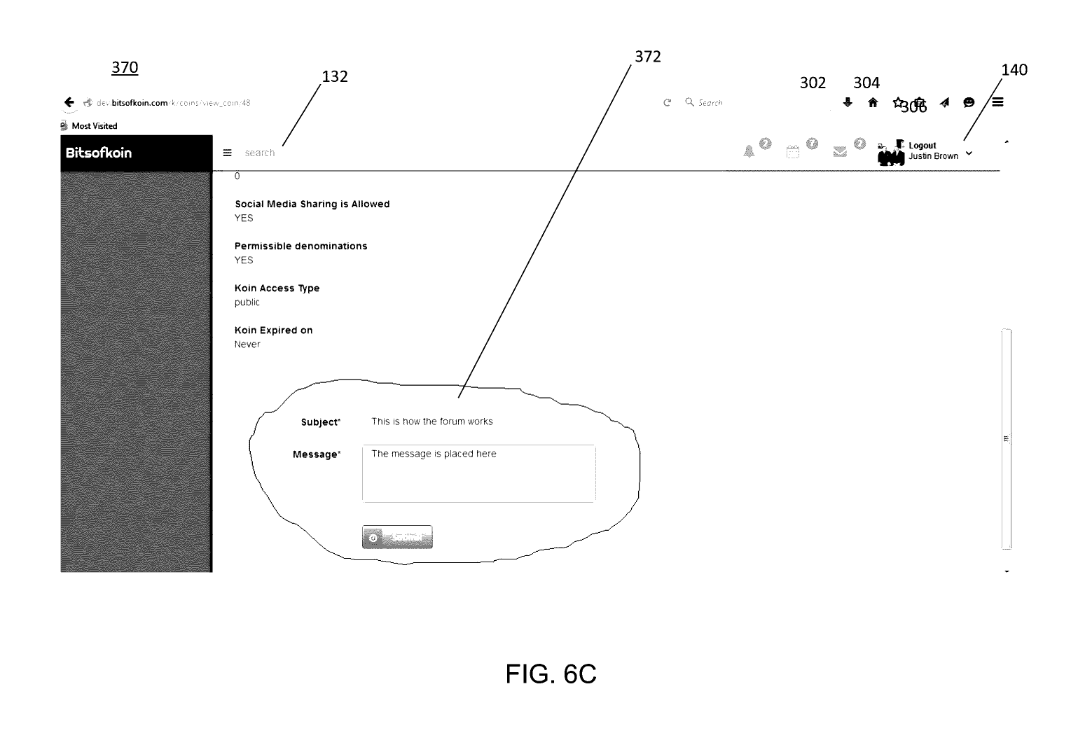

FIGS. 6A-6C combine in a scroll down manner (370A, 370B, 370C) to show a screenshot of an entire page with information and the forum social communication feature for a currency selected (“thetest33”) in the list of FIG. 5 in accordance with an embodiment of the invention. As shown in FIG. 6B the selection of flag icon 308 produces a popup where users can complain about inappropriate content or spam to the administrator of the site. The thought balloon 312 allows the user to respond to a previous message. FIG. 6C shows the template 372 for posting a message in the user forum.

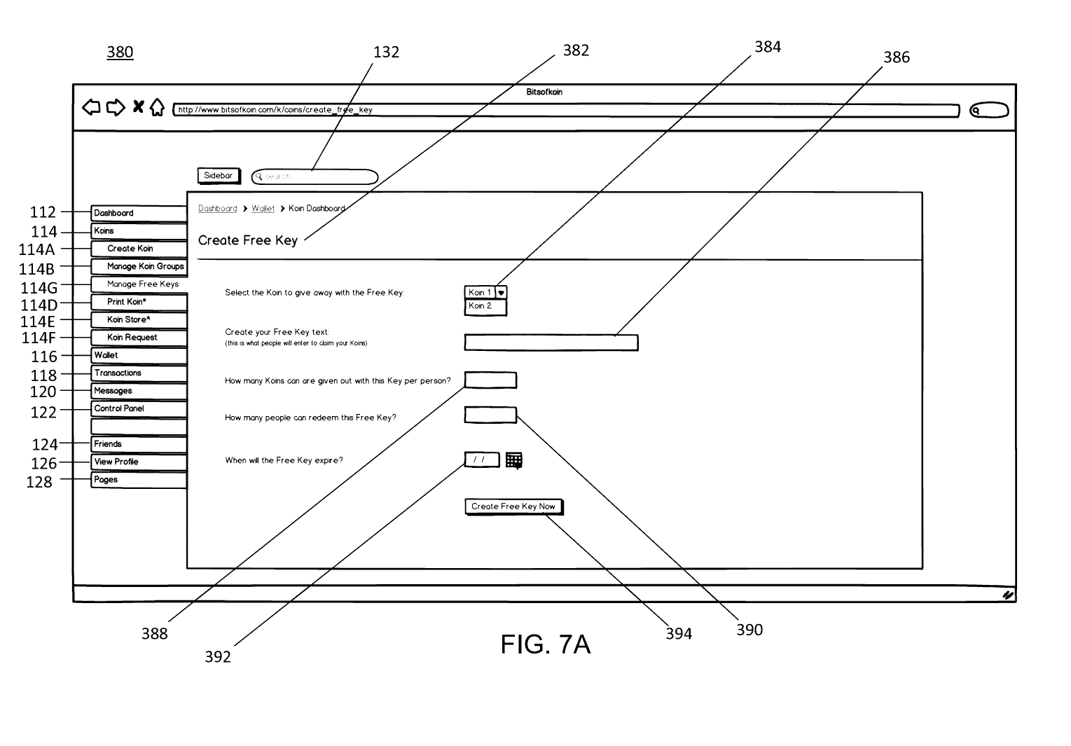

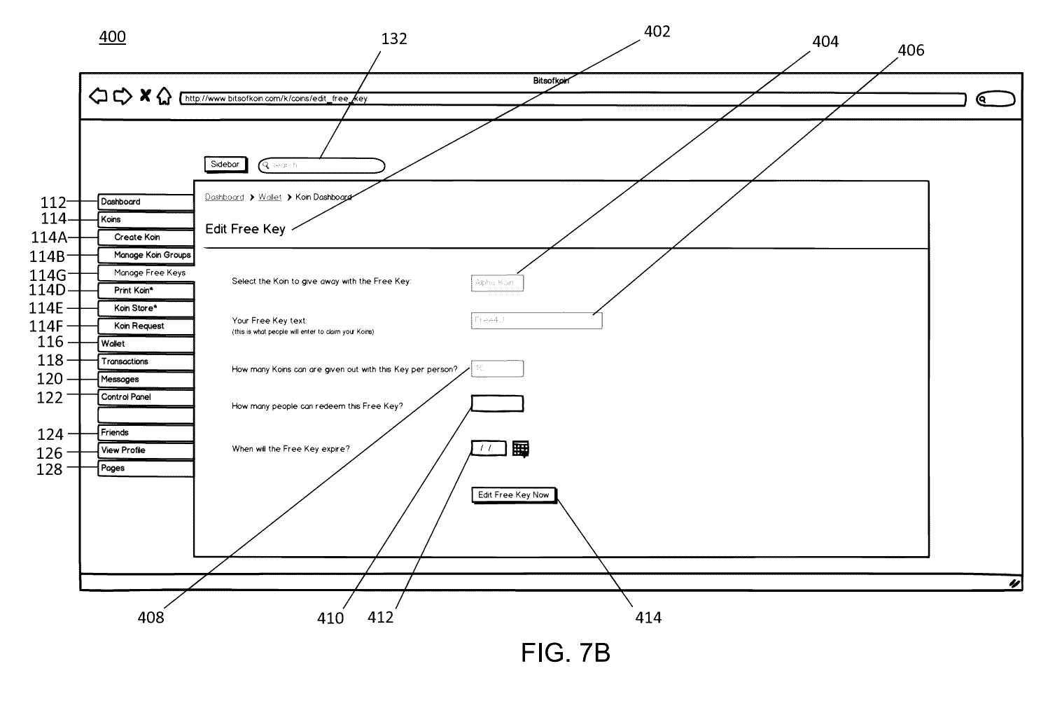

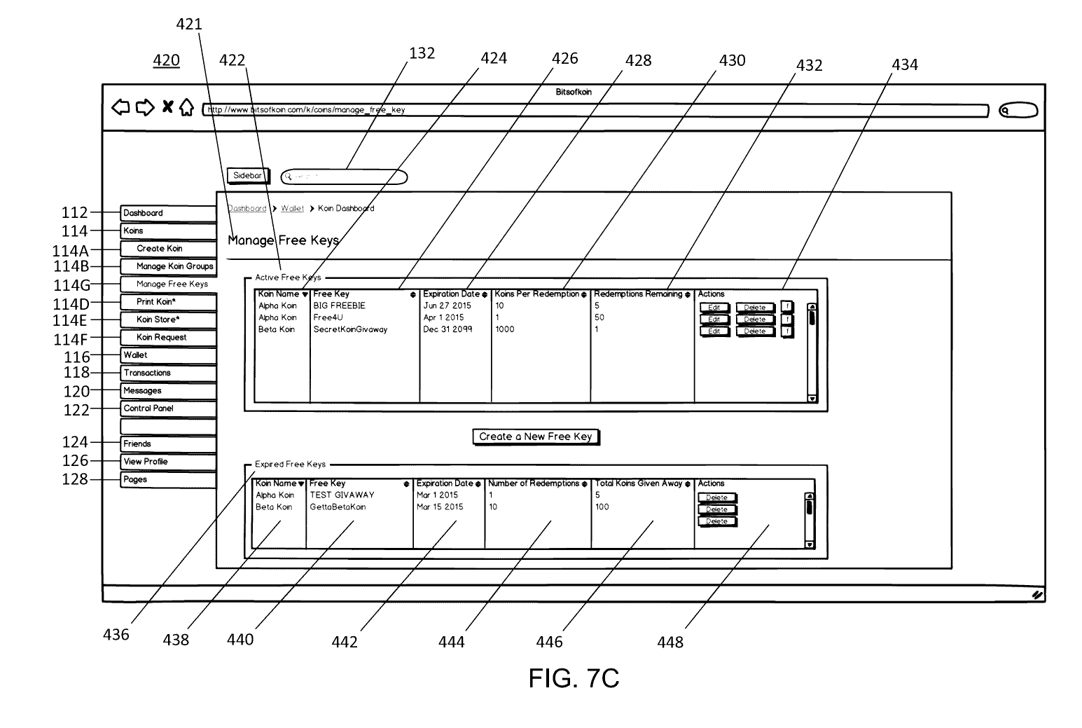

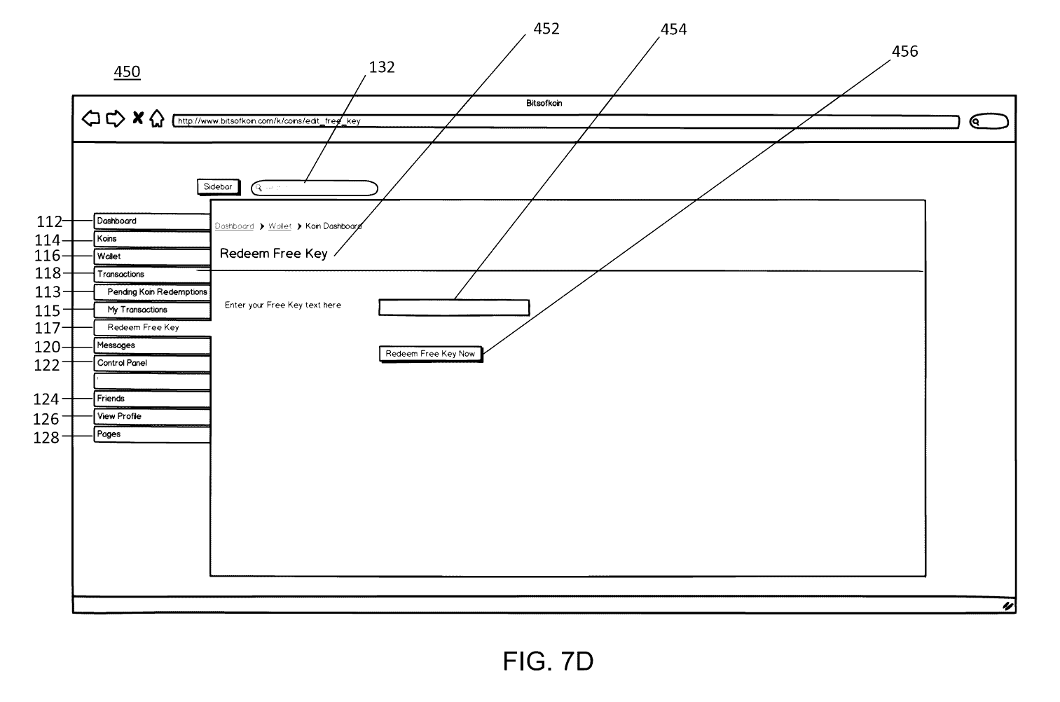

FIGS. 7A-7D are a series of pages of the graphical user interface for the user creation and use of the free key in accordance with an embodiment of the invention.

FIG. 7A is a screenshot 380 of a create free key 382 function under manage free keys tab 114G. The user may select the koin to give away with the free key (384) from a list of available koins the user has created. The “create your free text field” 386 allows the user to input alphanumeric codes for the free key. In a specific embodiment the free key alphanumeric code may have a 256 character maximum length. In field 388 the user sets how many koins are to be given to a free key holder, where the number of koins is lower than the total circulation of the koin. In field 390 a limit for the number of people who may redeem the free key is set, where the circulation for the koin may not be exceeded. The calendar function 392 is used to set an expiration date of the koin (at least 1 day ahead of the expiration or todays date). The create free key now button 394 implements the values set on this page.

FIG. 7B is a screenshot 400 of an edit free key 402 function. The koin to give away with the free key is auto populated in field 404. The free key text 406 is auto populated in field 406. The number of koins that are given out per person with the key 408 is auto populated based on the inputs of FIG. 7A. The edit free key now button 414 implements the values set on this page. The how many people who may redeem a coin 408 is limited by the circulation. The calendar function 412 is used to set an expiration date of the koin (at least 1 day ahead of the expiration or todays date).

FIG. 7C is a screenshot 420 of a manage free keys 421 with tables for active free keys 421 and for expired free keys 436. The active free key table 421 includes the following columns: koin name 424, free key 426, expiration date 428, number of koins per redemption 430, redemptions remaining 432, and action (edit, delete, share on social media) that may be done to the free key koin 434. The expired free keys table 436 may have the following columns: koin name 438, free key 440, expiration date 442, number of redemptions 444, total koins given away 446, and actions (delete) 448.

FIG. 7D is a screenshot 450 of a redeem free key field 452 where the user enters the free key text in field 454 and submits with the redeem free key button 456. If a user attempts to redeem an incorrect/invalid free key an error message such as “This free key is invalid. Please double check the free key that was provided.” will appear on their display screen. If an expired free key is entered an error message such as “This free key has expired” may appear on the user screen. The number of invalid attempts may be tracked, and after a specified number of invalid attempts the user may be locked out for the day.

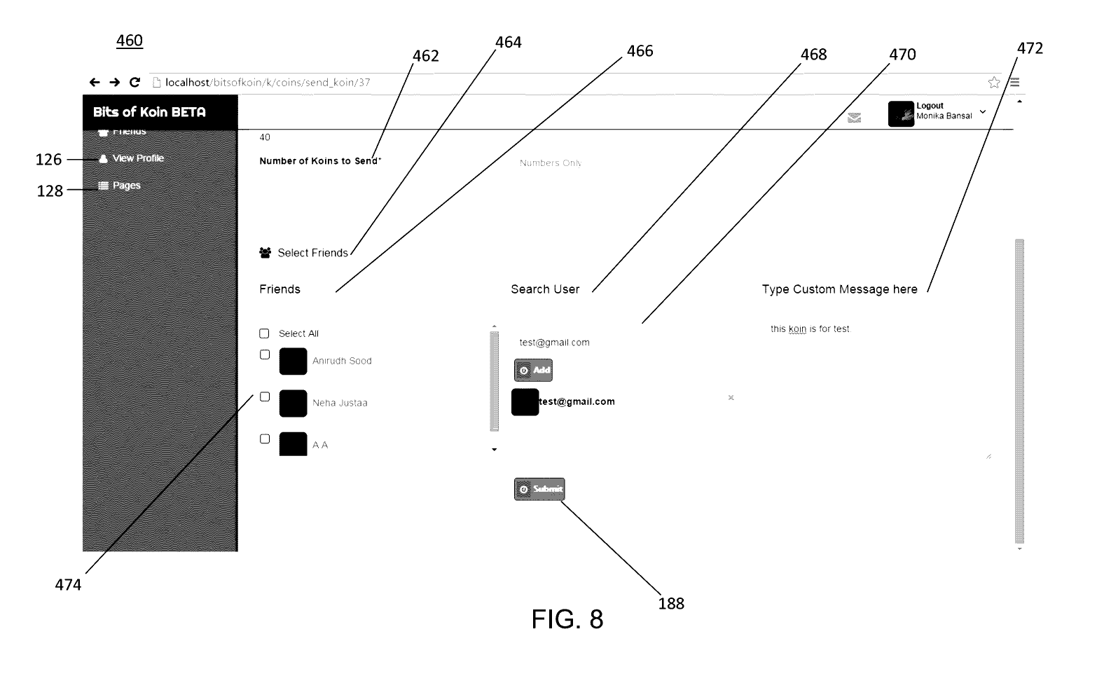

FIG. 8 is a screenshot of a page 460 illustrating the send koin functionality including sending via e-mail in accordance with embodiments of the invention. The portion of page 460 shown is the lower scrolled down portion of the wallet accessed via the send koin button 385 in the action column 222 (see FIG. 5) of the wallet tab 116A. The number of koins to send is specified by the user creator in fillable section 462. It is noted that the total number of koins that may be sent must be less than or equal to the total number of koins currently in the user's wallet. The select friends section 464 is configured with a friends section 466 that allows the creating user to select from a scrollable list 474 of names of friends to whom the user may send koins to. The select friends section 464 provides creating users with a way to invite new users by sending koins via e-mail and with a customized message. Under the search for user section 468, the creating user/account owner may type in an e-mail address 470 to send a koin via e-mail, if the recipient is not currently a member of the personal currency platform. A custom message may also be sent with the koin as typed in the message field 472. The koin and accompanying message are sent in response to selecting the submit button 188.

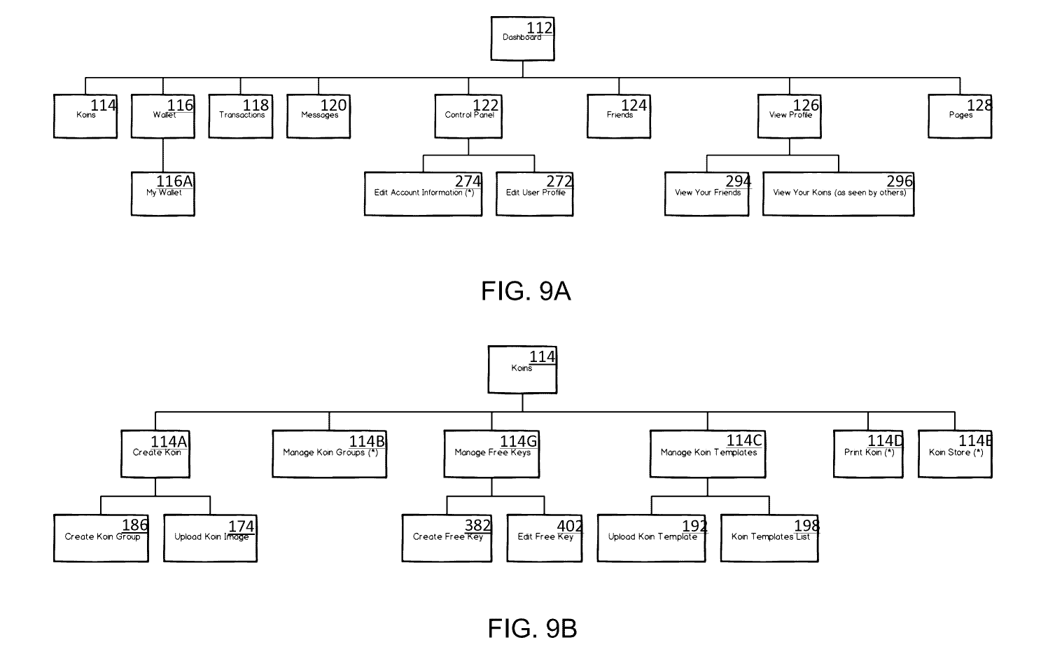

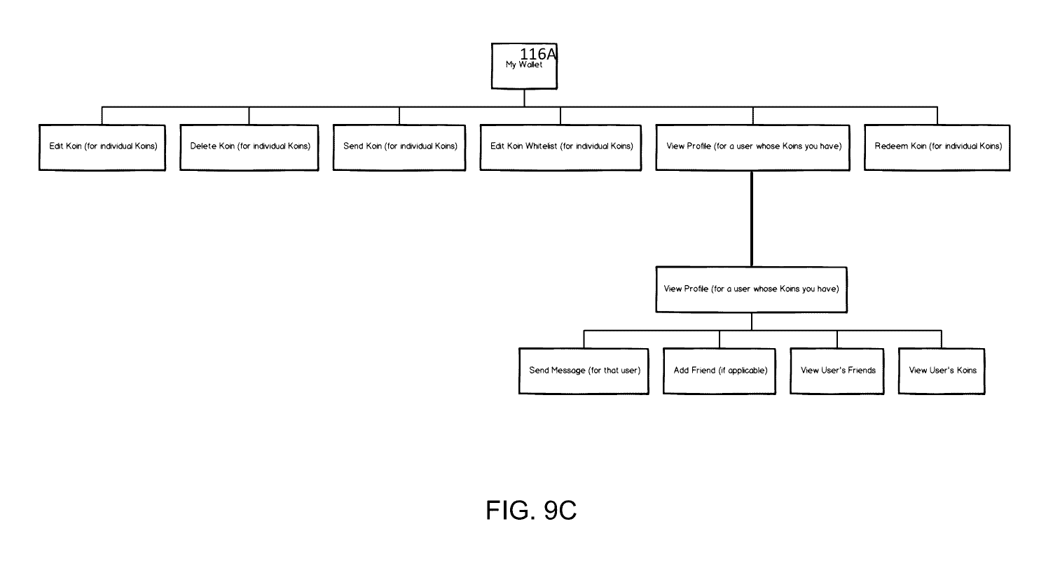

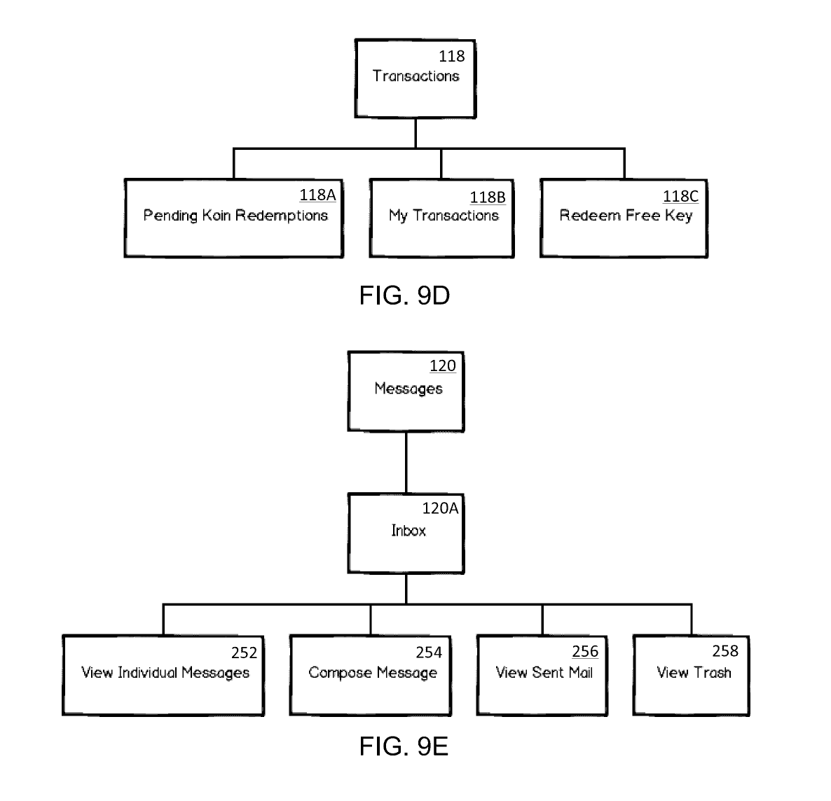

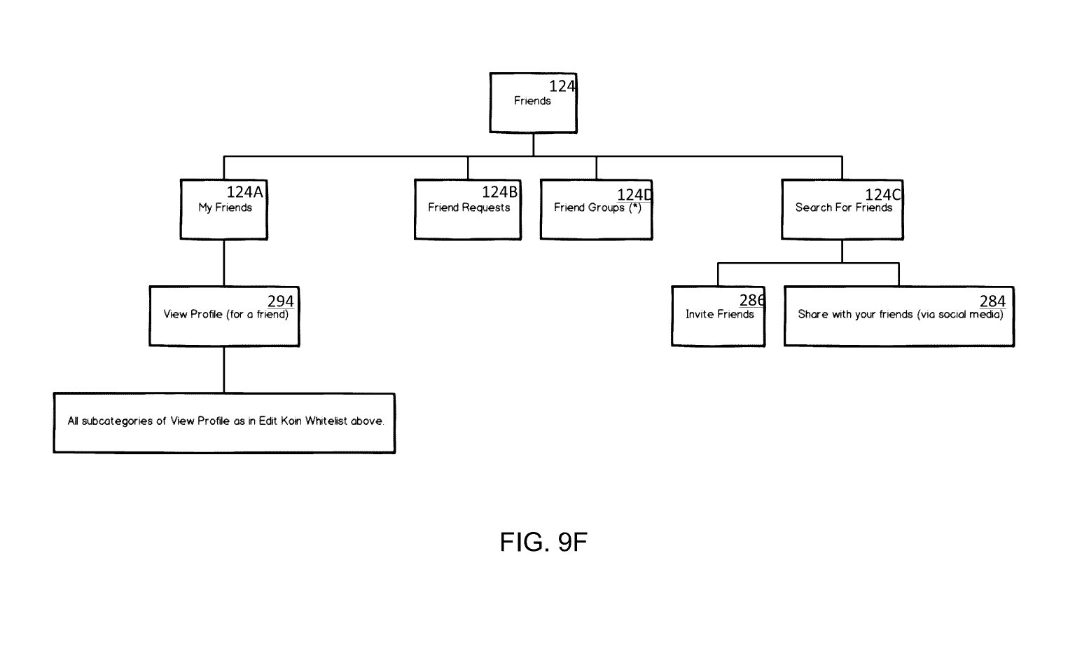

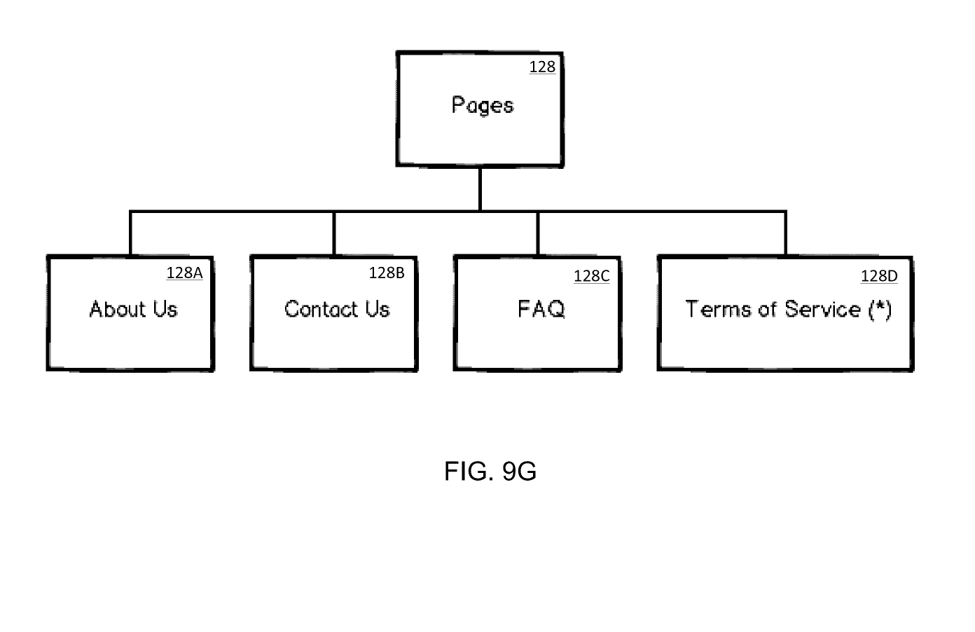

FIGS. 9A-9G illustrate the branches of a site map of the graphical user interface pages shown in FIGS. 2-7 to show the navigation tree through the GUI in accordance with embodiments of the invention.

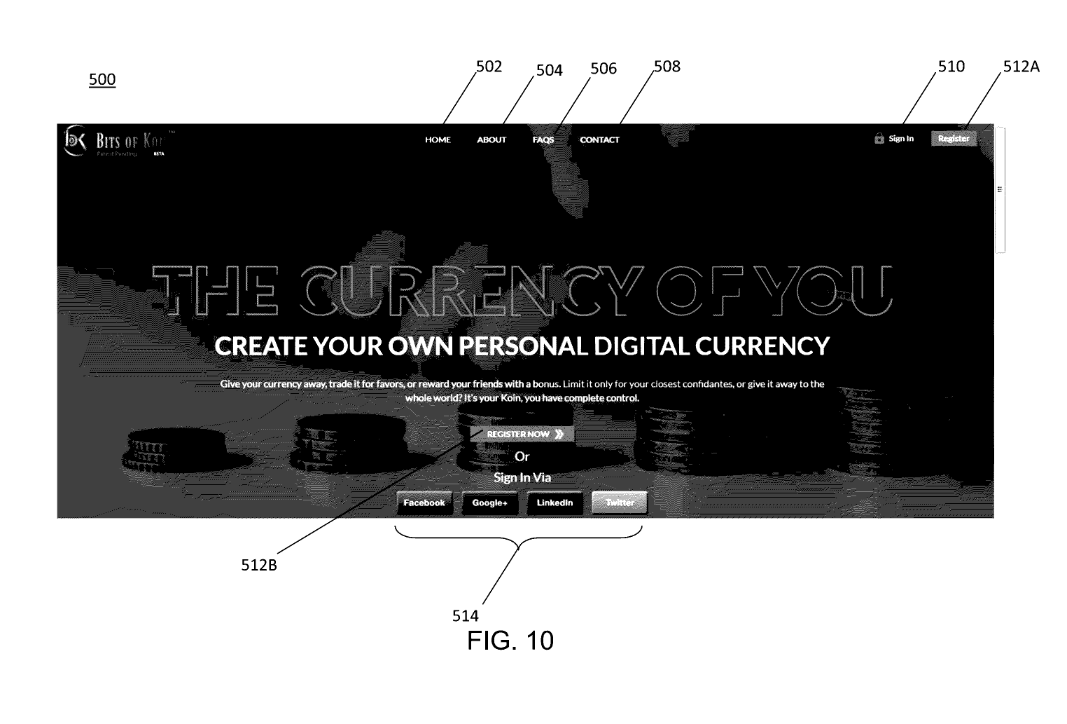

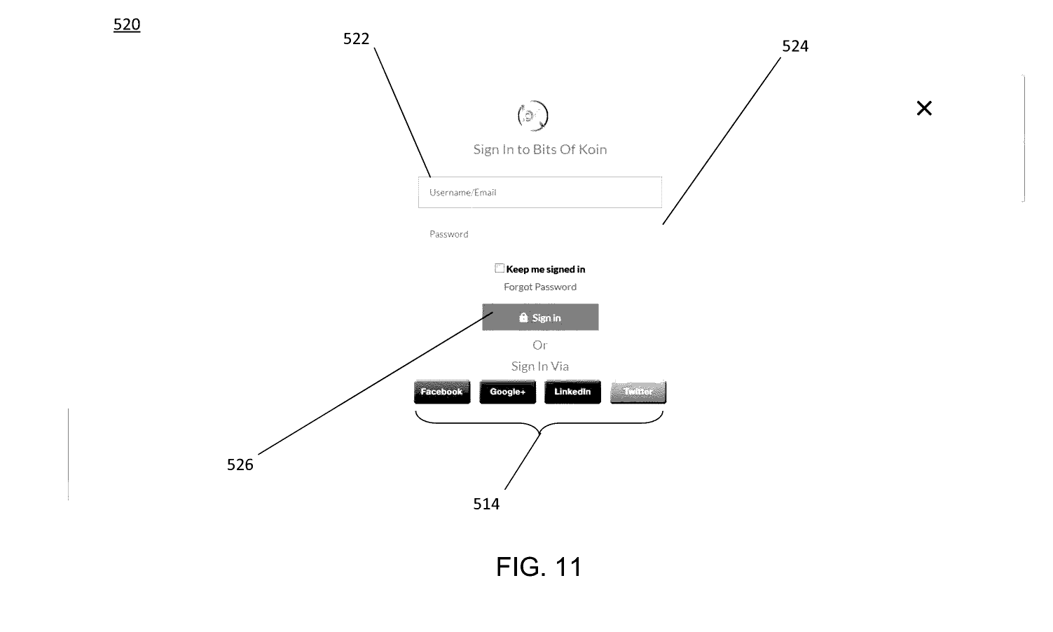

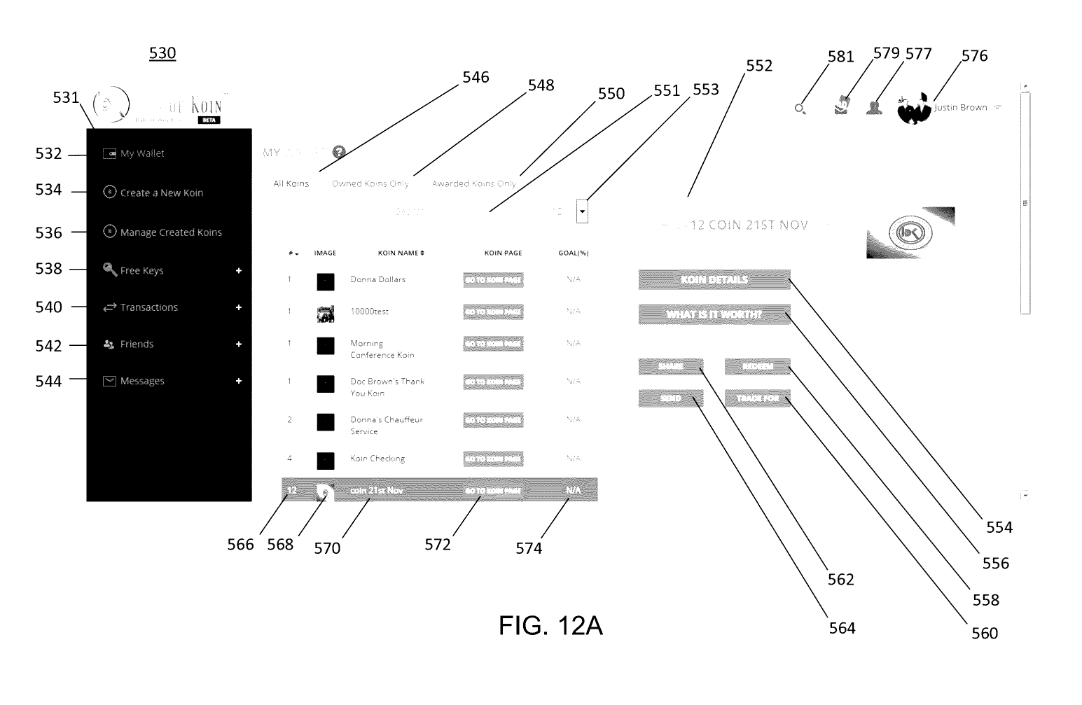

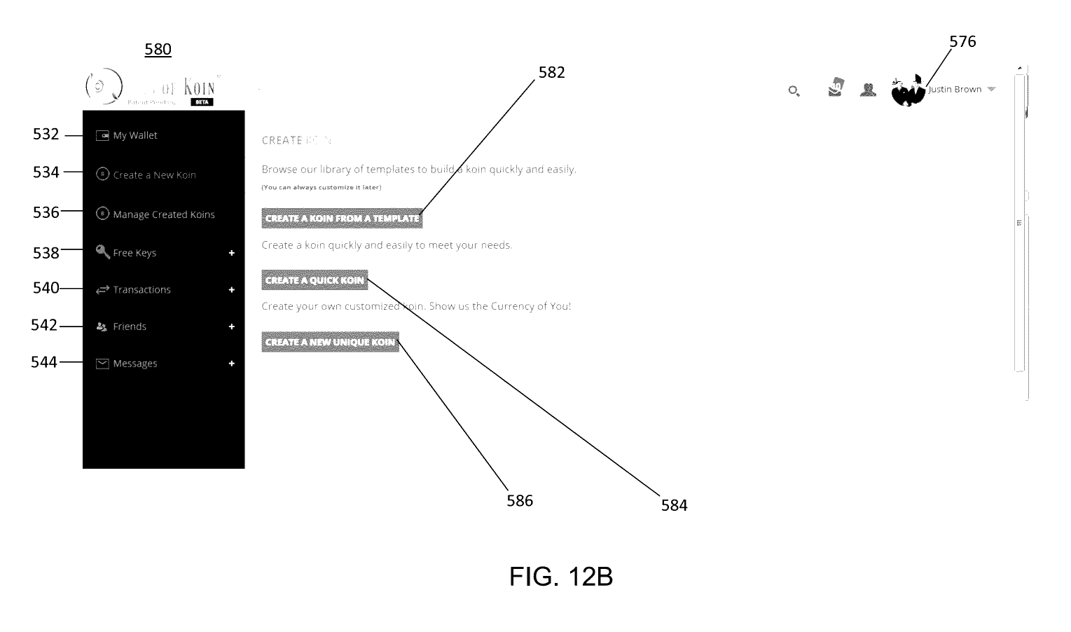

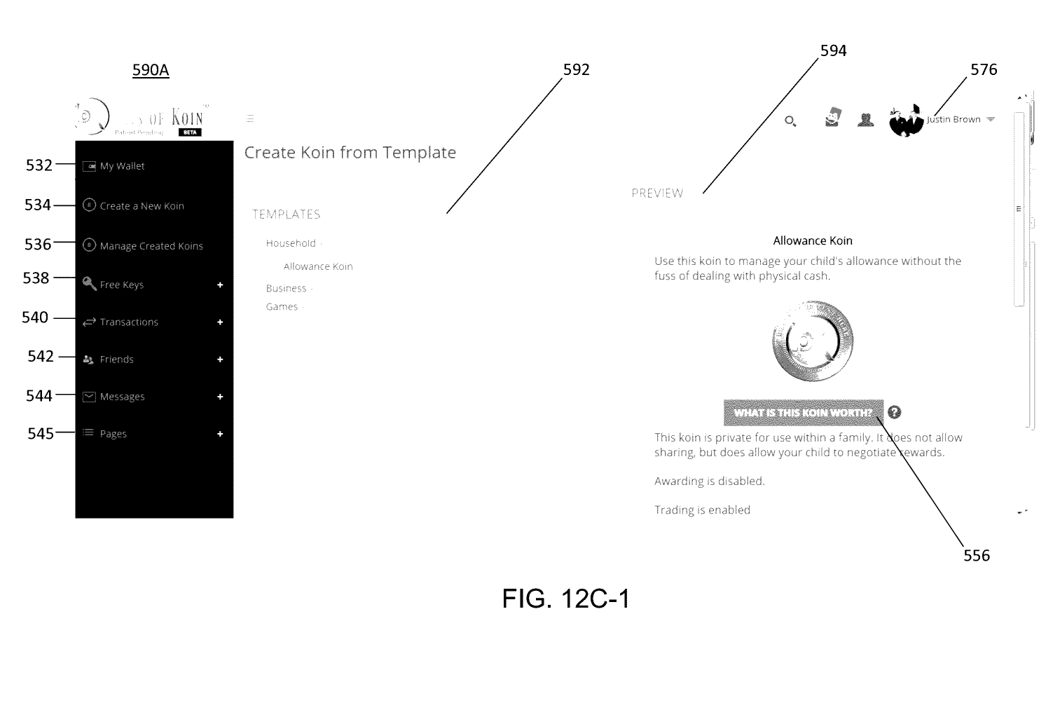

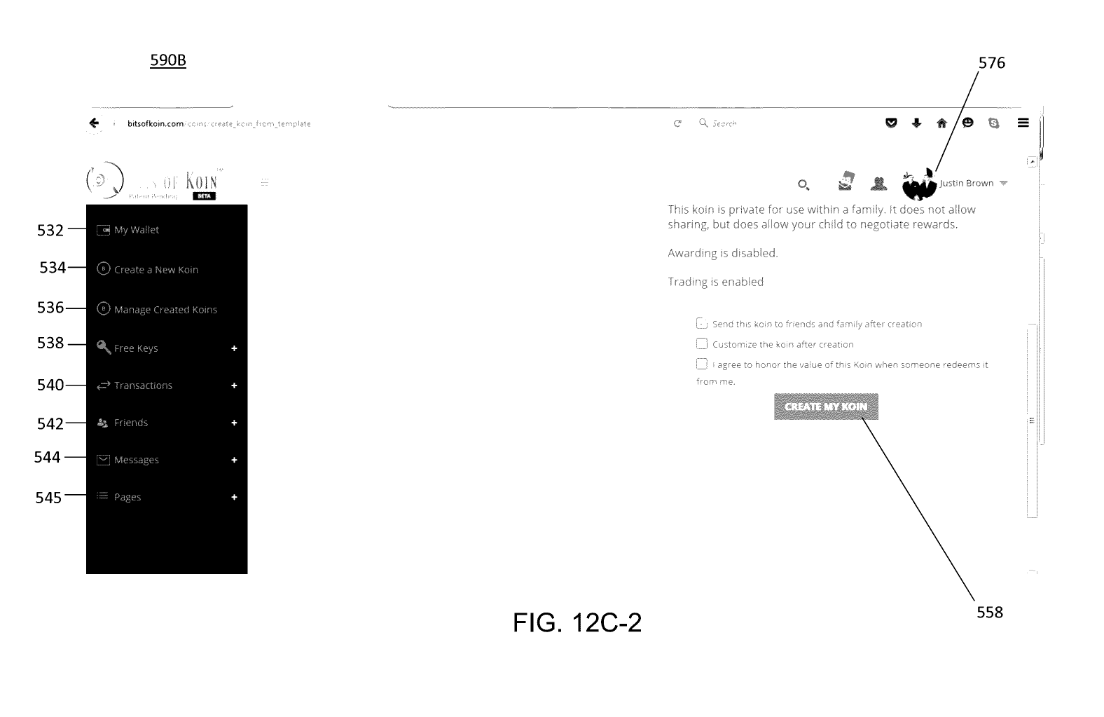

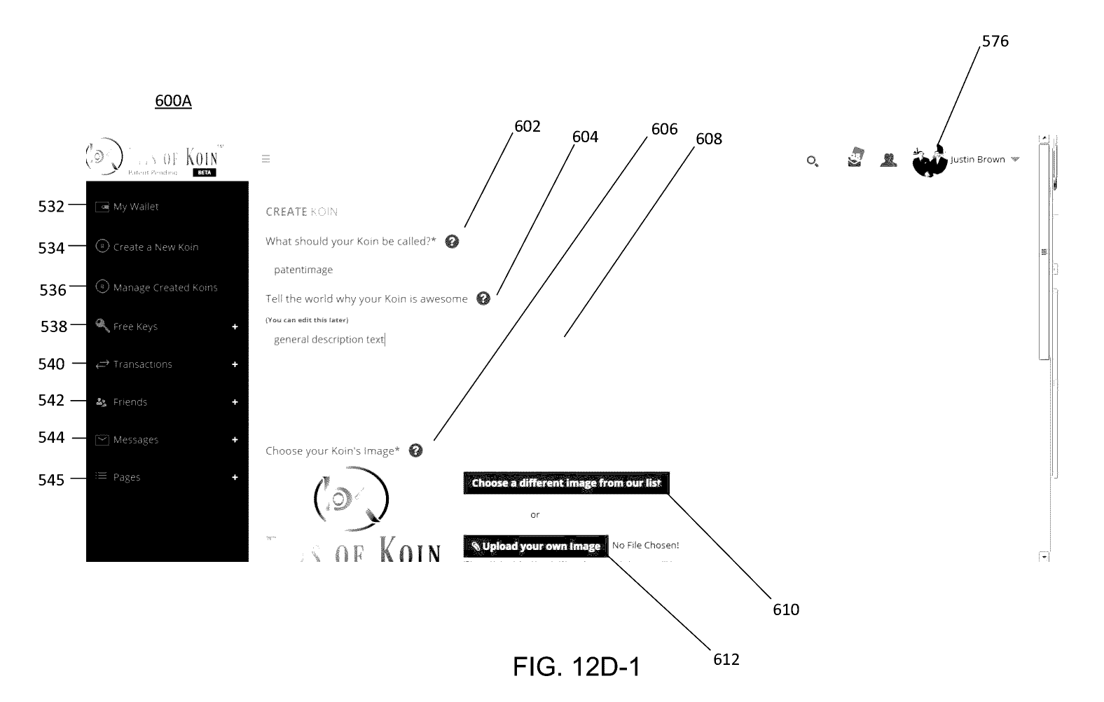

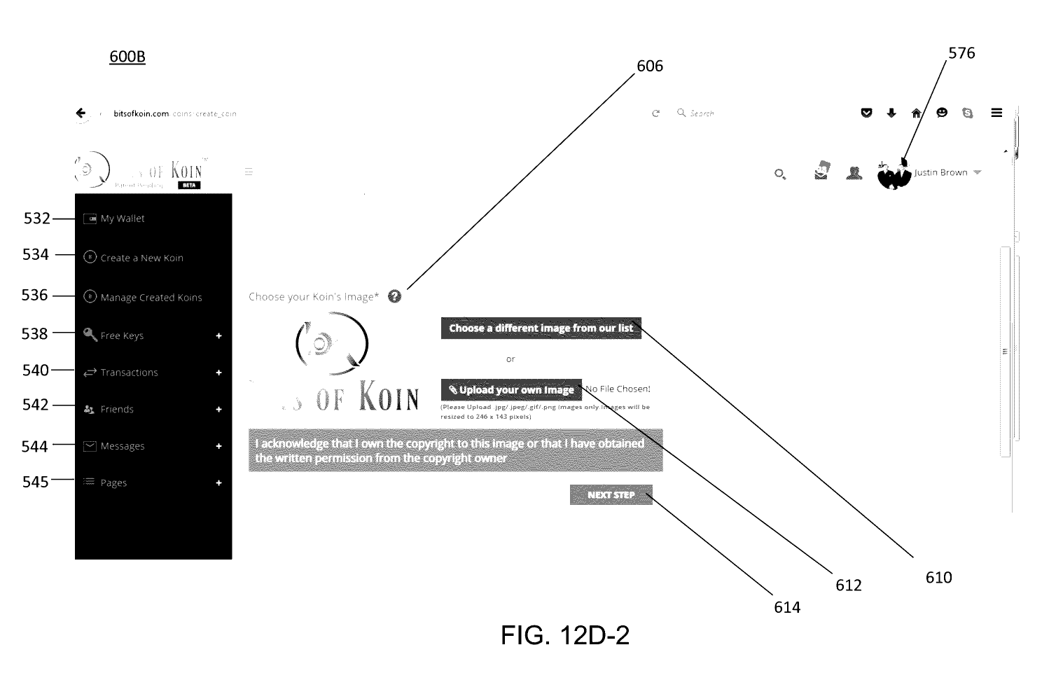

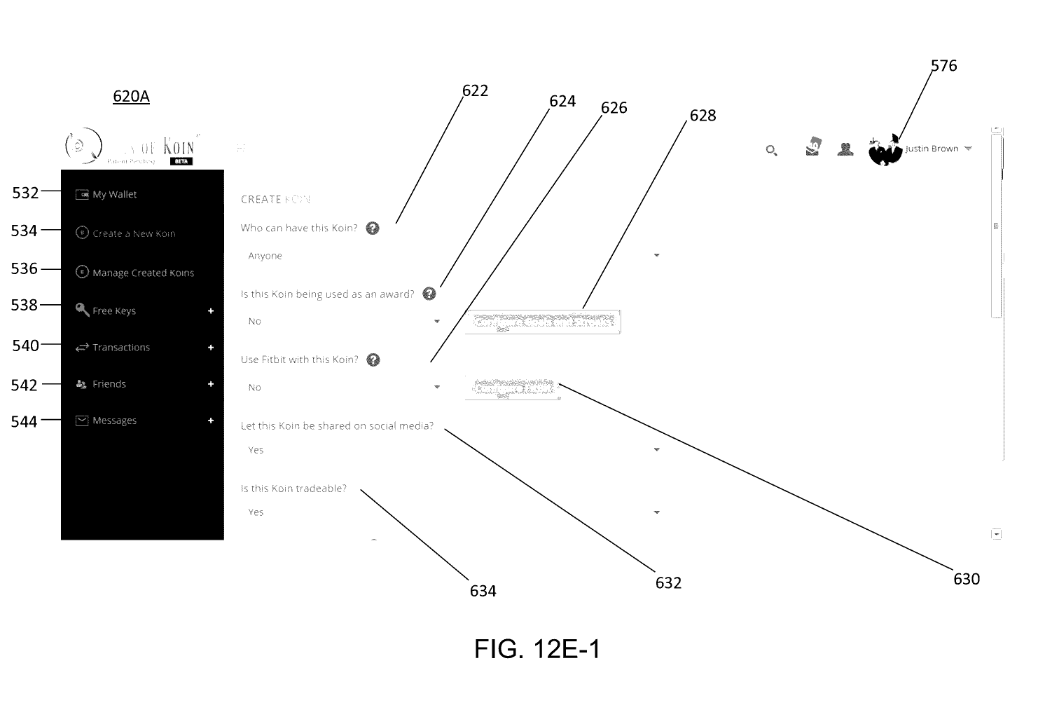

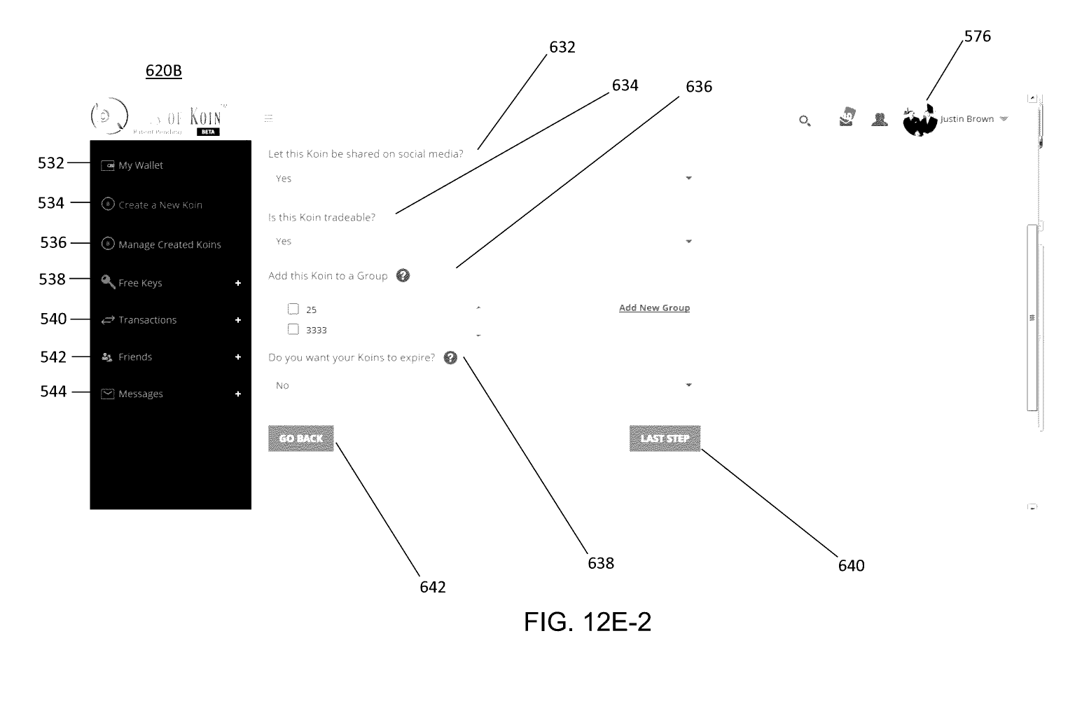

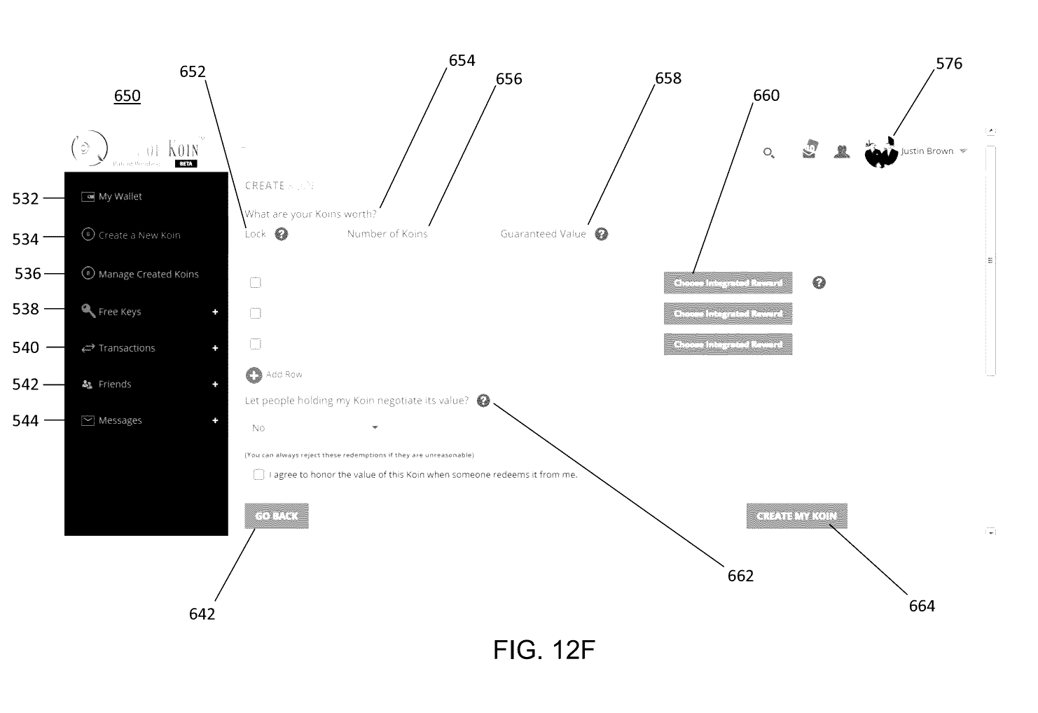

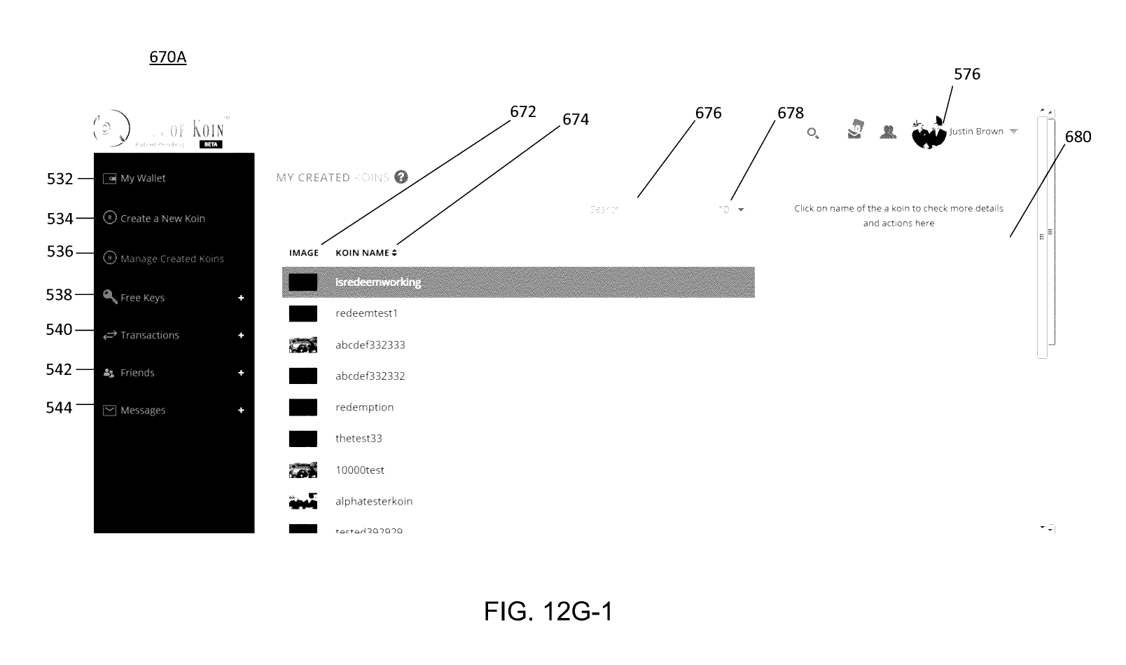

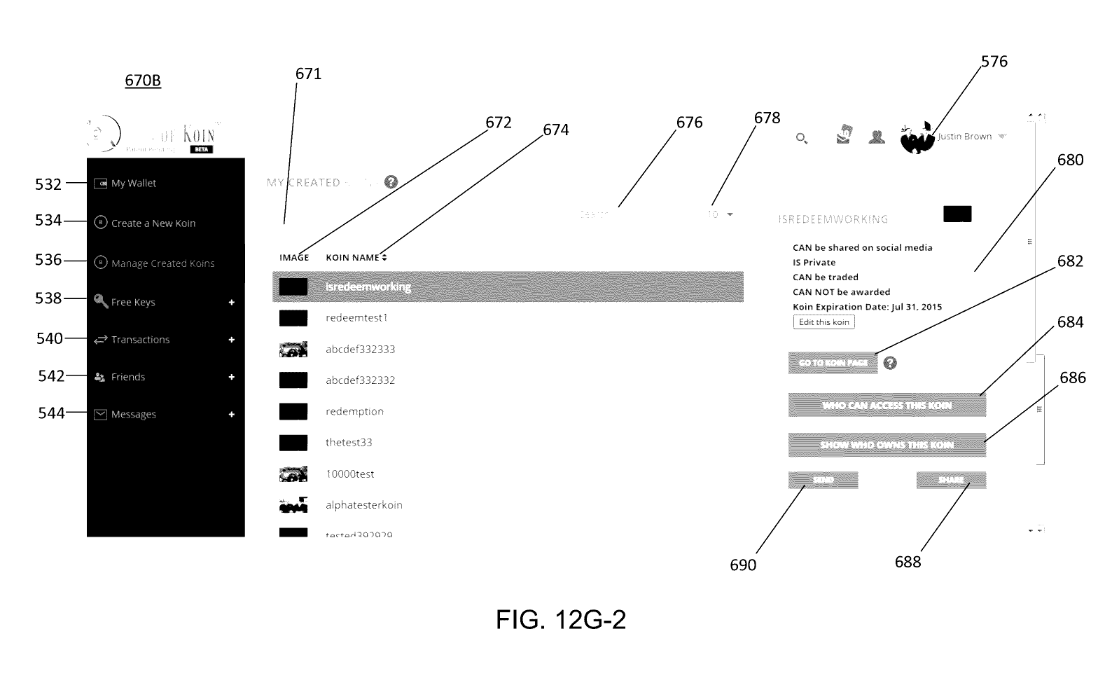

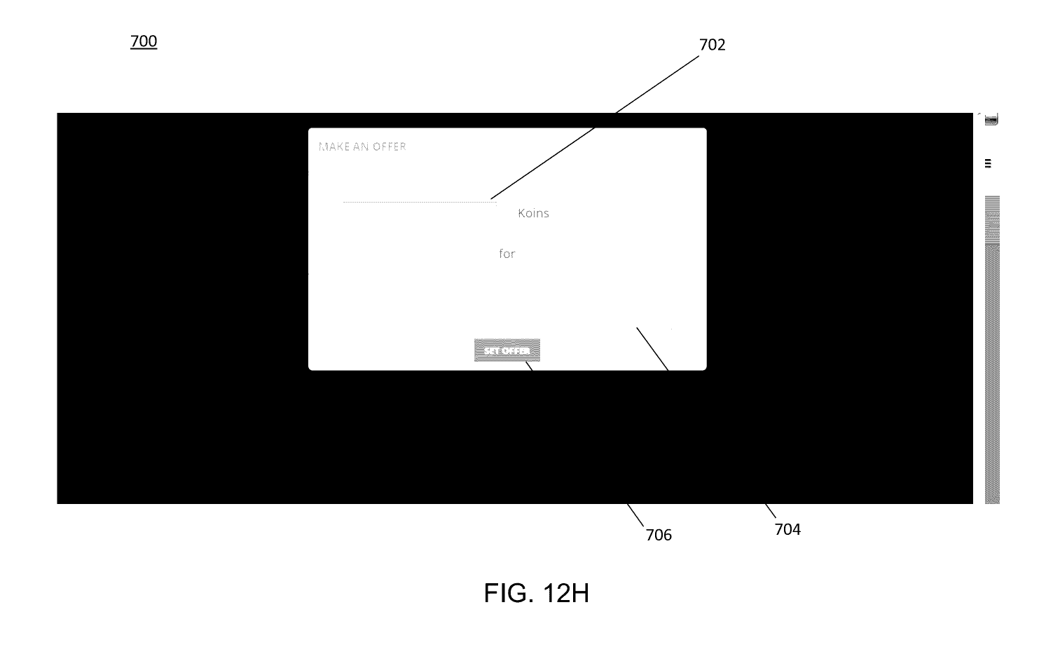

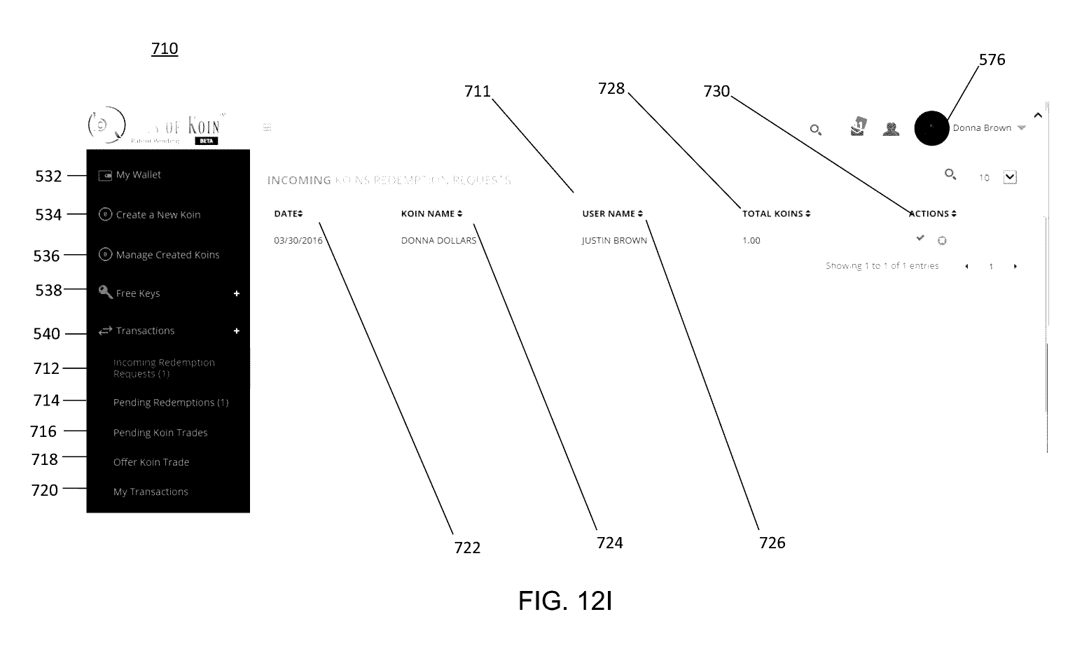

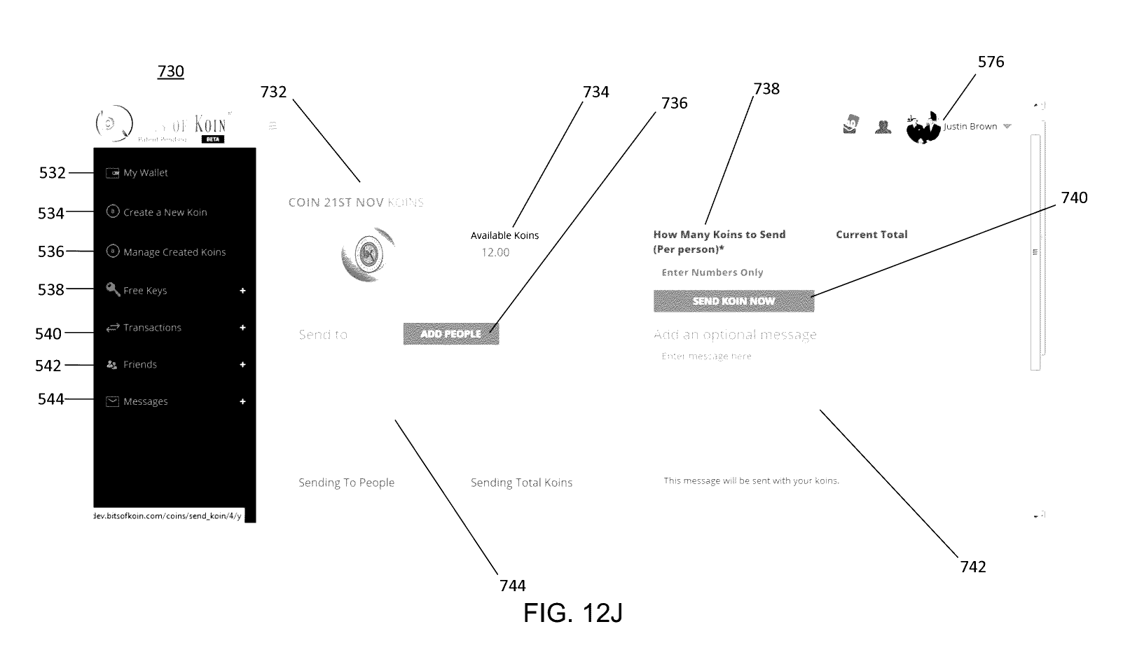

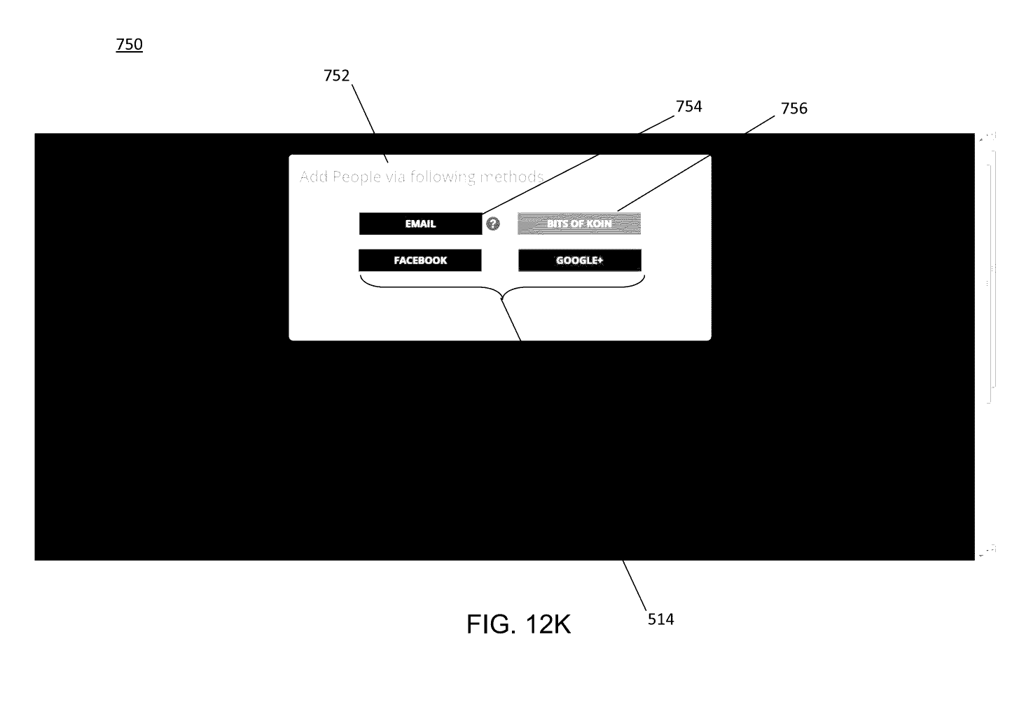

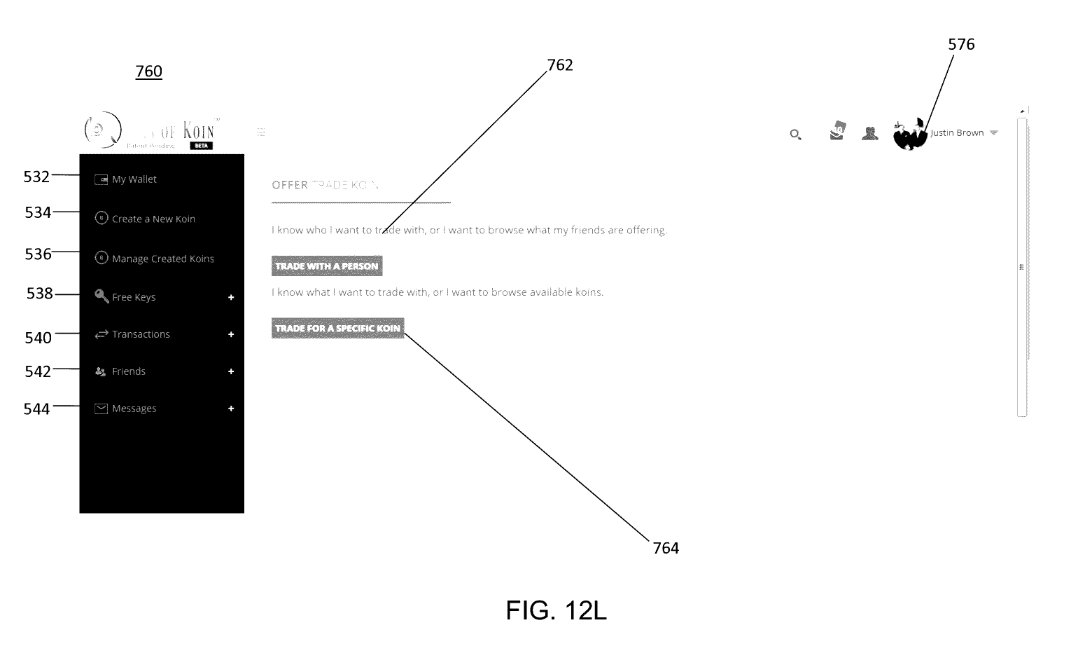

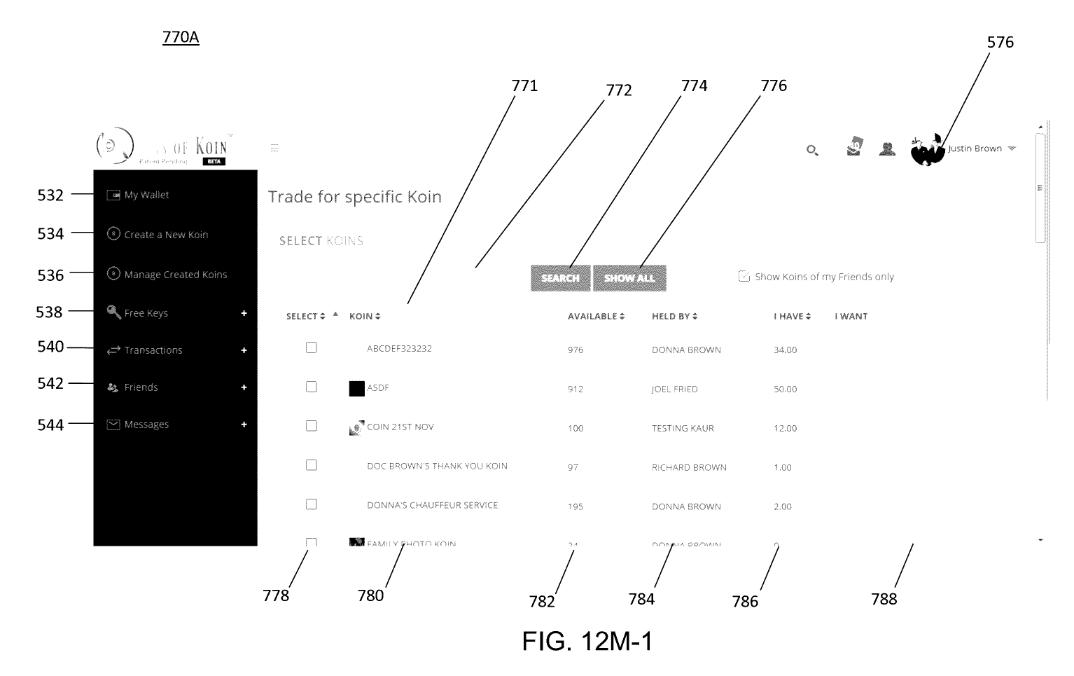

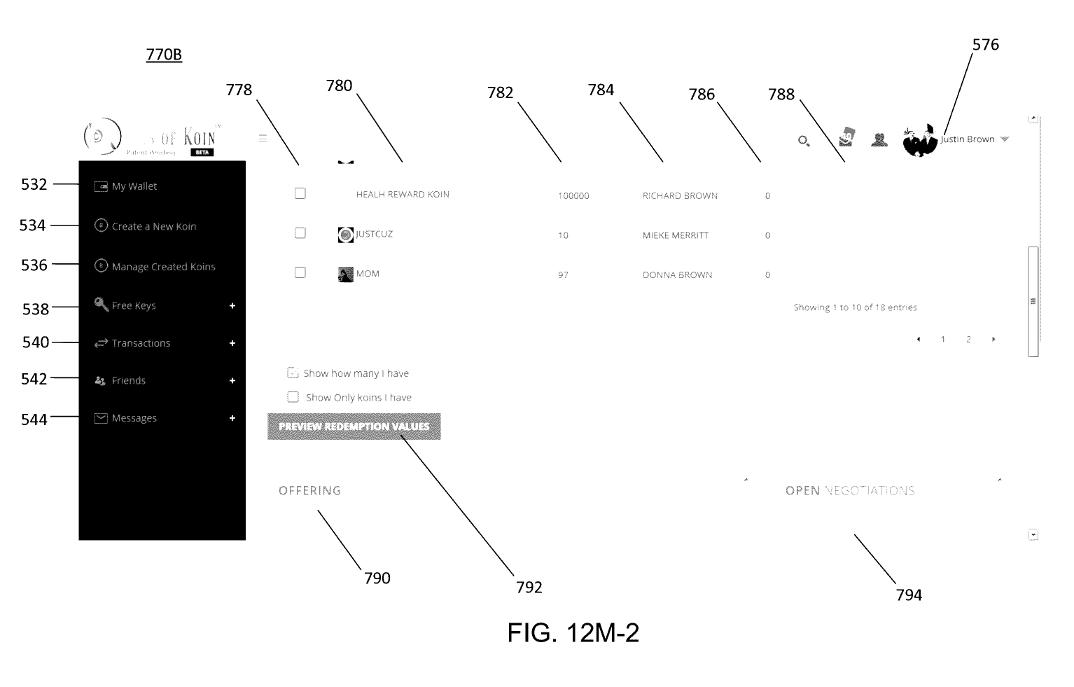

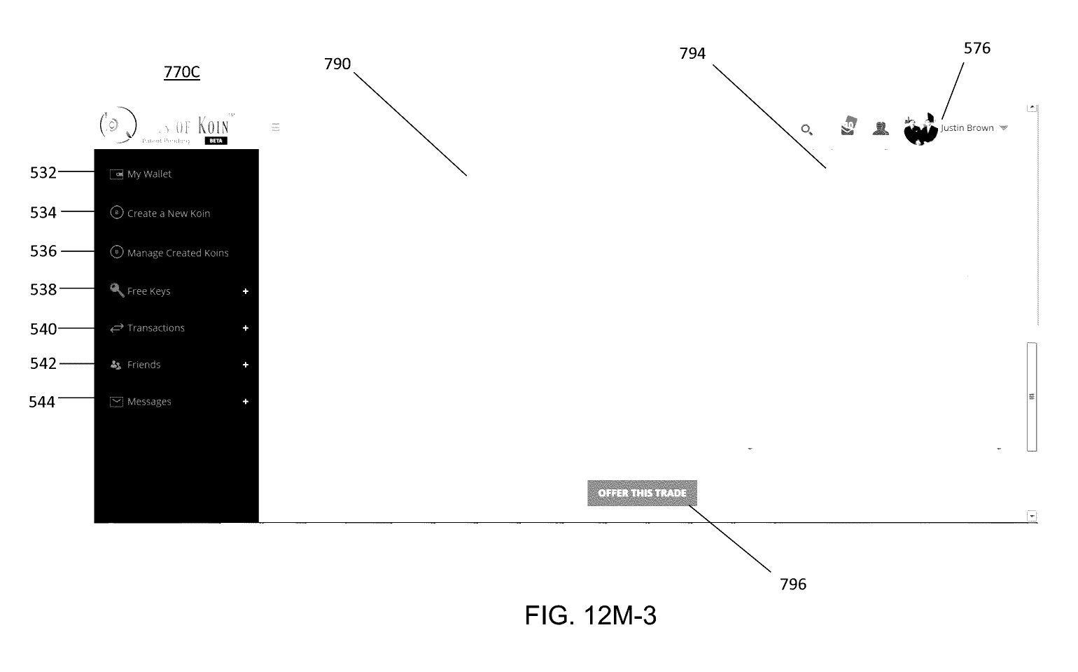

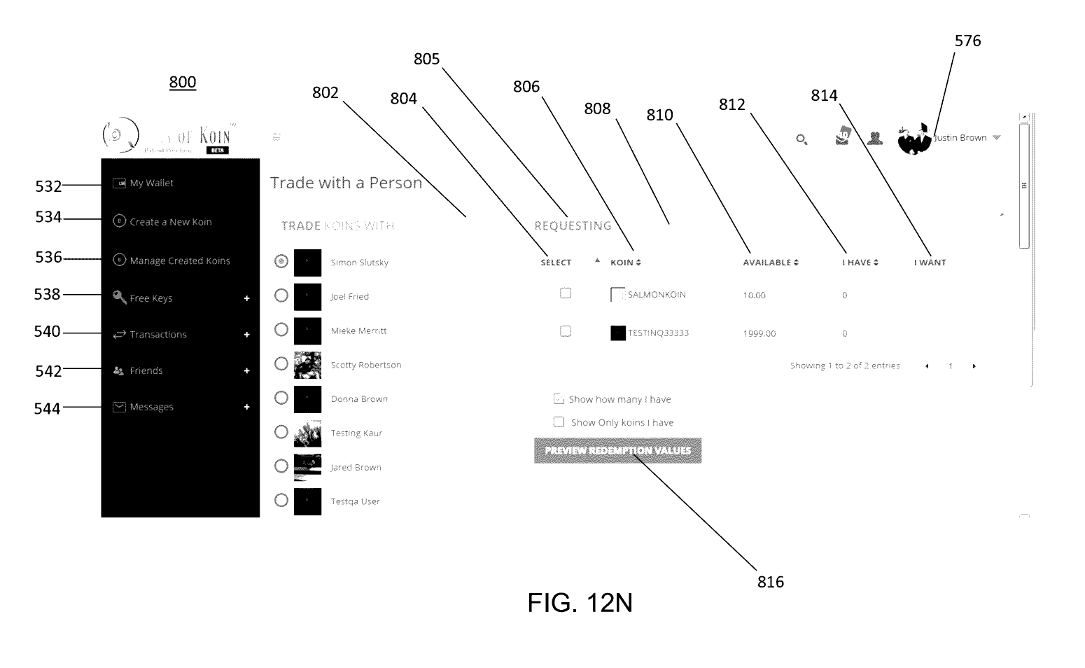

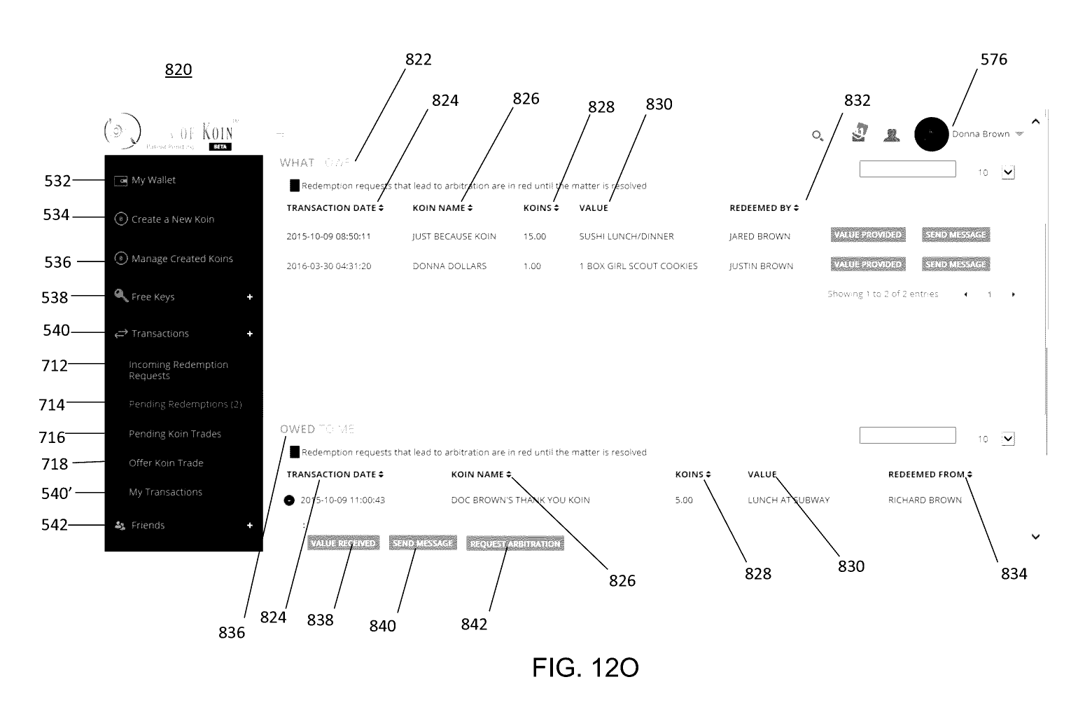

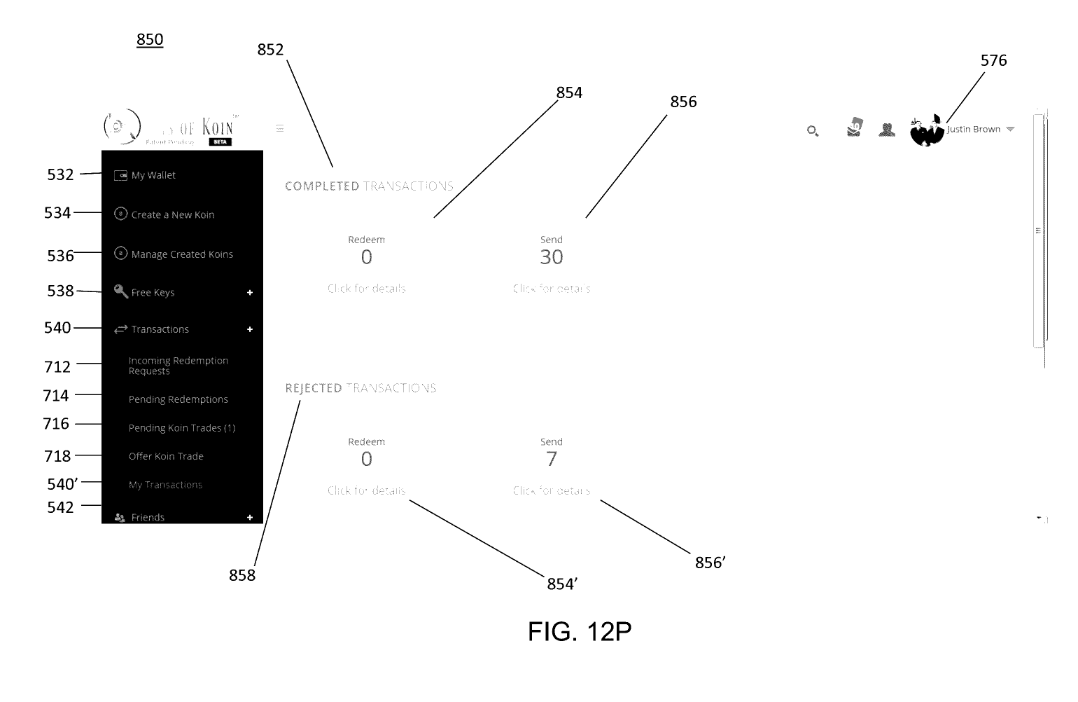

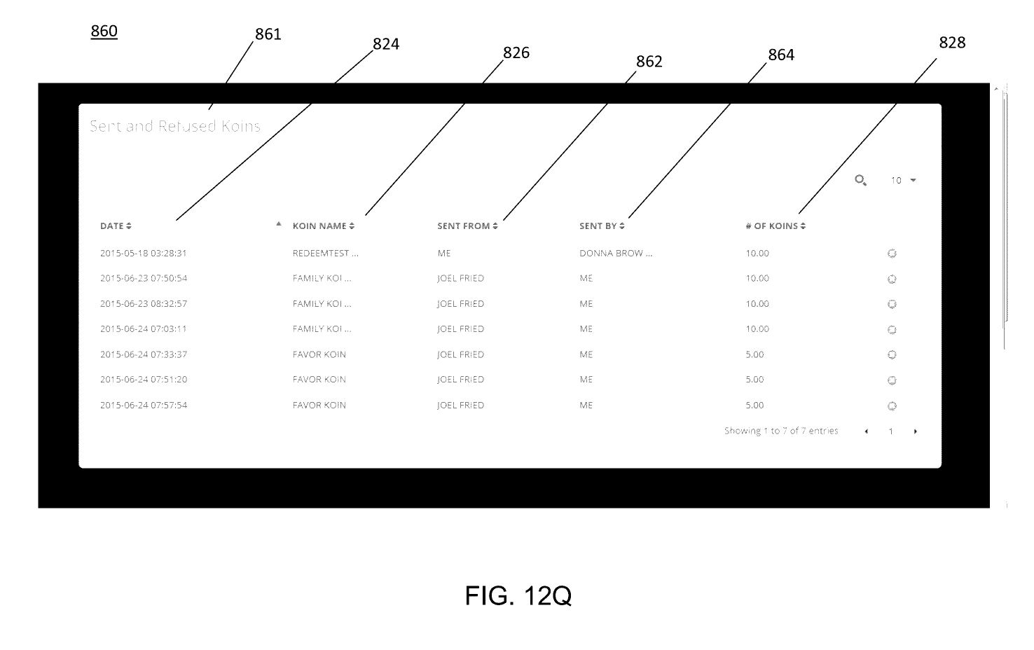

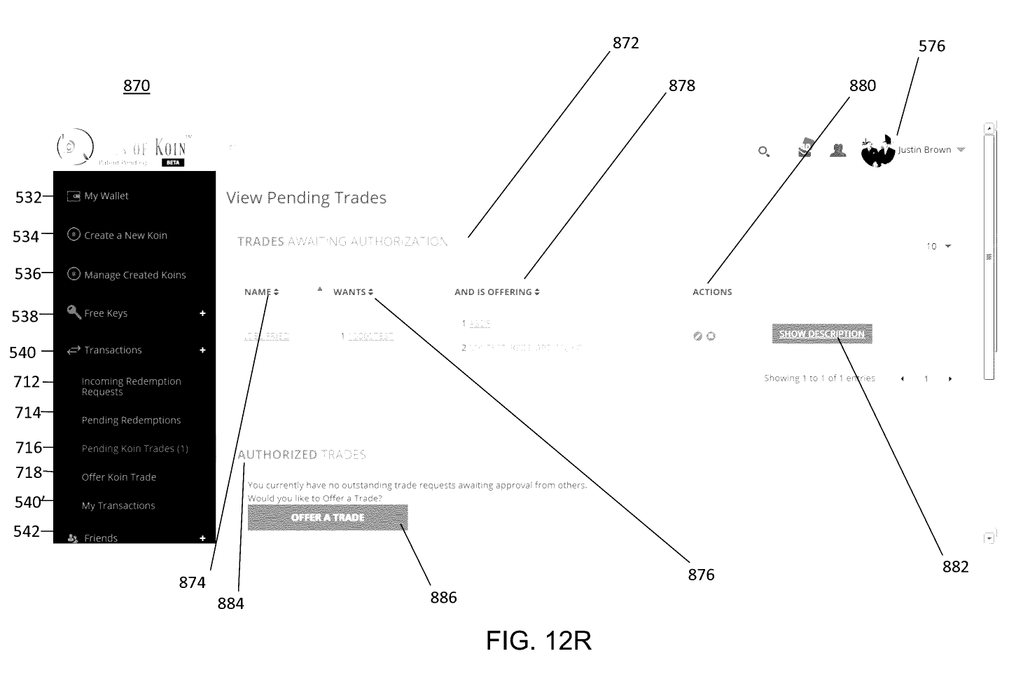

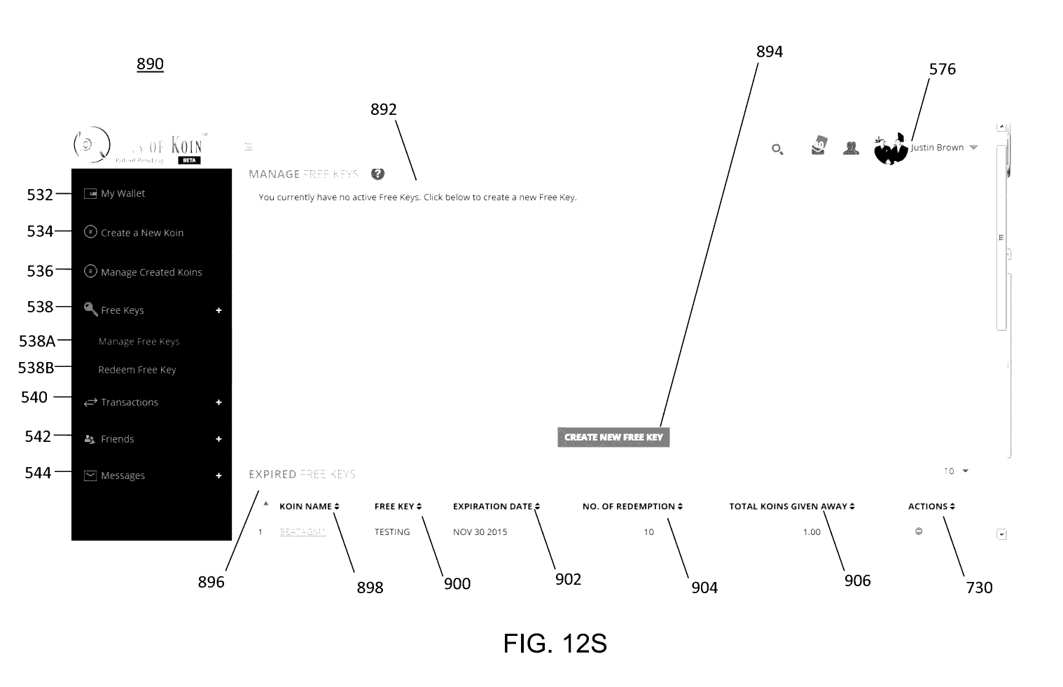

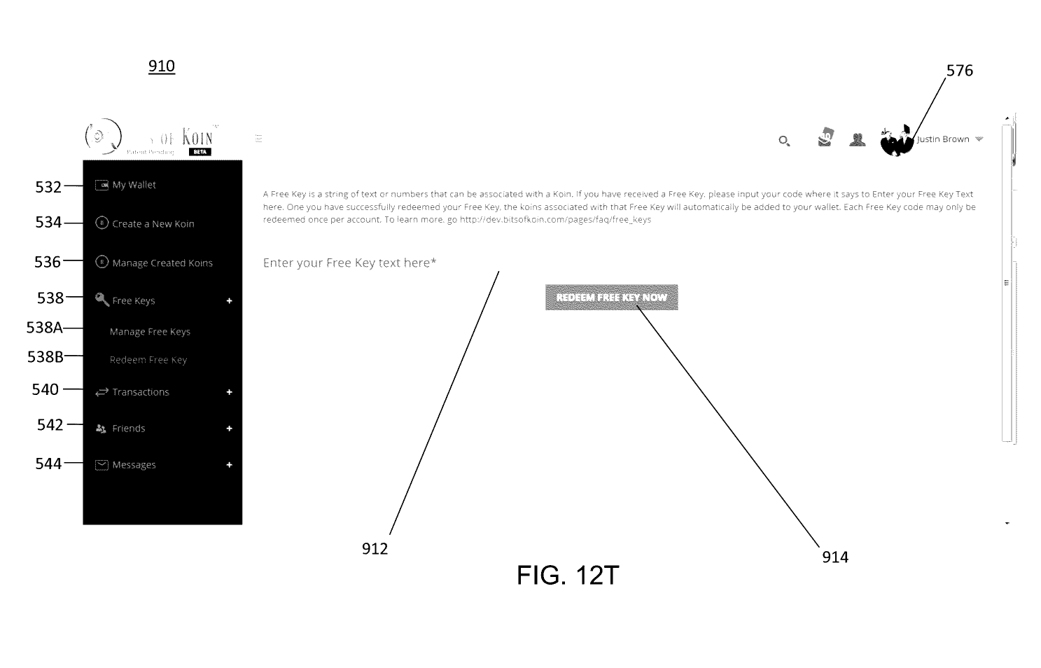

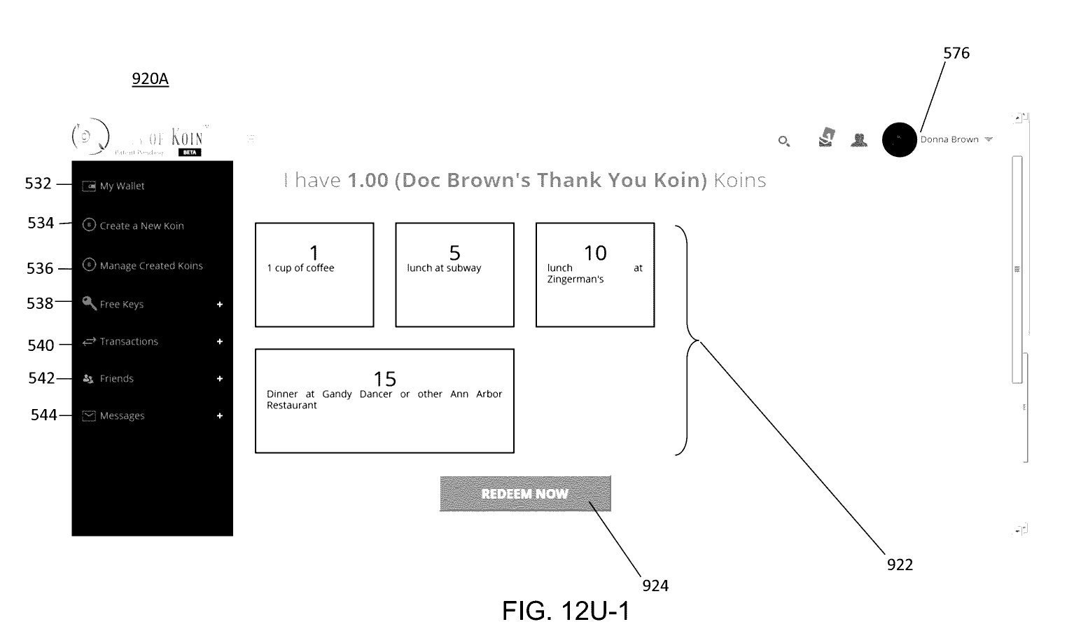

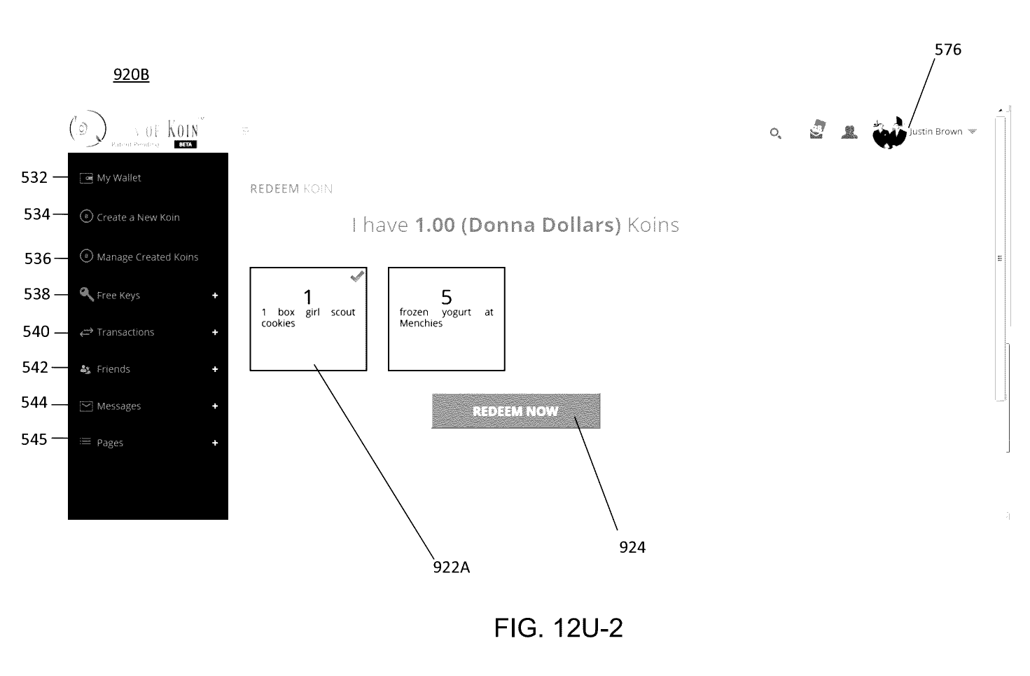

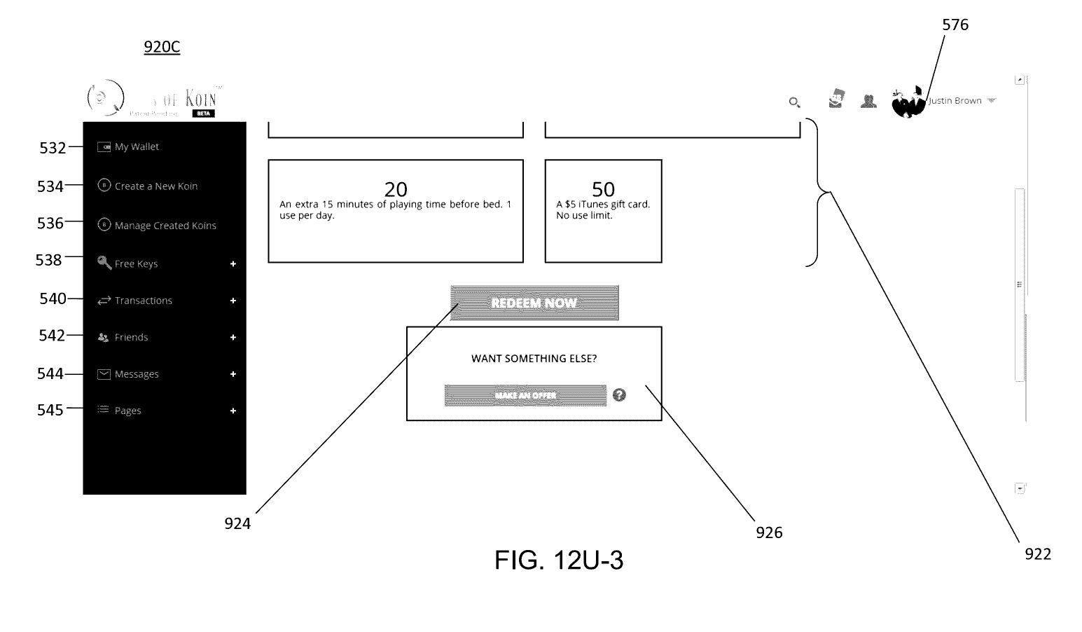

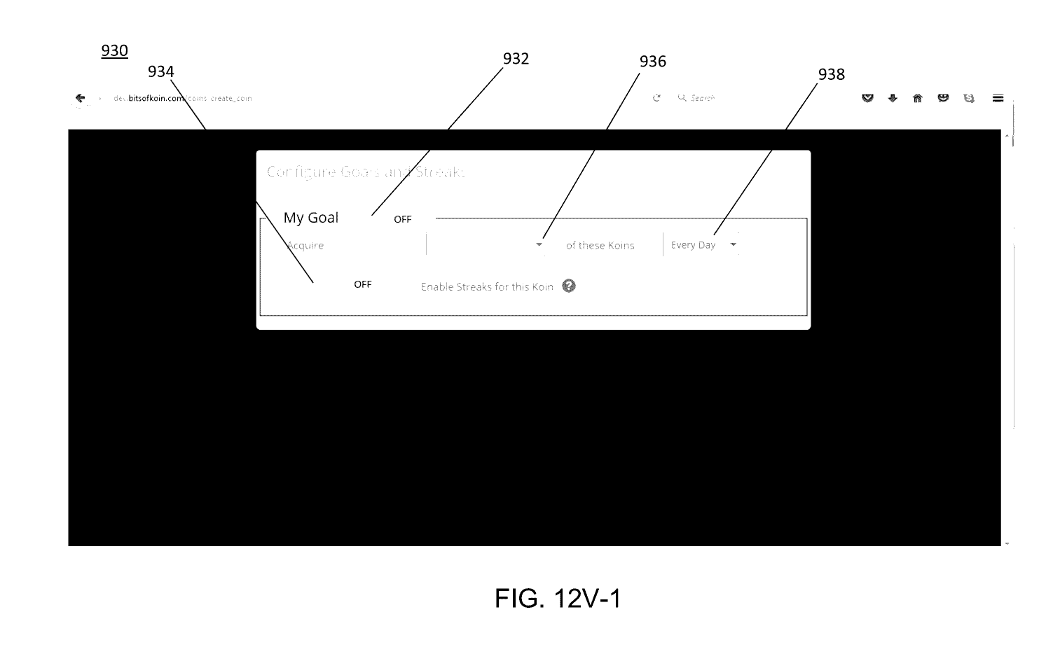

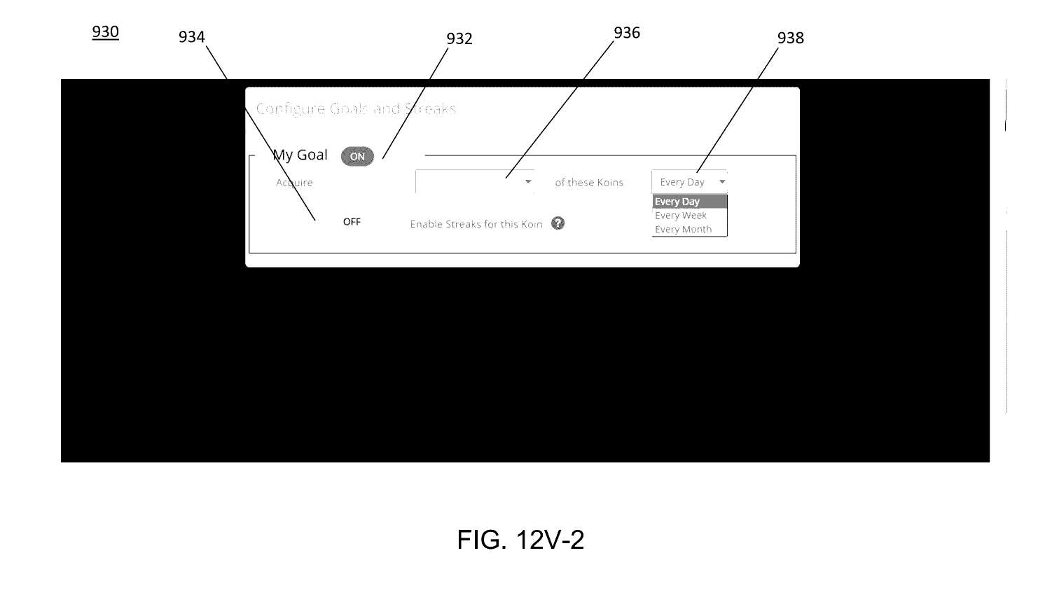

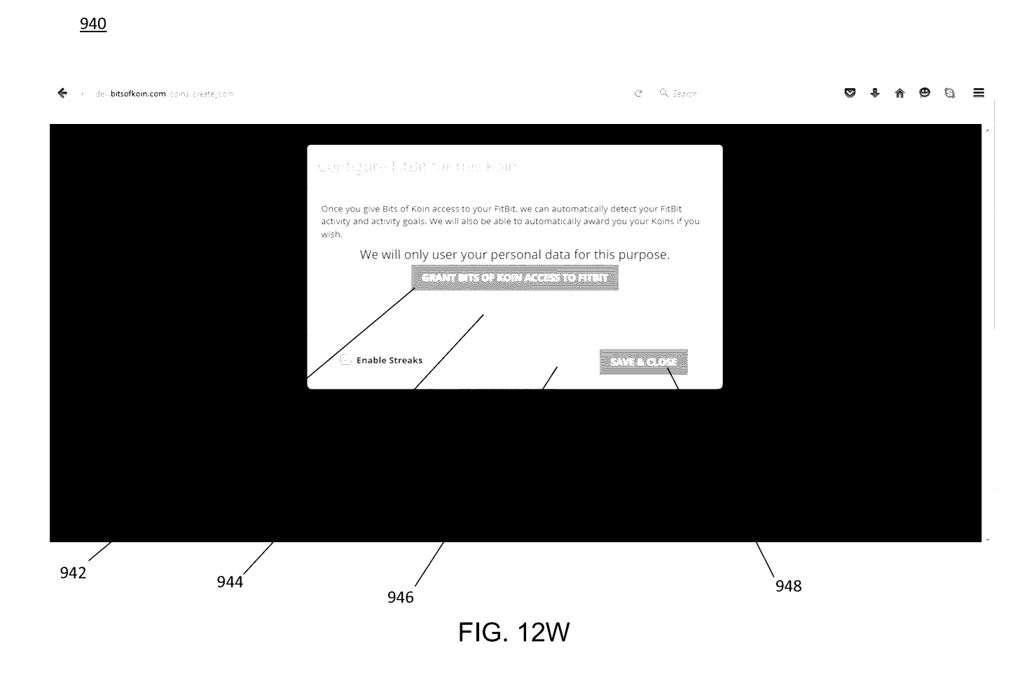

In a specific inventive embodiment, which is described in relation to FIGS. 10-13, the landing page has been changed from the dashboard (FIG. 2B) to a My Wallet page (FIG. 12A), and users can log in directly to the inventive currency platform, or log in by using their social media accounts illustratively including Facebook, Google+, Twitter, LinkedIn, and other social media services. In addition, koins that a user creates and manages are separate from koins that they own or have been awarded. Koins that a user owns or have been awarded may be available in “My Wallet”—the user's landing page. Koins the user has created and wish to administer are found under a “Manage Created Koins” GUI feature. In specific embodiments koins may have two major types—owned and awarded. Owned koins once given away cannot be recalled, but awarded koins may be revoked at the creator's wish. Furthermore, in specific embodiments a creating user may not own their own koins, but may award themselves koins they have created.

In specific inventive embodiments, koins may have three creation paths—quick, template, and unique. Quick koins may be created with fewer settings and options—the user specifies one thing the koins may be redeemed for and sets how many are required for that redemption, and gives the koin a name. Template Koins are pre-defined koins used for specific purposes that users may create a personal instance of. For example, “Chore Koins” are a koin type intended for use for household chores. The user may see the pre-defined values, create their own instance of that koin and then edit and use the koins as needed. Unique koins are fully customizeable using a unique koin creation interface of the edit koin function that has a series of questions the creator answers for each property of the koin to be created.

In specific embodiments a “Koin Page” is provided that may show a koin name, description, what the koin may be redeemed for, and may have buttons to view who can access the koin and who owns the koin. A message board called the Koin Wall may be provided for each Koin Page, where only users who can access the koin can view the Koin Wall. Koins may be traded for other koins. Koins do not need to be traded on a one-for-one basis or a one-type for one-type basis, for example a user can trade three X koins for 10 Y koins and a Z koin. Users may converse through the site back and forth before any trade is agreed upon. Koins may be shared on social media sites if allowed by the koin creator, and a corresponding promotional tool shows there is a koin and gives some details about it. Pages are provided in the inventive graphical user interface that detail pending or incomplete transactions, and allow a user to see what redemptions they have requested but have not yet received, mark their value as received, or request arbitration to resolve a dispute. Users may send messages to one another through this interface as well. Koins may be sent via email, to a Bits of Koin account or through social media applications. It is noted that in specific embodiments the sending function is for owned koins, while awarded koins may use a designated award interface.

Goal oriented tracking and fitness monitors may be used with embodiments of the inventive system and method to create and use a virtual personal electronic currency. Application interfaces (API) are provided to integrate fitness tracking devices and monitors to the graphical user interface to automatically award koins when a user reaches a goal they have set in an activity tracking system. This allows functionality such as “award me 5 koins when I walk 1 mile in a day”. These koins have redemption values the user sets like anything else, allowing for effective self-motivation. An integrated rewards system allows a user to choose a redemption value from a pre-defined list and be taken to a website to purchase the item in question. In specific embodiments digital gift cards from different retailers, entertainment providers, or service providers may be part of the integrated rewards structure. Revenues may accrue or be earned by the inventive virtual personal electronic currency system for providing the digital gift cards of various retailers and service providers (vendors).

In specific embodiments of the GUI for the virtual personal electronic currency, users may be able to delegate certain levels of authority over their koins to other user accounts. This allows someone to create a koin and let others users give the koin out, let others mark the koin(s) as value received, or just one koin but not the other koin(s), which is useful for groups with varying levels of authority. Users who redeem koins may be able to display on their mobile device (or print out at their discretion) a QR code that can be scanned with embodiments of the inventive virtual personal electronic currency app to validate their redemption. When a koin creator scans the relevant QR code they are notified that the redemption is valid and value has not been provided yet. They are then able to immediately mark the received koins as value provided and perform whatever service is necessary. This facilitates quick and easy point of sale redemptions from any point of sale with an Internet connection and QR code reading capability.

In specific embodiments, users are able to create koins that may be used to manage raffles. The koin creator may be able to set the prizes and number of each prize to be distributed. Each koin may for example be one ticket and the system may be able to perform the raffle draw and notify the users who holds the winning “tickets” automatically. The koin creator may be able to track who has received their raffle winnings as well.

FIG. 10 is a screenshot of a home page 500 for an embodiment of the virtual personal electronic currency. Links provided on the home page 520 may include home 502, about 504 to obtain information about the virtual personal currency system, FAQS 506 (frequently asked questions), and contact 508 that provides information to reach the operators of the virtual personal electronic currency platform. A sign in 510 or registration link (512, 512B) allows a user to enter or use the virtual personal currency system platform and app. Social media links 514 are also provided to allow sign in to the virtual personal currency system platform from the social media apps. FIG. 11 is an overlay screenshot of a login page 520 with links for signing in by entering a registered user name 522 and password 524 or via social network applications 514. Following the correct entry of a user name 522 and password 524 and clicking the sign in button 526, a user is sent to the my wallet page 530 shown in FIG. 12A.

FIGS. 12A-12W are a series of screenshots of a graphical user interface illustrating the functional and social aspects of the virtual personal electronic currency according to embodiments of the invention. FIG. 12A is a screenshot of the my wallet page 530 with a navigation sidebar 531. The navigation sidebar may include links to various pages of the GUI such as my wallet 532, create a new koin 534, manage created koins 536, free keys 538, transactions 540, friends 542, and messages 544. Function tabs available on the my wallet page 530 include all koins 546 (which is selected), owned koins only 548, awarded koins only 550. Display area 552 shows a selected koin from the all koins list 546. The all koins list 552 has a search function 551 with a user definable number of koins to display per page 553. The all koins list 546 has columns showing koin list number 566, koin/user image 568, koin name 570, koin page link 572, goal percentage 574 that has been achieved to earn a specific koin. The display area 552 has links to pages or overlays that show koin details 554, what a koin is worth 556, a redemption link 558, a trade for link 560, a sharing link 562, and a send koin link 564. In a specific embodiment in the upper right corner a series of icons are available including the user who is logged on 576, a friends link 577, an email indicator link 579, and a search link 581.

FIG. 12B shows a screenshot of a create koin page 580. The create koin page has a link to create a koin from a template 582 which has a library of templates to build a koin, a link to create a koin quickly 584, and a create a new unique koin 586. The create koin from a template screen 590A and 590B is shown as a scroll down in a composite of FIGS. 12C-1 and 12C-2. Available templates 592 illustratively include household, business, and games. In the example shown an allowance koin is shown in preview pane 594 with a link to show what the koin is worth 556 and a create my koin link 558.

The create koin page 600A and 600B is shown as a scroll down in a composite of FIGS. 12D-1 and 12D-2. Through use of the create koin page (600A, 600B) a user is provided with an option for a koin name 602, a written description area 604 with a text entry area 608, and a koin image selection link 606. The koin image may also be selected from a standard list 610. Following the selection of a koin image the image is uploaded via link 612. Selection of the next step button 614 send the user to the next create koin screen 620A and 620B shown as a scroll down in a composite in FIGS. 12E-1 and 12E-2, where the user is asked a series of questions including: who can have the koin 622; Is the koin being used as an award 624; Is a fitness tracker being used with the koin 626; Can the koin be shared on social media 632; is the koin tradeable 634; is the koin to be added to a selected group 636; and should the koin have an expiration date 638. The user may submit their answers by selecting the last step button 640 to proceed to the next page 650 shown in FIG. 12F, or select the go back button 642 to proceed back to the previous page (600A, 600B). User actions on page 650 include: letting the user lock the value of their koin; setting the value of their created koin 654; the number of koins to be issued 656; the guaranteed value 658, whether to link an integrated reward 660; whether to allow people who receive the created koin negotiate the value of the koin 662. Following the completion of the questions, the user may select the create koin button 664, or go back to the previous screen (620A, 620B).

The my created koin page 670A and 670B is shown as a scroll down in a composite of FIGS. 12G-1 and 12G-2. The list 671 of koins in the possession of the user is shown in a table with columns for koin image 672 and koin name 674. A search selection 676 and number of rows to show per page 678 is also available. Information on a selected koin from the list 671 is shown in viewing pane 680. Selectable buttons that are also on the page include: go to the koin page 682; who can access the koin 684; show who owns this koin 686; share the koin 688; and send the koin 690.

FIG. 12H shows a make an offer screen 700 that allows a user to offer a number of koins 702 for a user requested item or service entered in entry area 704 that is sent to a recipient with the set offer button 706.

FIG. 12I is an incoming koin redemption request screen 710. The list 711 of incoming koins redemption requested by recipient users of created koins is shown in a table with columns for date of request 722, koin name 724, recipient user 726, total koins to be redeemed 728, and action to be taken 730.

FIG. 12J is a screenshot 730 of a koin sending page 732 that shows the name of a selected koin to be sent, the number of koins available 734, an entry area 744 to button 736 add recipients 736, the number of koins to send per person 738, a send button 740, and an area to add an optional message 742. Selection of the add people button 736 sends the user to the overlay 752 in screenshot 750 shown in FIG. 12K. People may be added by email 754, through the platform itself 756, and through social media 514.

FIG. 12L is a screenshot 760 of an offer to trade a koin where if the user knows the person they want to trade with they select the trade with a person button 762 which sends the user to FIG. 12N. If the user knows what they want to trade for, or want to browse for available koins by selecting trade for a specific koin button 764.

The trade for a specific koin page 770A-770C is shown as a scroll down in a composite of FIGS. 12M-1-12M-3. An entry field 772 is provided to specify a specific koin 772. A search function button 774 and a show all koin button 776 are available. A list of koins 771 is shown in column form with columns for selection 778, koin name 780, available number of koins 782, who holds the koin 784, how many of these koins are currently held by the use 785, and an entry area to specify how many koins the user wants 788. Additional action buttons include a preview of redemption values 792, an offering entry area 790, an entry area to negotiate 794, and an offer this trade button 796 that sends the proposed trade to a recipient.

FIG. 12N is a screenshot 800 of a trade with a person page where area 802 allows the user to select with whom to trade with. Requesting pane allow the user to select 804 a specific koin 806, how many are available 810, how many the user already has 812, and how many the user wants 814.

FIG. 12O is a screenshot 820 of what a user owes 822 and what is owed the user 836 in terms of transactions and trades in tabular form with columns for transaction date 824, koin name 826, number of koins 828, value 830, and redeemed by 832, and redeemed from 834.

FIG. 12P is a screenshot of completed transactions 852 that shows redeemed koins 854 and sent koins 856, and rejected transactions 858 that shows redeemed koins 854′ and koins sent 856′. FIG. 12Q is a screenshot 860 of a sent and refused koin table 861 that shows date of refusal 824, koin name 826, set from 862, sent by 864, and number of koins 828.

FIG. 12R shows a screenshot of a view pending trade page 870. A trades awaiting authorization table 872 has columns for name of person in trade 874 what they want 876, what they are offering for trade 878, and actions 880. A show description button 882 may be used to obtain additional information about the koin. The authorized trades 884 shows trade status and if the user wants to offer a trade 886.

FIG. 12S is a screenshot 890 of a manage free keys page 892 that shows if there are any outstanding free keys. The user may produce a new free key with the create free key button 894. The expired free keys list 896 has columns for koin name 898, free key 900, expiration date 902, number of redemptions 904, total koins given away 906, and actions 730.

FIG. 12T is a screenshot 910 for a user to redeem a free key with entry of text or numbers or alpha numeric string in an entry area 912 with a redeem free key now 914. Screen shots 920A-920C shown in FIGS. 12U-1-12U-3 in a scroll down fashion show redemption for specific items 922 with redemption button 924. The user may make an offer for another item or service with selection 926.

FIGS. 12V-1 and 12V-2 show screenshots 930 for the configuration of goals and streaks for acquiring koins. A goal may be set with on/off toggle switch 932 to acquire a specified number 936 of koins on a pull down menu for a specified schedule 938. On/off toggle switch 934 may be used to enable a streak. A streak refers to the number of times in a row that a goal set by the user is reached. For example if the user sets their goal to walk 10,000 steps each day as measured with a wearable fitness tracking device that interfaces with embodiments of the inventive application (app). When the user walks the 10,000th step they have reached their goal and are awarded a koin. Streaks track how many consecutive times a user has reached their goal. So if the user walks 10,000 steps in a row for 6 days, their streak is 6.

FIG. 12W is a screenshot 940 for configuring an activity and fitness tracking module, which may be wearable on a person's body. In order to use this feature, the user needs to grant the platform access to the data from the activity tracker with button 942 and select to get their goals from the activity tracker with button 944. The user setting are saved with button 948 and the overlay is closed with button 946.

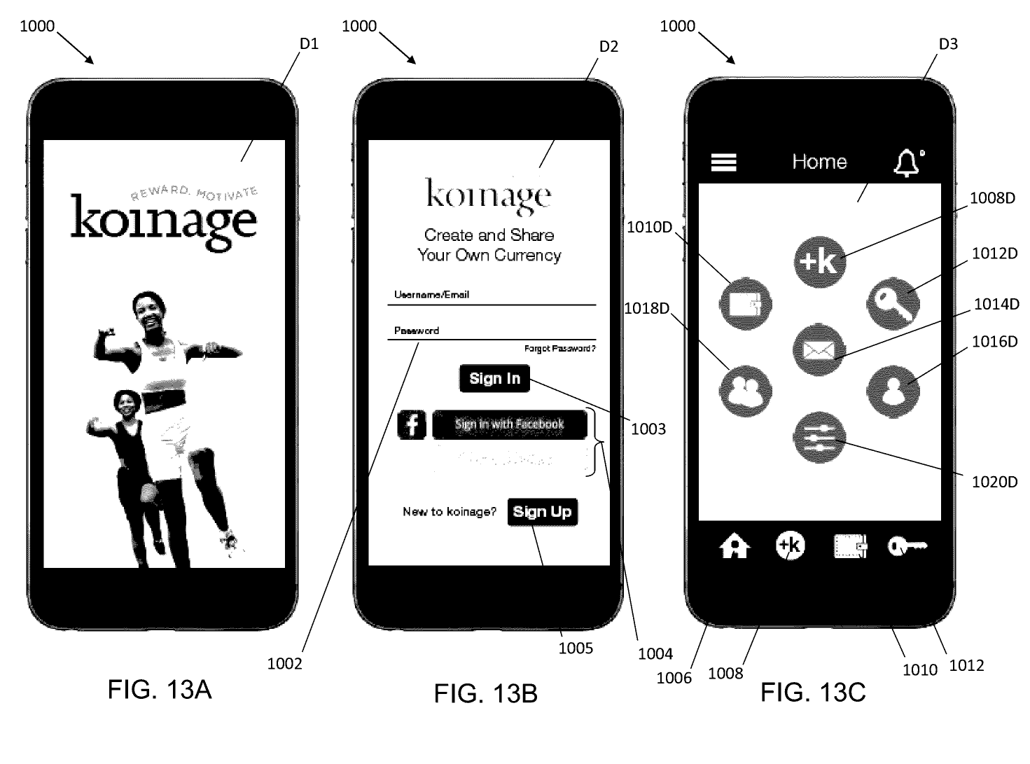

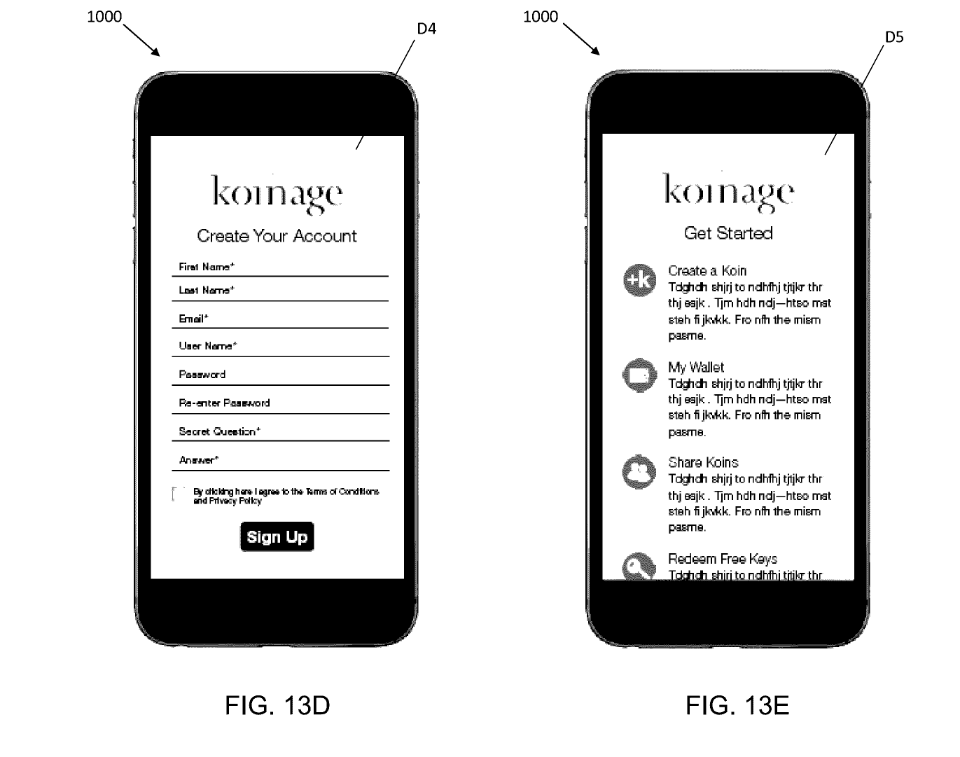

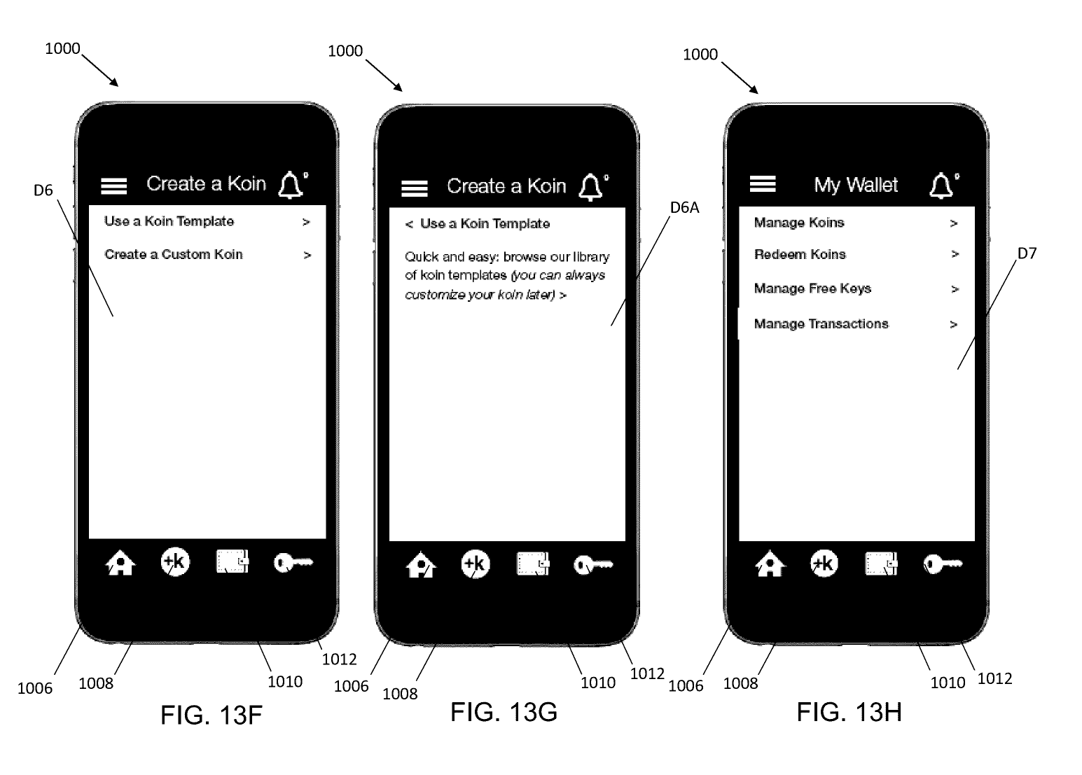

FIGS. 13A-13H are a series of screenshots of a graphical user interface configured for use on a mobile communication and computing device 1000 in accordance with embodiments of the invention. Embodiments of the app are configured as a downloadable application (app) that are available for computing operating systems (OS) or mobile operating systems illustratively including Windows, OS X, Linux, Android, iOS, Windows for mobile, and other available mobile operating systems (OS). In FIG. 13A a start screen D1 for the app is shown. In FIG. 13B a sign in screen D2 is shown with username and password fields 1002 and sign in button 1003. The user may also sign in via social media apps 1004. The user may also sign up for an account with button 1005. FIG. 12C shows home screen D3 with touch icons for home 1006, create koin 1008, my wallet 1010, and redeem free keys 1012 in a bottom bar on the display. Icons are also displayed around the display D3 with touch icons create koin 1008D, my wallet 1010D, redeem free keys 1012D, mail/messages 1014D, profile 1016D, friends 1018D, and user settings for the app 1020D. FIG. 13D is a screen D4 for creating an account for accessing the platform and using the app. FIG. 13E is a start screen D5 with an explanation of the key icons.

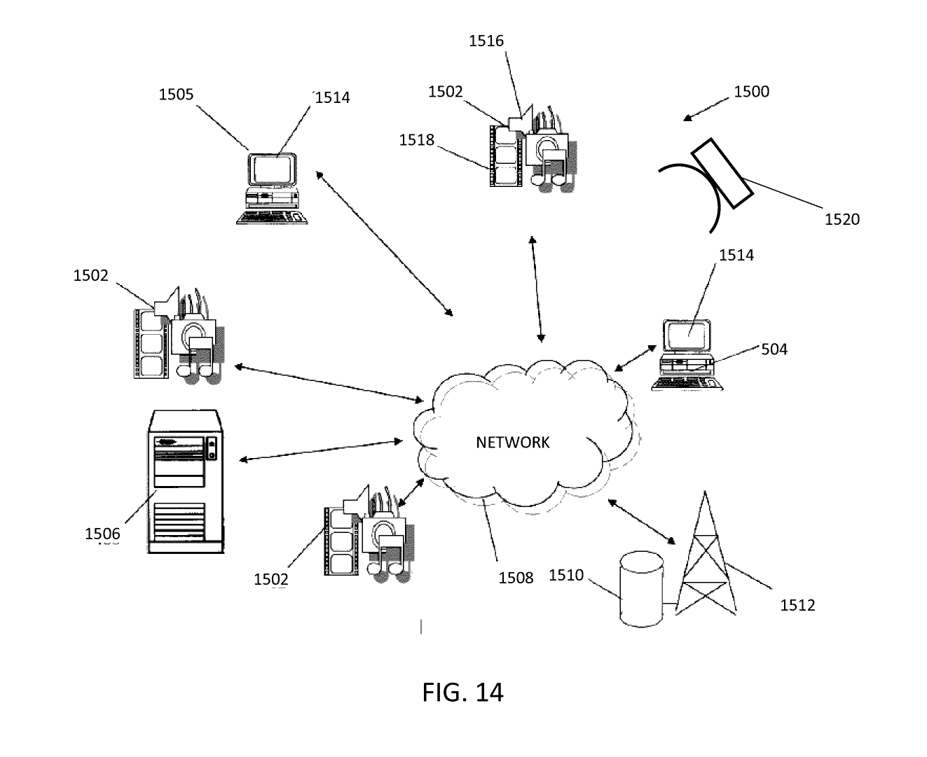

FIG. 14 is a schematic diagram illustrating an overall view of communication devices, computing devices, and mediums for implementing the platform according to embodiments of the invention. The elements of the embodiments of FIGS. 1 to 13 are included in the networks and devices of FIG. 14.

The system 1500 includes an end-point device 1502 and desktop computer devices 1504 configured with display capabilities 1514 and processors for executing instructions and commands. The end-point device 1502 is in certain embodiments may be mobile communication and entertainment devices, such as cellular phones, tablets, and mobile computing devices that in certain embodiments are wirelessly connected to a network 1508. The end-point device 1502 typically has a video displays 1518 and audio outputs 1516. The end-point device may be configured to interact with other external devices illustratively including fitness tracking devices. The end-point device 1502 and desktop computer devices 1504 are optionally configured with internal storage, software, and a graphical user interface (GUI) for carrying out elements of the platform according to embodiments of the invention. The network 1508 is optionally any type of known network including a fixed wire line network, cable and fiber optics, over the air broadcasts, satellite 1520, local area network (LAN), wide area network (WAN), global network (e.g., Internet), intranet, etc. with data/Internet capabilities as represented by server 1506. Communication aspects of the network are represented by cellular base station 1510 and antenna 1512. In a preferred embodiment, the network 1508 is a LAN and each remote device 1502 and desktop device 1504 executes a user interface application (e.g., Web browser) to contact the server system 1506 through the network 1508. Alternatively, the remote devices 1502 and 1504 may be implemented using a device programmed primarily for accessing network 1508 such as a remote client.

The software for the platform, of embodiments of the invention, may be resident on the individual end-point device 1502 and desktop computers 1504, or stored within the server 1506 or cellular base station 1510. Server 1506 may implement a cloud-based service for implementing embodiments of the platform with a multi-tenant database for storage of separate client data.

The foregoing description is illustrative of particular embodiments of the invention, but is not meant to be a limitation upon the practice thereof. The following claims, including all equivalents thereof, are intended to define the scope of the invention.

1. A non-transitory computer-readable medium for implementing an automated virtual personal electronic currency, comprising instructions stored thereon, that when executed on a processor, perform the steps of:
providing a graphical user interface (GUI) from a platform;
registering as a user on the platform;
creating said virtual personal electronic currency with a set of user defined attributes on said platform; and
distributing said virtual personal electronic currency to one or more recipients for goods and services provided.

2. The non-transitory computer-readable medium of claim 1 wherein the user sets a redemption value of said personal electronic currency.

3. The non-transitory computer-readable medium of claim 1 wherein said user defined attributes comprise at least one of a name, description, representative icon, who can own the virtual personal electronic currency, permission levels for sharing the virtual personal electronic currency on social media, whether or not the virtual personal electronic currency expires after a defined period, the number and amount of virtual personal electronic currency in circulation, and the value of a single unit of the virtual personal electronic currency.

4. The non-transitory computer-readable medium of claim 3 wherein said permission levels limit the distribution of the virtual personal electronic currency to the user's friends.

5. The non-transitory computer-readable medium of claim 3 wherein said permission levels limit the distribution of the virtual personal electronic currency to only individuals specified by the user.

6. The non-transitory computer-readable medium of claim 1 wherein said distribution is via social networks.

7. The non-transitory computer-readable medium of claim 1 wherein said distribution is via electronic mail (e-mail).

8. The non-transitory computer-readable medium of claim 1 wherein a redemption value of said personal electronic currency is locked.

9. The non-transitory computer-readable medium of claim 1 wherein the GUI is made up of a series of pages organized in a navigation tree.

10. The non-transitory computer-readable medium of claim 9 wherein the series of pages are web pages sent over the Internet.

11. The non-transitory computer-readable medium of claim 1 further comprising assigning an alphanumeric code as a free key that allows other users to obtain a defined amount of said virtual personal electronic currency for free.

12. The non-transitory computer-readable medium of claim 11 wherein said alphanumeric code is a quick response (QR) code or a barcode as part of a koin image.

13. The non-transitory computer-readable medium of claim 1 further comprising a set of tiers that the user qualifies for based on performance of one or more criteria.

14. The non-transitory computer-readable medium of claim 13 wherein said one or more criteria comprise a defined minimum number of transactions per month, creation of a minimum number of virtual personal electronic currency units, a minimum number of friends, a minimum number of social media contacts, and a minimum number of referrals.

15. The non-transitory computer-readable medium of claim 1 further comprising a set of tiers that the user qualifies for based on payment of a fee.

16. The non-transitory computer-readable medium of claim 1 further comprising transaction costs or charges associated with a transaction with a koin as computed by the platform.

17. The non-transitory computer-readable medium of claim 1 wherein said platform is a downloadable application (app).

18. The non-transitory computer-readable medium of claim 1 wherein said platform is accessed from a remote server.

19. An automated method for implementing a virtual personal electronic currency, said method comprising:
providing a graphical user interface (GUI) from a platform;
registering as a user on the platform;
creating said virtual personal electronic currency with a set of user defined attributes on said platform; and
distributing said virtual personal electronic currency to one or more recipients for goods and services provided.

20. The method of claim 19 wherein the user sets a redemption value of said personal electronic currency.

21. The method of claim 19 wherein said user defined attributes comprise at least one of a name, description, representative icon, who can own the virtual personal electronic currency, permission levels for sharing the virtual personal electronic currency on social media, whether or not the virtual personal electronic currency expires after a defined period, the number and amount of virtual personal electronic currency in circulation, and the value of a single unit of the virtual personal electronic currency.

22. The method of claim 19 wherein said permission levels limit the distribution of the virtual personal electronic currency to the user's friends.

23. The method of claim 19 wherein said permission levels limit the distribution of the virtual personal electronic currency to only individuals specified by the user.

24. The method of claim 19 wherein said distribution is via social networks.

25. The method of claim 19 wherein said distribution is via electronic mail (e-mail).

26. The method of claim 19 wherein a redemption value of said personal electronic currency is locked.

27. The method of claim 19 wherein the GUI is made up of a series of pages organized in a navigation tree.

28. The method of claim 27 wherein the series of pages are web pages sent over the Internet.

29. The method of claim 19 further comprising assigning an alphanumeric code as a free key that allows other users to obtain a defined amount of said virtual personal electronic currency for free.

30. The method of claim 29 wherein said alphanumeric code is a quick response (QR) code or a barcode as part of a koin image.

31. The method of claim 19 further comprising a set of tiers that the user qualifies for based on performance of one or more criteria.

32. The method of claim 31 wherein said one or more criteria comprise a defined minimum number of transactions per month, creation of a minimum number of virtual personal electronic currency units, a minimum number of friends, a minimum number of social media contacts, and a minimum number of referrals.

33. The method of claim 19 further comprising a set of tiers that the user qualifies for based on payment of a fee.

34. The method of claim 19 further comprising transaction costs or charges associated with a transaction with a koin as computed by the platform.

35. The method of claim 19 wherein said platform is a downloadable application (app).

36. The method of claim 19 wherein said platform is accessed from a remote server.

37. A system for a virtual personal electronic currency, said system comprising:
a server connected via a network to plurality of computing and mobile communication devices; and
a memory system in electrical communication with said server containing a machine readable medium having stored thereon one or more sequences of instructions which, when executed by a processor, cause said method of claim 19 to be carried out.
